(19) United States
(12) Patent Application Publication
(10) Pub. No.: US 2025/0343764 A1
(43) Pub. Date: Nov. 6, 2025

(54) Concepts for Coding Neural Networks Parameters

(71) Applicant: Fraunhofer-Gesellschaft zur Foerderung der angewandten Forschung e.V., Munich (DE)

(72) Inventors: Paul HAASE, Berlin (DE); Heiner KIRCHHOFFER, Berlin (DE); Heiko SCHWARZ, Berlin (DE); Detlev MARPE, Berlin (DE); Thomas WIEGAND, Berlin (DE)

(21) Appl. No.: 19/267,146

(22) Filed: Jul. 11, 2025

Related U.S. Application Data
(63) Continuation of application No. 17/843,772, filed on Jun. 17, 2022.
Application No. 17/843,772 is a continuation of application No. PCT/EP2020/087489, filed on Dec. 21, 2020.

(30) Foreign Application Priority Data
Dec. 20, 2019 (EP) 19218862.1

(51) Int. Cl. H04L 47/2483; G06N 3/04

(52) U.S. Cl. CPC H04L 47/2483; G06N 3/04

(57) ABSTRACT

Embodiments according to a first aspect of the present invention are based on the idea, that neural network parameters may be compressed more efficiently by using a non-constant quantizer, but varying same during coding the neural network parameters, namely by selecting a set of reconstruction levels depending on quantization indices decoded from, or respectively encoded, into the data stream for previous or respectively previously encoded neural network parameters. Embodiments according to a second aspect of the present invention are based on the idea that a more efficient neural network coding may be achieved when done in stages—called reconstruction layers to distinguish them from the layered composition of the neural network in neural layers—and if the parametrizations provided in these stages are then, neural network parameter-wise combined to yield a neural network parametrization improved compared to any of the stages.

### CROSS-REFERENCES TO RELATED APPLICATIONS

This application is a continuation U.S. patent application Ser. No. 17/843,772, filed Jun. 17, 2022, which is a continuation of copending International Application No. PCT/EP2020/087489, filed Dec. 21, 2020, which is incorporated herein by reference in its entirety, and additionally claims priority from European Application No. EP 19 218 862.1, filed Dec. 20, 2019, which is incorporated herein by reference in its entirety.

Embodiments according to the invention are related to coding concepts for neural networks parameters.

### BACKGROUND OF THE INVENTION

### 1 Application Area

In their most basic form, neural networks constitute a chain of affine transformations followed by an element-wise non-linear function. They may be represented as a directed acyclic graph, as depicted in FIG. 1. FIG. 1 shows a schematic diagram of an Illustration of a neural network, here exemplarily a 2-layered feed forward neural network. In other words, FIG. 1 shows a graph representation of a feed forward neural network. Specifically, this 2-layered neural network is a non linear function which maps a 4-dimensional input vector into the real line. The neural network comprises 4 neurons 10c, according to the 4-dimensional input vector, in an Input layer which is an input of the neural network and 5 neurons 10c in a Hidden layer, and 1 neuron 10c in the Output layer which forms an output of the neural network. The neural network further comprises neuron interconnections 11, connecting neurons from different-or subsequent-layers. The neuron interconnections 11 may be associated with weights, wherein the weights are associated with a relationship between the neurons 10c connected with each other. In particular, the weights weight the activation of neurons of one layer when forwarded to a subsequent layer, where, in turn, a sum of the inbound weighted activations is formed at each neuron of that subsequent layer-corresponding to the linear function-followed by a non-linear scalar function applied to the weighted sum formed at each neuron/node of the subsequent layer-corresponding to the non-linear function. Thus, each node, e.g. neuron 10c, entails a particular value, which is forward propagated into the next node by multiplication with the respective weight value of the edge, e.g. the neuron interconnections 11. All incoming values are then simply aggregated.

Mathematically, the neural network of FIG. 1 would calculate the output in the following manner:

$$output = σ ( {W}_{2} \cdot σ ( {W}_{1} \cdot input ) )$$

where W2 and W1 are neural networks parameters, e.g., the neural networks weight parameters (edge weights) and sigma is some non-linear function. For instance, so-called convolutional layers may also be used by casting them as matrix-matrix products as described in [1]. From now on, we will refer as inference the procedure of calculating the output from a given input. Also, we will call intermediate results as hidden layers or hidden activation values, which constitute a linear transformation+element-wise non-linearity, e.g., such as the calculation of the first dot product+non-linearity above.

Usually, neural networks are equipped with millions of parameters, and may thus require hundreds of MB (e.g. Megabyte) in order to be represented. Consequently, they require high computational resources in order to be executed since their inference procedure involves computations of many dot product operations between large matrices. Hence, it is of high importance to reduce the complexity of performing these dot products.

Likewise, in addition to the abovementioned problems, the large number of parameters of neural networks has to be stored and may even need to be transmitted, for example from a server to a client. Further, sometimes it is favorable to be able to provide entities with information on a parametrization of a neural network gradually such as in a federated learning environment, or in case of offering a neural network parametrization at different stages of quality which a certain recipient has paid for, or is able to deal with when using the neural network for inference.

### SUMMARY

An embodiment may have an apparatus for decoding neural network parameters, which define a neural network, from a data stream, configured to sequentially decode the neural network parameters by selecting, for a current neural network parameter, a set of reconstruction levels out of a plurality of reconstruction level sets depending on quantization indices decoded from the data stream for previous neural network parameters, decoding a quantization index for the current neural network parameter from the data stream, wherein the quantization index indicates one reconstruction level out of the selected set of reconstruction levels for the current neural network parameter, dequantizing the current neural network parameter onto the one reconstruction level of the selected set of reconstruction levels that is indicated by the quantization index for the current neural network parameter.

Another embodiment may have an apparatus for encoding neural network parameters, which define a neural network, into a data stream, configured to sequentially encode the neural network parameters by selecting, for a current neural network parameter, a set of reconstruction levels out of a plurality of reconstruction level sets depending on quantization indices encoded into the data stream for previously encoded neural network parameters, quantizing the current neural network parameter onto the one reconstruction level of the selected set of reconstruction levels, and encoding a quantization index for the current neural network parameter that indicates the one reconstruction level onto which the quantization index for the current neural network parameter is quantized into the data stream.

Another embodiment may have an apparatus for reconstructing neural network parameters, which define a neural network, configured to derive first neural network parameters for a first reconstruction layer to yield, per neural network parameter, a first-reconstruction-layer neural network parameter value, decode second neural network parameters for a second reconstruction layer from a data stream to yield, per neural network parameter, a second-reconstruction-layer neural network parameter value, and reconstruct the neural network parameters by, for each neural network parameter, combining the first-reconstruction-layer neural network parameter value and the second-reconstruction-layer neural network parameter value.

Another embodiment may have an apparatus for encoding neural network parameters, which define a neural network, by using first neural network parameters for a first reconstruction layer which comprise, per neural network parameter, a first-reconstruction-layer neural network parameter value, and the apparatus being configured to encode second neural network parameters for a second reconstruction layer into a data stream, which comprise, per neural network parameter, a second-reconstruction-layer neural network parameter value, wherein the neural network parameters are reconstructible by, for each neural network parameter, combining the first-reconstruction-layer neural network parameter value and the second-reconstruction-layer neural network parameter value.

Another embodiment may have a method for decoding neural network parameters, which define a neural network, from a data stream, the method comprising: sequentially decoding the neural network parameters by selecting, for a current neural network parameter, a set of reconstruction levels out of a plurality of reconstruction level sets depending on quantization indices decoded from the data stream for previous neural network parameters, decoding a quantization index for the current neural network parameter from the data stream, wherein the quantization index indicates one reconstruction level out of the selected set of reconstruction levels for the current neural network parameter, dequantizing the current neural network parameter onto the one reconstruction level of the selected set of reconstruction levels that is indicated by the quantization index for the current neural network parameter.

Another embodiment may have a method for encoding neural network parameters, which define a neural network, into a data stream, the method comprising: sequentially encoding the neural network parameters by selecting, for a current neural network parameter, a set of reconstruction levels out of a plurality of reconstruction level sets depending on quantization indices encoded into the data stream for previously encoded neural network parameters, quantizing the current neural network parameter onto the one reconstruction level of the selected set of reconstruction levels, and encoding a quantization index for the current neural network parameter that indicates the one reconstruction level onto which the quantization index for the current neural network parameter is quantized into the data stream.

Another embodiment may have a method for reconstructing neural network parameters, which define a neural network, comprising deriving first neural network parameters for a first reconstruction layer to yield, per neural network parameter, a first-reconstruction-layer neural network parameter value, decoding second neural network parameters for a second reconstruction layer from a data stream to yield, per neural network parameter, a second-reconstruction-layer neural network parameter value, and reconstructing the neural network parameters by, for each neural network parameter, combining the first-reconstruction-layer neural network parameter value and the second-reconstruction-layer neural network parameter value.

Another embodiment may have a method for encoding neural network parameters, which define a neural network, by using first neural network parameters for a first reconstruction layer which comprise, per neural network parameter, a first-reconstruction-layer neural network parameter value, and the method comprises encoding second neural network parameters for a second reconstruction layer into a data stream, which comprise, per neural network parameter, a second-reconstruction-layer neural network parameter value, wherein the neural network parameters are reconstructible by, for each neural network parameter, combining the first-reconstruction-layer neural network parameter value and the second-reconstruction-layer neural network parameter value.

Another embodiment may have a data stream encoded by a method according to the invention. Another embodiment may have a method a non-transitory digital storage medium having a computer program stored thereon to perform the methods according to the invention when said program is run by a computer.

Embodiments according to a first aspect of the invention comprise apparatuses for decoding neural network parameters, which define a neural network, from a data stream, configured to sequentially decode the neural network parameters by selecting, for a current neural network parameter, a set of reconstruction levels out of a plurality of reconstruction level sets depending on quantization indices decoded from the data stream for previous neural network parameters. In addition, the apparatuses are configured to sequentially decode the neural network parameters by decoding a quantization index for the current neural network parameter from the data stream, wherein the quantization index indicates one reconstruction level out of the selected set of reconstruction levels for the current neural network parameter, and by dequantizing the current neural network parameter onto the one reconstruction level of the selected set of reconstruction levels that is indicated by the quantization index for the current neural network parameter.

Further embodiments according to a first aspect of the invention comprise apparatuses for encoding neural network parameters, which define a neural network, into a data stream, configured to sequentially encode the neural network parameters by selecting, for a current neural network parameter, a set of reconstruction levels out of a plurality of reconstruction level sets depending on quantization indices encoded into the data stream for previously encoded neural network parameters. In addition, the apparatuses are configured to sequentially encode the neural network parameters by quantizing the current neural network parameter onto the one reconstruction level of the selected set of reconstruction levels, and by encoding a quantization index for the current neural network parameter that indicates the one reconstruction level onto which the quantization index for the current neural network parameter is quantized into the data stream.

Further embodiments according to a first aspect of the invention comprise a method for decoding neural network parameters, which define a neural network, from a data stream. The method comprises sequentially decoding the neural network parameters by selecting, for a current neural network parameter, a set of reconstruction levels out of a plurality of reconstruction level sets depending on quantization indices decoded from the data stream for previous neural network parameters. In addition, the method comprises sequentially encoding the neural network parameters by decoding a quantization index for the current neural network parameter from the data stream, wherein the quantization index indicates one reconstruction level out of the selected set of reconstruction levels for the current neural network parameter, and by dequantizing the current neural network parameter onto the one reconstruction level of the selected set of reconstruction levels that is indicated by the quantization index for the current neural network parameter.

Further embodiments according to a first aspect of the invention comprise a method for encoding neural network parameters, which define a neural network, into a data stream. The method comprises sequentially encoding the neural network parameters by selecting, for a current neural network parameter, a set of reconstruction levels out of a plurality of reconstruction level sets depending on quantization indices encoded into the data stream for previously encoded neural network parameters. In addition, the method comprises sequentially encoding the neural network parameters by quantizing the current neural network parameter onto the one reconstruction level of the selected set of reconstruction levels, and by encoding a quantization index for the current neural network parameter that indicates the one reconstruction level onto which the quantization index for the current neural network parameter is quantized into the data stream.

Embodiments according to a first aspect of the present invention are based on the idea, that neural network parameters may be compressed more efficiently by using a non-constant quantizer, but varying same during coding the neural network parameters, namely by selecting a set of reconstruction levels depending on quantization indices decoded from, or respectively encoded, into the data stream for previous or respectively previously encoded neural network parameters. Therefore, reconstruction vectors, which may refer to an ordered set of neural network parameters, may be packed more densely in the N-dimensional signal space, wherein N denotes the number of neural network parameters in a set of samples to be processed. Such a dependent quantization may be used for the decoding and dequantization by an apparatus for decoding or for quantizing and encoding by an apparatus for encoding respectively.

Embodiments according to a second aspect of the present invention are based on the idea that a more efficient neural network coding may be achieved when done in stages-called reconstruction layers to distinguish them from the layered composition of the neural network in neural layers—and if the parametrizations provided in these stages are then, neural network parameter-wise combined to yield a neural network parametrization improved compared to any of the stages. Thus, apparatuses for reconstructing neural network parameters, which define a neural network, may derive, first neural network parameters, e.g. first-reconstruction-layer neural network parameters, for a first reconstruction layer to yield, per neural network parameter, a first-reconstruction-layer neural network parameter value. The first neural network parameters might have been transmitted previously during, for instance, a federated learning process. Moreover the first neural network parameters may be a first-reconstruction-layer neural network parameter value. In addition, the apparatuses are configured to decode second neural network parameters, e.g. second-reconstruction-layer neural network parameters to distinguish them from the, for example final neural network parameters, for a second reconstruction layer from a data stream to yield, per neural network parameter, a second-reconstruction-layer neural network parameter value. The second neural network parameters might have no self-contained meaning in terms of neural network representation, but might merely lead to a neural network representation, namely the, for example, final neural network parameters, when combined with the parameter of the first representation layer. Furthermore, the apparatuses are configured to reconstruct the neural network parameters by, for each neural network parameter, combining the first-reconstruction-layer neural network parameter value and the second-reconstruction-layer neural network parameter value.

Further embodiments according to a second aspect of the invention comprise apparatuses for encoding neural network parameters, which define a neural network, by using first neural network parameters for a first reconstruction layer which comprise, per neural network parameter, a first-reconstruction-layer neural network parameter value. In addition, the apparatuses are configured to encode second neural network parameters for a second reconstruction layer into a data stream, which comprise, per neural network parameter, a second-reconstruction-layer neural network parameter value, wherein the neural network parameters are reconstructible by, for each neural network parameter, combining the first-reconstruction-layer neural network parameter value and the second-reconstruction-layer neural network parameter value.

Further embodiments according to a second aspect of the invention comprise a method for reconstructing neural network parameters, which define a neural network. The method comprises deriving first neural network parameters, which might have been transmitted previously during, for instance, a federated learning process, and which could for example be called first-reconstruction-layer neural network parameters, for a first reconstruction layer to yield, per neural network parameter, a first-reconstruction-layer neural network parameter value,

In addition, the method comprises decoding second neural network parameters, which could, for example, be called second-reconstruction-layer neural network parameters to distinguish them from the for example final, e.g. reconstructed neural network parameters, for a second reconstruction layer from a data stream to yield, per neural network parameter, a second-reconstruction-layer neural network parameter value, and the method comprises reconstructing the neural network parameters by, for each neural network parameter, combining the first-reconstruction-layer neural network parameter value and the second-reconstruction-layer neural network parameter value. The second neural network parameters might have no self-contained meaning in terms of neural representation, but might merely lead to a neural representation, namely the, for example final neural network parameters, when combined with the parameter of the first representation layer.

Further embodiments according to a second aspect of the invention comprise a method for encoding neural network parameters, which define a neural network, by using first neural network parameters for a first reconstruction layer which comprise, per neural network parameter, a first-reconstruction-layer neural network parameter value. The method comprises encoding second neural network parameters for a second reconstruction layer into a data stream, which comprise, per neural network parameter, a second-reconstruction-layer neural network parameter value, wherein the neural network parameters are reconstructible by, for each neural network parameter, combining the first-reconstruction-layer neural network parameter value and the second-reconstruction-layer neural network parameter value.

Embodiments according to a second aspect of the present invention are based on the idea, that neural networks, e.g. defined by neural network parameters, may be compressed and/or transmitted efficiently, e.g. with a low amount of data in a bitstream, using reconstruction-layers, for example sublayers, such as base-layers and enhancement-layers. The reconstruction layers may be defined, such that the neural network parameters are reconstructible by, for each neural network parameter, combining the first-reconstruction-layer neural network parameter value and the second-reconstruction-layer neural network parameter value. This distribution enables an efficient coding, e.g. encoding and/or decoding, and/or transmission of the neural network parameters. Therefore, second neural network parameters for a second reconstruction layer may be encoded and/or transmitted separately into the data stream.

### BRIEF DESCRIPTION OF THE DRAWINGS

Embodiments of the present invention will be detailed subsequently referring to the appended drawings, in which:

FIG. 1 shows a schematic diagram of an Illustration of a 2-layered feed forward neural network that may be used with embodiments of the invention;

FIG. 2 shows a schematic diagram of a concept for dequantization performed within an apparatus for decoding neural network parameters, which define a neural network from a data stream according to an embodiment;

FIG. 3 shows a schematic diagram of a concept for quantization performed within an apparatus for encoding neural network parameters into a data stream according to an embodiment;

FIG. 4 shows a schematic diagram of a concept for decoding performed within an apparatus for reconstructing neural network parameters, which define a neural network, according to an embodiment;

FIG. 5 shows a schematic diagram of a concept for encoding performed within an apparatus for reconstructing neural network parameters, which define a neural network, according to an embodiment;

FIG. 6 shows a schematic diagram of a concept using reconstruction layers for neural network parameters for usage with embodiments according to the invention;

FIG. 7 shows a schematic diagram of an Illustration of a uniform reconstruction quantizer according to embodiments of the invention;

FIG. 8a-b shows an example of locations of admissible reconstruction vectors for the simple case of two weight parameters according to embodiments of the invention;

FIG. 9a-c shows examples for dependent quantization with two sets of reconstruction levels that are completely determined by a single quantization steps size Δ according to embodiments of the invention;

FIG. 10 shows an example for a pseudo-code illustrating an example for the reconstruction process for neural network parameters, according to embodiments of the invention;

FIG. 11 shows an example for a splitting of the sets of reconstruction levels into two subsets according to embodiments of the invention;

FIG. 12 shows an example of pseudo-code illustrating an example for the reconstruction process of neural network parameters for a layer according to embodiments;

FIG. 13 shows examples for the state transition table sttab and the table setld, which specifies the quantization set associated with the states according to embodiments of the invention;

FIG. 14 shows examples for the state transition table sttab and the table setld, which specifies the quantization set associated with the states, according to embodiments of the invention;

FIG. 15 shows a pseudo-code illustrating an alternative reconstruction process for neural network parameter levels, in which quantization index equal to 0 are excluded from the state transition and dependent scalar quantization, according to embodiments of the invention;

FIG. 16 shows examples of state transitions in dependent scalar quantization as trellis structure according to embodiments of the invention;

FIG. 17 shows an example of a basic trellis cell according to embodiments of the invention;

FIG. 18 shows a Trellis example for dependent scalar quantization of 8 neural network parameters according to embodiments of the invention;

FIG. 19 shows example trellis structures that can be exploited for determining sequences (or blocks) of quantization indexes that minimize a cost measures (such as an Lagrangian cost measure D+A·R), according to embodiments of the invention;

FIG. 20 shows a block diagram of a method for decoding neural network parameters, which define a neural network, from a data stream according to embodiments of the invention;

FIG. 21 shows a block diagram of a method for encoding neural network parameters, which define a neural network, into a data stream according to embodiments of the invention;

FIG. 22 shows a block diagram of a method for reconstructing neural network parameters, which define a neural network, according to embodiments of the invention; and

FIG. 23 shows a block diagram of a method for encoding neural network parameters, which define a neural network, according to embodiments of the invention.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

The description starts with a presentation of some embodiments of the present application.

This description is pretty generic, but provides the reader with an outline of the functionalities on which embodiments of the present application are based. Subsequently, a more detailed description of these functionalities is present, along with a motivation for the embodiments and how they achieve the efficiency gain described above. The details are combinable with the embodiments described now, individually and in combination.

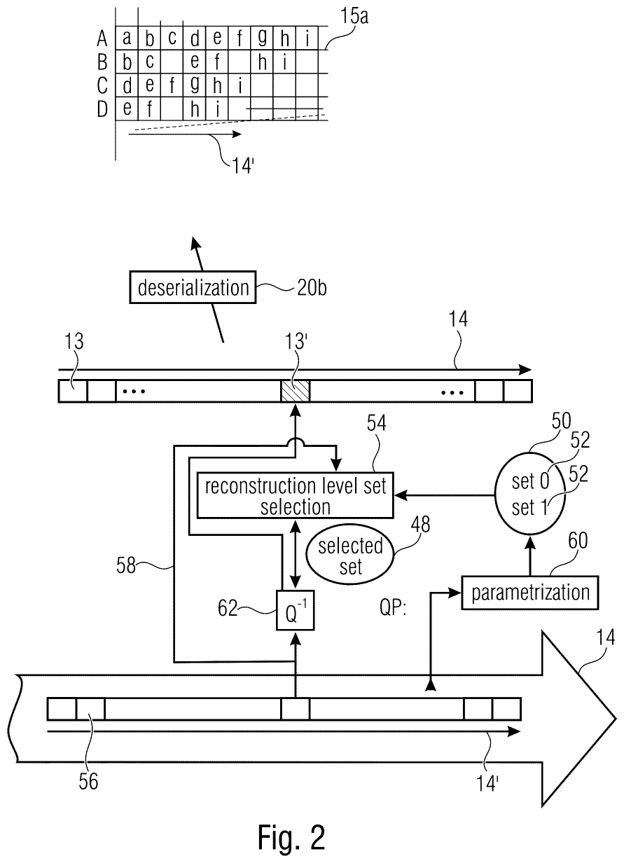

FIG. 2 shows a schematic diagram of a concept for dequantization performed within an apparatus for decoding neural network parameters which define a neural network from a data stream according to an embodiment. The neural network may comprise a plurality of interconnected neural network layers, e.g. with neuron interconnections between neurons of the interconnected layers. FIG. 2 shows quantization indexes 56 for neural network parameters 13, for example encoded, in a data stream 14. The neural network parameters 13 may, thus, define or parametrize a neural network such as in terms of its weights between its neurons.

The apparatus is configured to sequentially decode the neural network parameters 13. During this sequential processing, the quantizer (reconstruction level set) is varied. This variation enables to use quantizers with fewer (or better less dense) levels and, thus, enable smaller quantization indices to be coded, wherein the quality of the neural network representation resulting from this quantization compared to the needed coding bitrate is improved compared to using a constant quantizer. Details are set out later on. In particular, the apparatus sequentially decodes the neural network parameters 13 by selecting 54 (reconstruction level selection), for a current neural network parameter 13′, a set 48 (selected set) of reconstruction levels out of a plurality 50 of reconstruction level sets 52 (set 0, set 1) depending on quantization indices 58 decoded from the data stream 14 for previous neural network parameters.

In addition, the apparatus is configured to sequentially decode the neural network parameters 13 by decoding a quantization index 56 for the current neural network parameter 13′ from the data stream 14, wherein the quantization index 56 indicates one reconstruction level out of the selected set 48 of reconstruction levels for the current neural network parameter, and by dequantizing 62 the current neural network parameter 13′ onto the one reconstruction level of the selected set 48 of reconstruction levels that is indicated by the quantization index 56 for the current neural network parameter.

The decoded neural network parameters 13 are, as an example, represented with a matrix 15a. The matrix may contain deserialized 20b (deserialization) neural network parameters 13, which may relate to weights of neuron interconnections of the neural network.

Optionally, the number of reconstruction level sets 52, also called quantizers sometimes herein, of the plurality 50 of reconstruction level sets 52 may be two, for example set 0 and set 1 as shown in FIG. 2.

Moreover, the apparatus may be configured to parametrize 60 (parametrization) the plurality 50 of reconstruction level sets 52 (e.g., set 0, set 1) by way of a predetermined quantization step size (QP), for example denoted by A or Ak, and derive information on the predetermined quantization step size from the data stream 14. Therefore, a decoder according to embodiments may adapt to a variable step size (QP).

Furthermore, according to embodiments, the neural network may comprise one or more NN layers and the apparatus may be configured to derive, for each NN layer, an information on a predetermined quantization step size (QP) for the respective NN layer from the data stream 14, and to parametrize, for each NN layer, the plurality 50 of reconstruction level sets 52 using the predetermined quantization step size derived for the respective NN layer so as to be used for dequantizing the neural network parameters belonging to the respective NN layer.

Adaptation of the step size and therefore of the reconstruction level sets 52 with respect to NN layers may improve coding efficiency.

According to further embodiments, the apparatus may be configured to select 54, for the current neural network parameter 13′, the set 48 of reconstruction levels out of the plurality 50 of reconstruction level sets 52 depending on a LSB (e.g. least significant bit) portion or previously decoded bins (e.g. binary decision) of a binarization of the quantization indices 58 decoded from the data stream 14 for previously decoded neural network parameters. A LSB comparison may be performed with low computational costs. In particular, a state transitioning may be used. The selection 54 may be performed for the current neural network parameter 13′ out of the set 48 of quantization levels out of the plurality 50 of reconstruction level sets 52 by means of a state transition process by determining, for the current neural network parameter 13′, the set 48 of reconstruction levels out of the plurality 50 of reconstruction level sets 52 depending on a state associated with the current neural network parameter 13′, and by updating the state for a subsequent neural network parameter depending on the quantization index 58 decoded from the data stream for the immediately preceding neural network parameter. Alternative approaches, other than state transitioning by use of, for instance, a transition table, may be used as well and are set out below.

Additionally, or alternatively, the apparatus may, for example, be configured to select 54, for the current neural network parameter 13′, the set 48 of reconstruction levels out of the plurality 50 of reconstruction level sets 52 depending on the results of a binary function of the quantization indices 58 decoded from the data stream 14 for previously decoded neural network parameters. The binary function may, for example, be a parity check, e.g. using a bit-wise “and” operation, signaling whether the quantization indices 58 represent even or odd numbers. This may provide an information about the set 48 of reconstruction levels used to encode the quantization indices 58 and therefore, e.g. because of a predetermined order of reconstruction levels sets used in a corresponding encoder, for the set of reconstruction levels used to encode the current neural network parameter 13′. The parity may be used for the state transition mentioned before.

Moreover, according to embodiments, the apparatus may, for example, be configured to select 54, for the current neural network parameter 13′, the set 48 of reconstruction levels out of the plurality 50 of reconstruction level sets 52 depending on a parity of the quantization indices 58 decoded from the data stream 14 for previously decoded neural network parameters. The parity check may be performed with low computational cost, e.g. using a bit-wise “and” operation.

Optionally, the apparatus may be configured to decode the quantization indices 56 for the neural network parameters 13 and perform the dequantization of the neural network parameters 13 along a common sequential order 14′ among the neural network parameters 13. In other words, the same order may be used for both tasks.

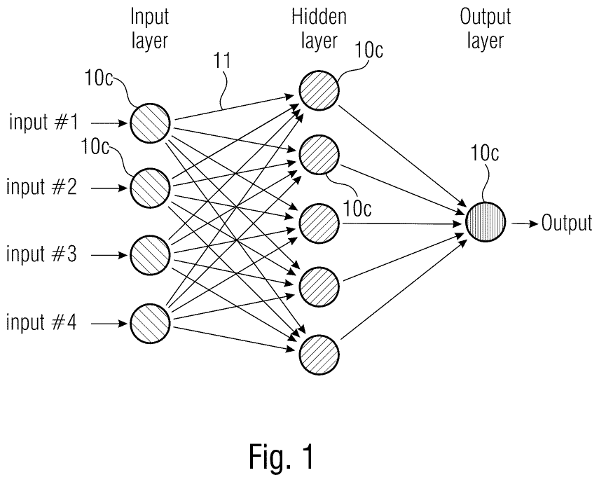

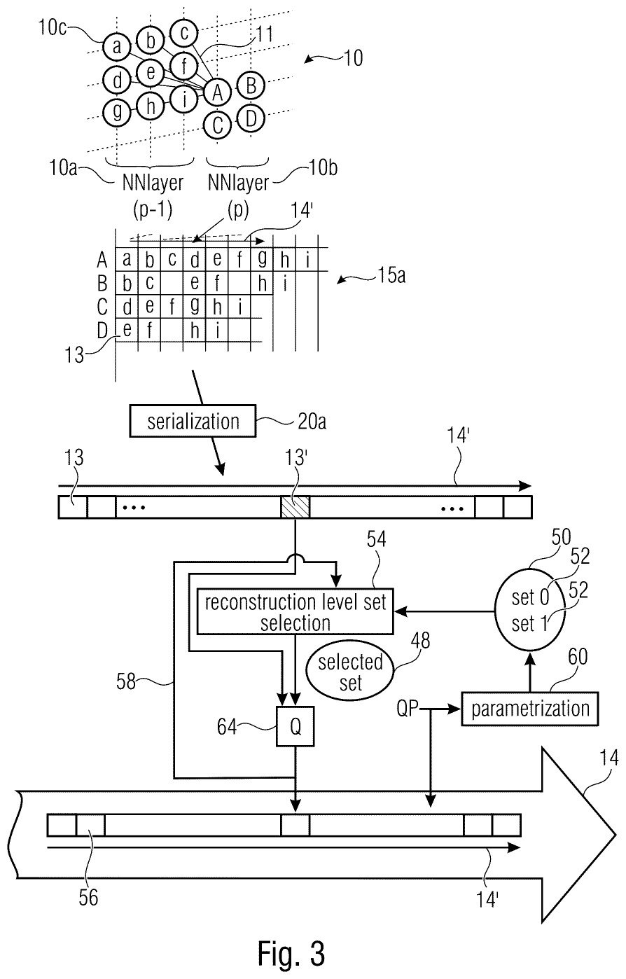

FIG. 3 shows a schematic diagram of a concept for quantization performed within an apparatus for encoding neural network parameters into a data stream according to an embodiment. FIG. 3 shows a neural network (NN) 10 comprising neural network layers 10a, 10b, wherein the layers comprise neurons 10c and wherein the neurons of interconnected layers are interconnected via neuron interconnections 11. As an example, NN layer (p−1) 10a and NN layer (p) 10b are shown, wherein p is an index for the NN layers, with 1≤p≤number of layers of the NN. The neural network is defined or parametrized by neural network parameters 13, which may optionally relate to weights of neuron interconnections 11 of the neural network 10. The neurons 10c of the hidden layer of FIG. 1 may represent the neurons of layer p (A, B, C, . . . ) of FIG. 3, the neurons of the input layer of FIG. 1 may represent the neurons of layer p−1 (a, b, c, . . . ) shown in FIG. 3. The neural network parameters 13 may relate to weights of the neuron interconnections 11 of FIG. 1.

Relationships of the neurons 10c of different layers are represented in FIG. 1 by a matrix 15a of neural network parameters 13. For example, in the case that the network parameters 13 relate to weights of neuron interconnections 11, the matrix 15a may, for example, be structured such that matrix elements represent the weights between neurons 10c of different layers (e.g., a, b, . . . for layer p−1 and A, B, . . . for layer p).

The apparatus is configured to sequentially encode, for example in serial 20a (serialization), the neural network parameters 13. During this sequential processing, the quantizer (reconstruction level set) is varied. This variation enables to use quantizers with fewer (or better less dense) levels and, thus, enable smaller quantization indices to be coded, wherein the quality of the neural network representation resulting from this quantization compared to the needed coding bitrate is improved compared to using a constant quantizer. Details are set out later on. In particular, the apparatus sequentially enocde the neural network parameters 13 by selecting 54, for a current neural network parameter 13′, a set 48 of reconstruction levels out of a plurality 50 of reconstruction level sets 52 depending on quantization indices 58 encoded into the data stream 14 for previously encoded neural network parameters.

In addition, the apparatus is configured to sequentially encode the neural network parameters 13 by quantizing 64 (Q) the current neural network parameter 13′ onto the one reconstruction level of the selected set 48 of reconstruction levels, and by encoding a quantization index 56 for the current neural network parameter 13′ that indicates the one reconstruction level onto which the quantization index 56 for the current neural network parameter is quantized into the data stream 14. Optionally, the number of reconstruction level sets 52, also called quantizers sometimes herein, of the plurality 50 of reconstruction level sets 52 may be two, e.g. as shown using a set 0 and a set 1.

According to embodiments, as shown in FIG. 3, the apparatus may, for example, be configured to parametrize 60 the plurality 50 of reconstruction level sets 52 by way of a predetermined quantization step size (QP) and insert information on the predetermined quantization step size into the data stream 14. This may enable an adaptive quantization, for example to improve quantization efficiency, wherein a change in the way neural network parameter 13 are encoded may be communicated to a decoder with the information on the predetermined quantization step size. By using a predetermined quantization step size (QP) the amount of data for the transmission of the information may be reduced.

Furthermore, according to embodiments, the neural network 10 may comprise one or more NN layers 10a, 10b and the apparatus may be configured to insert, for each NN layer (p; p−1), information on a predetermined quantization step size (QP) for the respective NN layer into the data stream 14, and to parametrize, for each NN layer, the plurality 50 of reconstruction level sets 52 using the predetermined quantization step size derived for the respective NN layer so as to be used for quantizing the neural network parameters belonging to the respective NN layer. As explained before, an adaptation of the quantization, e.g. according to NN layers or characteristics of NN layers, may improve quantization efficiency.

Optionally, the apparatus may be configured to select 54, for the current neural network parameter 13′, the set 48 of reconstruction levels out of the plurality 50 of reconstruction level sets 52 depending on a LSB portion or previously encoded bins of a binarization of the quantization indices 58 encoded into the data stream 14 for previously encoded neural network parameters. A LSB comparison may be performed with low computational costs.

Analogously, to the apparatus for decoding explained in FIG. 2, a state transitioning may be used. The selection 54 may be performed for the current neural network parameter 13′ out of the set 48 of quantization levels out of the plurality 50 of reconstruction level sets 52 by means of a state transition process by determining, for the current neural network parameter 13′, the set 48 of reconstruction levels out of the plurality 50 of reconstruction level sets 52 depending on a state associated with the current neural network parameter 13′, and by updating the state for a subsequent neural network parameter depending on the quantization index 58 encoded into the data stream for the immediately preceding neural network parameter Alternative approaches, other than state transitioning by use of, for instance, a transition table, may be used as well and are set out below.

Additionally, or alternatively, the apparatus may be configured to select 54, for the current neural network parameter 13′, the set 48 of reconstruction levels out of the plurality 50 of reconstruction level sets 52 depending on the results of a binary function of the quantization indices 58 encoded into the data stream 14 for previously encoded neural network parameters. The binary function may, for example, be a parity check, e.g. using a bit-wise “and” operation, signaling whether the quantization indices 58 represent even or odd numbers. This may provide an information about the set 48 of reconstruction levels used to encode the quantization indices 58 and may therefore determine, e.g. because of a predetermined order of reconstruction levels, the set 48 of reconstruction levels for the current neural network parameter 13′, for example such that a corresponding decoder may be able to select the corresponding set 48 of reconstruction levels because of the predetermined order. The parity may be used for the state transition mentioned before.

Furthermore, according to embodiments, the apparatus may, for example, be configured to select 54, for the current neural network parameter 13′, the set 48 of quantization levels out of the plurality 50 of reconstruction level sets 52 depending on a parity of the quantization indices 56 encoded into the data stream 14 for previously encoded neural network parameters. The parity check may be performed with low computational cost, e.g. using a bit-wise “and” operation.

Optionally, the apparatus may be configured to encode the quantization indices (56) for the neural network parameters (13) and perform the quantization of the neural network parameters (13) along a common sequential order (14′) among the neural network parameters (13). In other words, the same order may be used for both tasks.

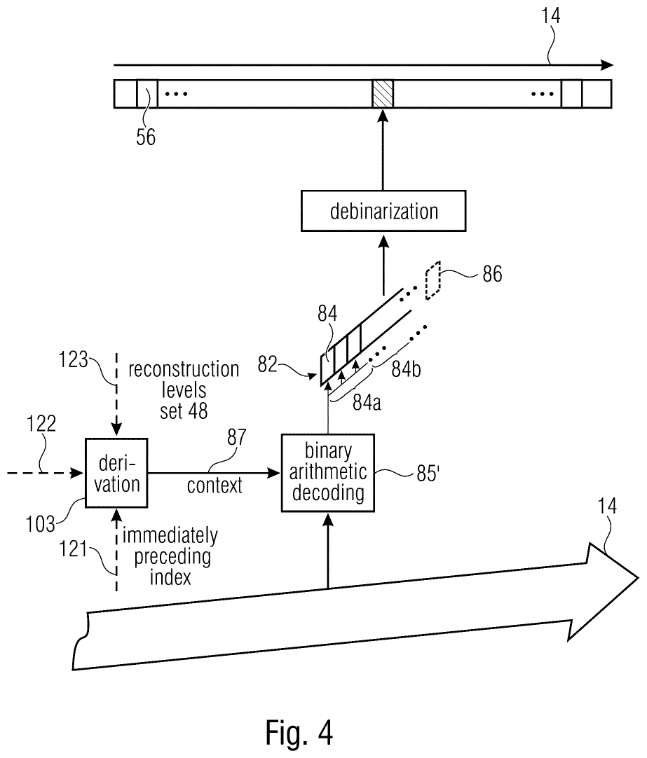

FIG. 4 shows a schematic diagram of a concept for arithmetic decoding the quantized neural networks parameters according to an embodiment. It may be used within an apparatus of FIG. 2. FIG. 4 may thus be seen as a possible extension of FIG. 2. It shows the data stream 14 from which a quantization index 56 for the current neural network parameter 13′ is decoded by the apparatus of FIG. 4 using arithmetic coding, e.g. as shown as an optional example by use of binary arithmetic coding. A probability model, e.g. defined by a certain context, is used which depends on, as indicted by arrow 123, the set 48 of reconstruction levels selected for the current neural network parameter 13′. Details are set hereinbelow.

As explained with respect to FIG. 2, a selection 54 is performed for the current neural network parameter 13′, which selects the set 48 of quantization levels out of the plurality 50 of reconstruction level sets 52 by means of a state transition process by determining, for the current neural network parameter 13′, the set 48 of reconstruction levels out of the plurality 50 of reconstruction level sets 52 depending on a state associated with the current neural network parameter 13′, and by updating the state for a subsequent neural network parameter depending on the quantization index 58 decoded from the data stream for the immediately preceding neural network parameter. The state, thus, is quasi a pointer to the set 48 of reconstruction levels to be used for encoding/decoding the current neural network parameter 13′, which is, however, updated at a granularity finer as only distinguishing the number states corresponding to the number of reconstruction sets so that the state, quasi, acts as a memory of past neural network parameters or past quantization indices. Thus, the state defines the order of sets of reconstruction levels used to encode/decode the neural network parameters 13. According to FIG. 4, for example, the quantization index (56) for the current neural network parameter (13′) is decoded from the data stream (14) using arithmetic coding using a probability model which depends on (122) the state for the current neural network parameter (13′). Adapting the probability model depending on the state may improve coding efficiency as the probability model estimation may be better. In addition, adaption based on the state may enable a computationally efficient adaption with low amounts of additional data transmitted.

According to further embodiments, the apparatus may, for example be configured to decode the quantization index 56 for the current neural network parameter 13′ from the data stream 14 using binary arithmetic coding by using the probability model which depends on 122 the state for the current neural network parameter 13′ for at least one bin 84 of a binarization 82 of the quantization index 56.

Additionally, or alternatively, the apparatus may be configured so that the dependency of the probability model involves a selection 103 (derivation) of a context 87 out of a set of contexts for the neural network parameters using the dependency, each context having a predetermined probability model associated therewith. The better the probability estimate used, the more efficient the compression. The probability models may be updated, e.g. using context adaptive (binary) arithmetic coding.

Optionally, the apparatus may be configured to update the predetermined probability model associated with each of the contexts based on the quantization index arithmetically coded using the respective context. Thus, the contexts' probability models are adapted to the actual statistics.

Moreover, the apparatus may, for example, be configured to decode the quantization index 56 for the current neural network parameter 13′ from the data stream 14 using binary arithmetic coding by using a probability model which depends on the set 48 of reconstruction levels selected for the current neural network parameter 13′ for at least one bin of a binarization of the quantization index.

Optionally, the at least one bin may comprise a significance bin indicative of the quantization index 56 of the current neural network parameter being equal to zero or not. Additionally, or alternatively, the at least one bin may comprise a sign bin indicative of the quantization index 56 of the current neural network parameter being greater than zero or lower than zero. Furthermore, the at least one bin may comprise a greater-than-X bin indicative of an absolute value of the quantization index 56 of the current neural network parameter being greater than X or not, wherein X is an integer greater than zero.

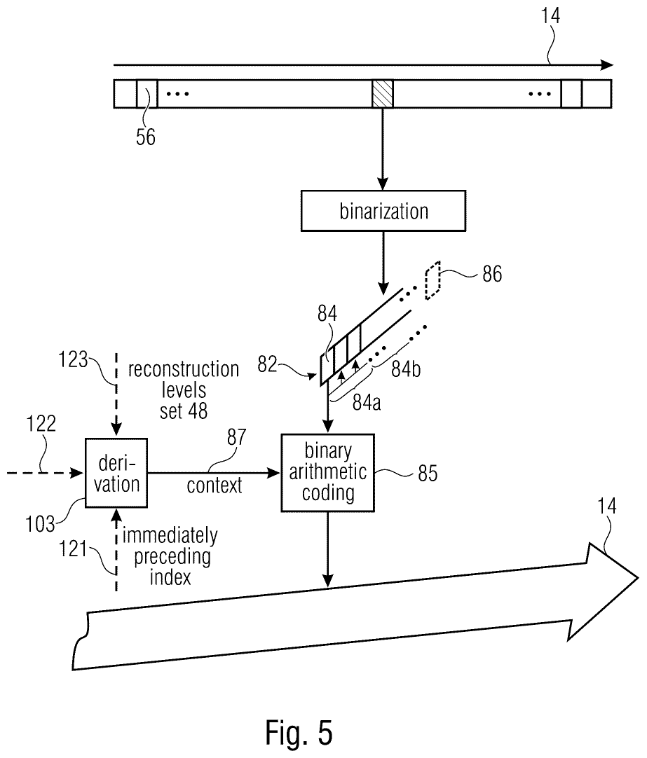

The following, FIG. 5 may describe the counterpart of the concepts for decoding explained with FIG. 4. Therefore, all explanations and advantages may be applicable accordingly, to the aspects of the following concepts for encoding.

FIG. 5 shows a schematic diagram of a concept for arithmetic encoding neural networks parameters according to an embodiment. It may be used within an apparatus of FIG. 3. FIG. 5 may thus be seen as a possible extension of FIG. 3. It shows the data stream 14 to which a quantization index 56 for the current neural network parameter 13′ is encoded by the apparatus of FIG. 3 using arithmetic coding, e.g. as shown as an optional example as by use of binary arithmetic coding. A probability model, e.g. defined by a certain context, is used which depends on, as indicted by arrow 123, the set 48 of reconstruction levels selected for the current neural network parameter 13′. Details are set hereinbelow.

As explained with respect to FIG. 3, a selection 54 is performed, for the current neural network parameter 13′, which selects the set 48 of quantization levels out of the plurality 50 of reconstruction level sets 52 by means of a state transition process by determining, for the current neural network parameter 13′, the set 48 of quantization levels out of the plurality 50 of reconstruction level sets 52 depending on a state associated with the current neural network parameter 13′ and by updating the state for a subsequent neural network parameter depending on the quantization index 58 encoded into the data stream for the immediately preceding neural network parameter.

The state, thus, is quasi a pointer to the set 48 of reconstruction levels to be used for encoding/decoding the current neural network parameter 13′, which is, however, updated at a granularity finer as only distinguishing the number states corresponding to the number of reconstruction sets so that the state, quasi, acts as a memory of past neural network parameters or past quantization indices. Thus, the state defines the order of sets of reconstruction levels used to encode/decode the neural network parameters 13.

In addition, the quantization index 56 for the current neural network parameter 13′ may be encoded into the data stream 14 using arithmetic coding using a probability model which depends on 122 the state for the current neural network parameter 13′.

According to FIG. 3 for example the quantization index 56 is encoded for the current neural network parameter 13′ into the data stream 14 using binary arithmetic coding by using the probability model which depends on 122 the state for the current neural network parameter 13′ for at least one bin 84 of a binarization 82 of the quantization index 56. Adapting the probability model depending on the state may improve coding efficiency as the probability model may be probability model estimation may be better. In addition, adaption based on the state may enable a computationally efficient adaption with low amounts of additional data transmitted.

Additionally, or alternatively, the apparatus may be configured so that the dependency of the probability model involves a selection 103 (derivation) of a context 87 out of a set of contexts for the neural network parameters using the dependency, each context having a predetermined probability model associated therewith.

Optionally, the apparatus may be configured to update the predetermined probability model associated with each of the contexts based on the quantization index arithmetically coded using the respective context.

Moreover, the apparatus may, for example, be configured to encode the quantization index 56 for the current neural network parameter 13′ into the data stream 14 using binary arithmetic coding by using a probability model which depends on the set 48 of reconstruction levels selected for the current neural network parameter 13′ for at least one bin of a binarization of the quantization index. For using binary arithmetic coding quantization indexes 56 may be binarized (binarization).

Optionally, the at least one bin may comprise a significance bin indicative of the quantization index 56 of the current neural network parameter being equal to zero or not. Additionally, or alternatively, the at least one bin may comprise a sign bin indicative of the quantization index 56 of the current neural network parameter being greater than zero or lower than zero. Furthermore, the at least one bin may comprise a greater-than-X bin indicative of an absolute value of the quantization index 56 of the current neural network parameter being greater than X or not, wherein X is an integer greater than zero.

The embodiments described next, concentrate on another aspect of the present application according to which the parametrization of a neural network is coded in stages or reconstruction layers so that, per NN parameter, one value from each stage need to be combined to yield an improved/enhanced representation of the neural network, enhanced to either one of the contributing stages among which at least one might itself represent a reasonable representation of the neural network, but at lower quality, although the latter possibility is not mandatory for the present aspect.

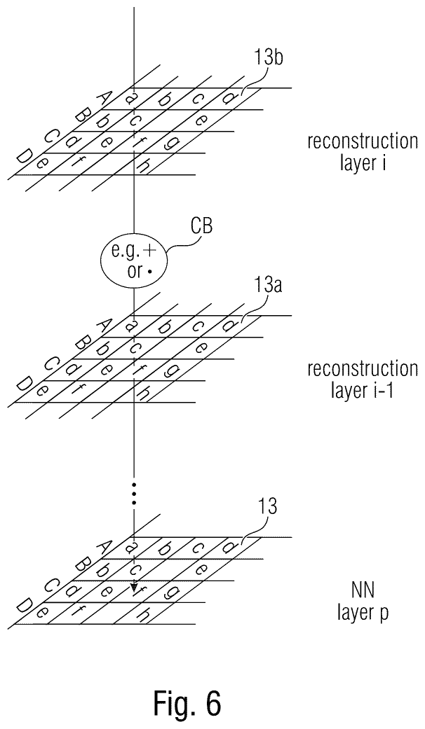

FIG. 6 shows a schematic diagram of a concept using reconstruction layers for neural network parameters for usage with embodiments according to the invention. FIG. 6 shows a reconstruction layer i, for example a second reconstruction layer, a reconstruction layer i-1, for example a first reconstruction layer and a neural network (NN) layer p, for example layer 10b from FIG. 3, represented in a layer e.g. in the form of an array or a matrix, such as matrix 15a from FIG. 3.

FIG. 6 shows the concept of an apparatus 310 for reconstructing neural network parameters 13, which define a neural network. Therefore, the apparatus is configured to derive first neural network parameters 13a, which may have been transmitted previously during, for instance, a federated learning process and which may, for example, be called first-reconstruction-layer neural network parameters, for a first reconstruction layer, e.g. reconstruction layer i-1, to yield, per neural network parameter, e.g. per weight or per inter-neuron connection, a first-reconstruction-layer neural network parameter value. This derivation might involve decoding or receiving the first neural network parameters 13a otherwise. Furthermore, the apparatus is configured to decode 312 second neural network parameters 13b, which may, for example, be called second-reconstruction-layer neural network parameters to distinguish them from the for example final neural network parameters, e.g. parameters 13, for a second reconstruction layer from a data stream 14 to yield, per neural network parameter 13, a second-reconstruction-layer neural network parameter value. Two contributing values, of first and second reconstruction layers, may, thus, be obtained per NN parameter, and the coding/decoding of the first and/or the second NN parameter values may use dependent quantization according to FIG. 2 and FIG. 3 and/or arithmetic coding/decoding of the quantization indices as explained in FIGS. 4 and 5. The second neural network parameters 13b might have no self-contained meaning in terms of neural representation, but might merely lead to a neural network representation, namely the final neural network parameters, when combined with the parameter of the first representation layer.

In addition, the apparatus is configured to reconstruct 314 the neural network parameters 13 by, for each neural network parameter, combining (CB), e.g. using element-wise addition and/or multiplication, the first-reconstruction-layer neural network parameter value and the second-reconstruction-layer neural network parameter value.

Additionally, FIG. 6 shows a concept for an apparatus 320 for encoding neural network parameters 13, which define a neural network, by using first neural network parameters 13a for a first reconstruction layer, e.g. reconstruction layer i-1, which comprise, per neural network parameter 13, a first-reconstruction-layer neural network parameter value. Therefore, the apparatus is configured to encode 322 second neural network parameters 13b for a second reconstruction layer, e.g. reconstruction layer i, into a data stream, which comprise, per neural network parameter 13, a second-reconstruction-layer neural network parameter value, wherein the neural network parameters 13 are reconstructible by, for each neural network parameter, combining (CB), e.g. using element-wise addition and/or multiplication, the first-reconstruction-layer neural network parameter value and the second-reconstruction-layer neural network parameter value.

Optionally, apparatus 310 may be configured to decode 316 the first neural network parameters for the first reconstruction layer from the data stream 14 or from a separate data stream

In simple words, the decomposition of neural network parameters 13 may enable a more efficient encoding and/or decoding and transmission of the parameters.

In the following, further embodiments, comprising, inter alia, Neural Network Coding Concepts are disclosed. The following description provides further details which may be combined with the embodiments described above, individually and in combination.

Firstly, a method for Entropy Coding of Parameters of Neural Networks with Dependent Scalar Quantization according to embodiments of the invention will be presented.

A method for parameter coding of a set of neural network parameters 13 (also referred to as weights, weight parameters or parameters) using dependent scalar quantization is described. The parameter coding presented herein consists of a dependent scalar quantization (e.g., as described in the context of FIG. 3) of the parameters 13 and an entropy coding of the obtained quantization indexes 56 (e.g., as described in the context of FIG. 5). At the decode side, the set of reconstructed neural network parameters 13 is obtained by entropy decoding of the quantization indexes 56 (e.g., as described in the context of FIG. 4), and a dependent reconstruction of neural network parameters 13 (e.g., as described in the context of FIG. 2). In contrast to parameter coding with independent and scalar quantization and entropy coding, the set of admissible reconstruction levels for a neural network parameter 13 depends on the transmitted quantization indexes 56 that precede the current neural network parameter 13′ in reconstruction order. The presentation set forth below additionally describes methods for entropy coding of the quantization indexes that specify the reconstruction levels used in dependent scalar quantization.

The description is mainly targeted on a lossy coding of layers of neural network parameters in neural network compression, but in can also be applied to other areas of lossy coding.

The methodology of the apparatus may be divided into different main parts, which consist of the following:
1. Quantization
2. Lossless Encoding
3. Lossless Decoding

In order to understand the main advantages of the embodiments set out below, we will firstly give a brief introduction on the topic of neural networks and on related methods for parameter coding. Nevertheless, all aspects, features and concepts disclosed may be used separately or in combination with embodiments described herein.

### 2 Related Methods for Quantization and Entropy Coding

Working draft 2 of the MPEG-7 part 17 standard for compression of neural networks for multimedia content description and analysis [2] applies independent scalar quantization and entropy coding for neural network parameter coding.

### 2.1 Scalar Quantizers

The neural network parameters are quantized using scalar quantizers. As a result of the quantization, the set of admissible values for the parameters 13 is reduced. In other words, the neural network parameters are mapped to a countable set (in practice, a finite set) of so-called reconstruction levels. The set of reconstruction levels represents a proper subset of the set of possible neural network parameter values. For simplifying the following entropy coding, the admissible reconstruction levels are represented by quantization indexes 56, which are transmitted as part of the bitstream 14. At the decoder side, the quantization indexes 56 are mapped to reconstructed neural network parameters 13. The possible values for the reconstructed neural network parameters 13 correspond to the set 52 of reconstruction levels. At the encoder side, the result of scalar quantization is a set of (integer) quantization indexes 56.

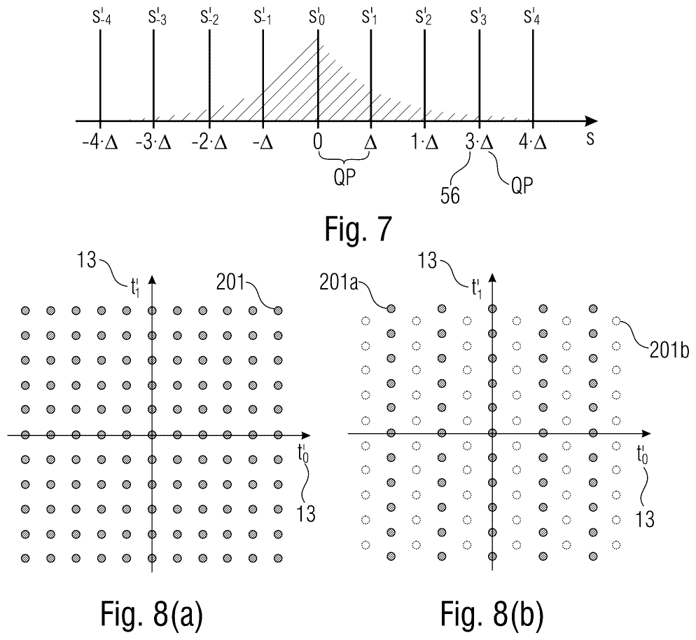

In this application uniform reconstruction quantizers (URQs) are used. Their basic design is illustrated in FIG. 7. FIG. 7 shows an Illustration of a uniform reconstruction quantizer. URQs have the property that the reconstruction levels are equally spaced. The distance Δ(QP) between two neighboring reconstruction levels is referred to as quantization step size. One of the reconstruction levels is equal to 0. Hence, the complete set of available reconstruction levels, e.g. s′ᵢ, i ∈N₀, is uniquely specified by the quantization step size Δ(QP). The decoder mapping of quantization indexes q 56 to reconstructed weight parameters t′ 13′ is, in principle, given by the simple formula

$${t}^{′} = q \cdot Δ .$$

In this context, the term “independent scalar quantization” refers to the property that, given the quantization index q 56 for any weight parameter 13, the associated reconstructed weight parameter t′ 13′ can be determined independently of all quantization indexes for the other weight parameters.

### 2.1.1 Encoder Operation: Quantization

Standards for compression of neural networks only specify the bitstream syntax and the reconstruction process. If we consider parameter coding for a given set of original neural network parameters 13 and given quantization step sizes (QP), the encoder has a lot a freedom. Given the quantization indexes qₖ 56 for a layer 10a, 10b, the entropy coding has to follow a uniquely defined algorithm for writing the data to the bitstream 14 (i.e., constructing the arithmetic codeword). But the encoder algorithm for obtaining the quantization indexes qₖ 56 given an original set (e.g. a layer) of weight parameters is out of the scope of neural network compression standards. For the following description, we assume the quantization step size (QP) for each neural network parameter 13 is known. Still, the encoder has the freedom to select a quantizer index qₖ 56 for each neural network (weight) parameter tₖ 13. Since the selection of quantization indexes determines both the distortion (or reconstruction/approximation quality) and the bit rate, the quantization algorithm used has a substantial impact on the rate-distortion performance of the produced bitstream 14.

The simplest quantization method rounds the neural network parameters tₖ 13 to the nearest reconstruction levels (also referred to as nearest neighbor quantization). For the typically used URQs, the corresponding quantization index q 56 can be determined according to

$${q}_{k} = sgn ( {t}_{k} ) \cdot ⌊ \frac{\vert {t}_{k} \vert}{{Δ}_{k}} + \frac{1}{2} ⌋ ,$$

where sgn ( ) is the sign function and the operator [.] returns the largest integer that is smaller or equal to its argument. This quantization method guarantees that the MSE distortion

$$D = {\sum }_{k} {D}_{k} = {\sum }_{k} {( {t}_{k} - {q}_{k} \cdot {Δ}_{k} )}^{2}$$

is minimized, but it completely ignores the bit rate that is required for transmitting the resulting parameter levels (weight levels) qₖ 56. Note that, the method is not restricted to the MSE distortion measure, also any other distortion measure e.g. the MAE distortion according to

$${D}^{M A E} = {\sum }_{k} {D}_{k}^{M A E} = {\sum }_{k} \vert {t}_{k} - {q}_{k} \cdot {Δ}_{k} \vert$$

can be used. Typically, better results are obtained if the rounding is biased towards zero:

$${q}_{k} = sgn ( {t}_{k} ) \cdot ⌊ \frac{\vert {t}_{k} \vert}{{Δ}_{k}} + a ⌋ with 0 \leq a < \frac{1}{2} .$$

Better results in rate-distortion sense can be obtained if the quantization process minimizes a Lagrangian function D+λ·R, where D represent the distortion (e.g., MSE distortion or MAE distortion) of the set of neural network parameters, R specifies the number of bits that are required for transmitting the quantization indexes 56, and A is a Lagrange multiplier.

Given the quantization step size the following relationship between the Lagrange multiplier 2 and the quantization step size is often used

$$λ = {c}_{1} \cdot {Δ}^{2} ,$$

where c₁ represents a constant factor for a set of neural network parameters. Quantization algorithms that aim to minimize a Lagrange function D+λ·R of distortion and rate are also referred to as rate-distortion optimized quantization (RDOQ). If we measure the distortion using the MSE or a weighted MSE (or MAE respectively), the quantization indexes qₖ 56 for a set (e.g. a layer) of weight parameters should be determined in a way so that the following cost measure is minimized:

$$D + λ \cdot R = {\sum }_{k} {α}_{k} \cdot {( {t}_{k} - {Δ}_{k} \cdot {q}_{k} )}^{2} + λ \cdot R ( {q}_{k} \vert {q}_{k - 1} , {q}_{k - 2} , … ) .$$

At this, the neural network parameter index k specifies the coding order (or scanning order) of neural network parameters 13. The term R(qₖ|qₖ₋₁, qₖ₋₂, . . . ) represents the number of bits (or an estimate thereof) that are required for transmitting the quantization index qₖ 56. The condition illustrates that (due to the usage of combined or conditional probabilities) the number of bits for a particular quantization index qₖ typically depends on the chosen values for preceding quantization indexes qₖ₋₁, qₖ₋₂, etc. in coding order, e.g. in the common sequential order 14′. The factors ak in the equation above can be used for weighting the contribution of the individual neural network parameters 13. In the following, we generally assume that all weightings factor ax are equal to 1 (but the algorithm can be straightforwardly modified in a way that different weighting factors can be taken into account).

In fact, nearest neighbor quantization is a trivial case with λ=0, which is applied in working draft 2 of the MPEG-7 part 17 standard for compression of neural networks for multimedia content description and analysis.

### 2.2 Entropy Coding

As a result of the uniform quantization, applied in the previous step, the weight parameters are mapped to a finite set of so-called reconstruction levels. Those can be represented by an (integer) quantizer index 56 (also referred to as parameter level or weight level) and the quantization step size (QP), which may, for example, be fixed for a whole layer. In order to restore all quantized weight parameters of a layer, the step size (QP) and dimensions of the layer may be known by the decoder. They may, for example, be transmitted separately.

2.2.1 Encoding of quantization indexes with context-adaptive binary arithmetic coding (CABAC)

The quantization indexes 56 (integer representation) are then transmitted using entropy coding techniques. Therefore, a layer of weights is mapped onto a sequence of quantized weight levels using a scan. For example, a row first scan order can be used, starting with the upper-most row of the matrix, encoding the contained values from left to right. In this way, all rows are encoded from the top to the bottom. The scan may be performed as shown in FIG. 3 for the matrix 15a, e.g. along a common sequential order 14′, comprising the neural network parameters 13, which may relate to the weights of neuron interconnections 11. The matrix may represent the layer of weights, for example weights between layer p−1 10a and layer p 10b or the hidden layer and the input layer of neuron interconnections 11 as shown in FIGS. 3 and 1 respectively. Note that any other scan can be applied. For example, the matrix (e.g., matrix 15a of FIG. 2 or 3) can be transposed, or flipped horizontally and/or vertically and/or rotated by 90/180/270 degree to the left or right, before applying the row-first scan

Apparatuses according to embodiments, as explained with respect to FIGS. 3 and 5, may be configured to encode the quantization index 56 for the current neural network parameter 13′ into the data stream 14 using binary arithmetic coding by using the probability model which depends on 122 the state for the current neural network parameter 13′ for at least one bin 84 of a binarization 82 of the quantization index 56. The binary arithmetic coding by using the probability model may be CABAC (Context-Adaptive Binary Arithmetic Coding).

In order words, according to embodiments, for coding of the levels CABAC is used. Refer to [3] for details. So, a quantized weight level q 56 is decomposed in a series of binary symbols or syntax elements, for example bins (binary decisions), which then may be handed to the binary arithmetic coder (CABAC).

In the first step, a binary syntax element sig_flag is derived for the quantized weight level, which specifies whether the corresponding level is equal to zero. In other words, the at least one bin of the binarization 82 of the quantization index 56 shown in FIG. 4 may comprise a significance bin indicative of the quantization index 56 of the current neural network parameter being equal to zero or not.

If the sig_flag is equal to one a further binary syntax element sign_flag is derived. The bin indicates if the current weight level is positive (e.g., bin=0) or negative (e.g., bin=1). In other words, the at least one bin of the binarization 82 of the quantization index 56 shown in FIG. 4 may comprise a sign bin 86 indicative of the quantization index 56 of the current neural network parameter being greater than zero or lower than zero.

Next, a unary sequence of bins is encoded, followed by a fixed length sequence as follows:

A variable k is initialized with a non-negative integer and X is initialized with 1<<k.

One or more syntax elements abs_level greater_X are encoded, which indicate, that the absolute value of the quantized weight level is greater than X. If abs_level_greater_X is equal to 1, the variable k is updated (for example, increased by 1), then 1<<k is added to X and a further abs_level_greater_X is encoded. This procedure is continued until an abs_level_greater_X is equal to 0. Afterwards, a fixed length code of length k suffices to complete the encoding of the quantizer index. For example, a variable rem=X−|q| could be encoded using k bits. Or alternatively, a variable rem′ could be defined as rem′=(1<<k)−rem−1 which is encoded using k bits. Any other mapping of the variable rem to a fixed length code of k bits may alternatively be used.

In other words, the at least one bin of the binarization 82 of the quantization index 56 shown in FIG. 4 may comprise a greater-than-X bin indicative of an absolute value of the quantization index 56 of the current neural network parameter being greater than X or not, wherein X is an integer greater than zero.

When increasing k by 1 after each abs_level_greater_X, this approach is identical to applying exponential Golomb coding (if the sign_flag is not regarded).

Additionally, if the maximum absolute value abs_max is known at the encoder and decoder side, encoding of abs_level_greater_X syntax elements may be terminated, when for the next abs_Level_greater_X to be transmitted, X>=abs_max holds.

2.2.2 Decoding of quantization indexes with context-adaptive binary arithmetic coding (CABAC) Decoding of the quantized weight levels 56 (integer representation) works analogously to the encoding. The decoder first decodes the sig_flag. If it is equal to one, a sign_flag and a unary sequence of abs_level_greater_X follows, where the updates of k, (and thus increments of X) has to follow the same rule as in the encoder. Finally, the fixed length code of k bits is decoded and interpreted as integer number (e.g. as rem or rem′, depending on which of both was encoded). The absolute value of the decoded quantized weight level |q| may then be reconstructed from from X, and form the fixed length part. For example, if rem was used as fixed-length part, |q|=X-rem. Or alternatively, if rem′ was encoded, |q|=X+1+rem′−(1<<k). As a last step, the sign needs to be applied to |q| in dependence on the decoded sign_flag, yielding the quantized weight level q 56. Finally, the quantized weight w is reconstructed by multiplying the quantized weight level q with the step size Δ(QP).

In other words, apparatuses according to embodiments, as explained with respect to FIGS. 2 and 4, may be configured to decode the quantization index 56 for the current neural network parameter 13′ from the data stream 14 using binary arithmetic coding by using the probability model which depends on 122 the state for the current neural network parameter 13′ for at least one bin 84 of a binarization 82 of the quantization index 56.

The at least one bin of the binarization 82 of the quantization index 56 shown in FIG. 5 may comprise a significance bin indicative of the quantization index 56 of the current neural network parameter being equal to zero or not. Additionally or alternatively, the at least one bin may comprise a sign bin 86 indicative of the quantization index 56 of the current neural network parameter being greater than zero or lower than zero. Furthermore, the at least one bin may comprise a greater-than-X bin indicative of an absolute value of the quantization index 56 of the current neural network parameter being greater than X or not, wherein X is an integer greater than zero.

In an embodiment, k is initialized with 0 and updated as follows. After each abs_level_greater_X equal to 1, the required update of k is done according to the following rule: If X>X′, k is incremented by 1 where X′ is a constant depending on the application. For example X′ is a number (e.g. between 0 and 100) that is derived by the encoder and signaled to the decoder.

### 2.2.3 Context Modelling

In the CABAC entropy coding, most syntax elements for the quantized weight levels 56 are coded using a binary probability modelling. Each binary decision (bin) is associated with a context. A context represents a probability model for a class of coded bins. The probability for one of the two possible bin values is estimated for each context based on the values of the bins that have been already coded with the corresponding context. Different context modelling approaches may be applied, depending on the application. Usually, for several bins related to the quantized weight coding, the context, that is used for coding, is selected based on already transmitted syntax elements. Different probability estimators may be chosen, for example SBMP 0, or those of HEVC 0 or VTM-4.0 0, depending on the actual application. The choice affects, for example, the compression efficiency and complexity.

In other words, probability models as explained with respect to FIG. 5, e.g. contexts 87, additionally depend on the quantization index of previously encoded neural network parameters.

Respectively, probability models as explained with respect to FIG. 4, e.g. contexts 87, additionally depend on the quantization index of previously decoded neural network parameters.

A context modeling scheme that fits a wide range of neural networks is described as follows. For decoding a quantized weight level q 56 at a particular position (x,y) in the weight matrix (layer), a local template is applied to the current position. This template contains a number of other (ordered) positions like e.g. (x−1, y), (x, y−1), (x−1, y−1), etc. For each position, a status identifier is derived.

In an embodiment (denoted Si1), a status identifier s_{x,y} for a position (x,y) is derived as follows: If position (x,y) points outside of the matrix, or if the quantized weight level qₖ,y at position (x,y) is not yet decoded or equals zero, the status identifier s_{x,y}=0. Otherwise, the status identifier shall be s_{x,y}=9x,y<0?1:2.

For a particular template, a sequence of status identifiers is derived, and each possible constellation of the values of the status identifiers is mapped to a context index, identifying a context to be used. The template, and the mapping may be different for different syntax elements. For example, from a template containing the (ordered) positions (x−1, y), (x, y−1), (x−1, y−1) an ordered sequence of status identifiers s_{x-1,y}, S_{x,y-1}, S_{x-1,y-1} is derived. For example, this sequence may be mapped to a context index C=S_{x-1,y}+3*S_{x,y-1}+9*S_{x-1,y-1}. For example, the context index C may be used to identify a number of contexts for the sig_flag.

In an embodiment (denoted approach 1), the local template for the sig_flag or for the sign_flag of the quantized weight level qₖ,y at position (x,y) consists of only one position (x−1, y) (i.e., the left neighbor). The associated status identifier s_{x-1,y} is derived according to embodiment Si1.

For the sig_flag, one out of three contexts is selected depending on the value of s_{x-1,y} or for the sign_flag, one out of three other contexts is selected depending on the value of s_{x-1,y}.

In another embodiment (denoted approach 2), the local template for the sig flag contains the three ordered positions (x−1, y), (x−2, y), (x−3, y). The associated sequence of status identifiers S_{x-1,y}, S_{x-2,y}, S_{x-3,y} is derived according to embodiment Si2.

For the sig_flag, the context index C is derived as follows:

If S_{x-1,y}≠0, then C=0. Otherwise, if S_{x-2,y}≠0, then C=1. Otherwise, if S_{x-3,y}≠0, then C=2. Otherwise, C=3.

This may also be expressed by the following equation:

$$C = ( {s}_{x - 1 , y} \neq 0 ) ? 0 : ( ( {s}_{x - 2 y} \neq 0 ) ? 1 : ( ( {s}_{x - 3 y} \neq 0 ) ? 2 : 3 ) )$$

In the same manner, the number of neighbors to the left may be increased or decreased so that the context index C equals the distance to the next nonzero weight to the left (not exceeding the template size).

Each abs_level_greater_X flag may, for example, apply an own set of two contexts. One out of the two contexts is then chosen depending on the value of the sign_flag.

In an embodiment, for abs_level_greater_X flags with X smaller than a predefined number X′, different contexts are distinguished depending on X and/or on the value of the sign_flag.

In an embodiment, for abs_level greater_X flags with X greater or equal to a predefined number X′, different contexts are distinguished only depending on X.

In another embodiment, abs_level_greater_X flags with X greater or equal to a predefined number X′ are encoded using a fixed code length of 1 (e.g. using the bypass mode of an arithmetic coder).

Furthermore, some or all of the syntax elements may also be encoded without the use of a context. Instead, they are encoded with a fixed length of 1 bit. E.g., using a so-called bypass bin of CABAC.

In another embodiment, the fixed-length remainder rem is encoded using the bypass mode.

In another embodiment, the encoder determines a predefined number X′, distinguishes for each syntax element abs_level_greater_X with X<X′ two contexts depending on the sign, and uses for each abs_level_greater_X with X>=X′ one context.

In other words, the probability model, e.g. contexts 87, as explained with respect to FIG. 5, may be selected 103 for the current neural network parameter out of the subset of probability models depending on the quantization index of previously encoded neural network parameters which relate to a portion of the neural network neighboring a portion which the current neural network parameter relates to.

The portion may be defined by a template, for example the template explained above, containing the (ordered) positions (x−1, y), (x, y−1), (x−1, y−1).

Respectively, the probability model, as explained with respect to FIG. 5, may be selected for the current neural network parameter out of the subset of probability models depending on the quantization index of previously decoded neural network parameters which relate to a portion of the neural network neighboring a portion which the current neural network parameter relates to.

### 3 Additional Method

The following describes an additional and therefore optional method for compression/transmission of neural networks 10 for which a reconstructed layer, e.g. neural network layer p from FIG. 6 is a composition of different sublayers, for example reconstruction layer i−1 and reconstruction layer i from FIG. 6, that may, for example, be transmitted separately.

### 3.1 Concept of Base-Layer and Enhancement-Layers

The concept introduces two types of sublayers denoted as base-layers and enhancement-layers. A reconstruction process (e.g. addition of all sublayers) then defines how the reconstructed layer can be obtained from the sublayers. A base-layer contains base values, that may, for example, be chosen such that they can efficiently be represented or compressed/transmitted in a first step. An enhancement layer contains enhancement information, for example differential values that may be added to the (base) layer values in order to reduce a distortion measure (e.g. regarding an original layer). In another example the base layer contains coarse values (from training with a small training set), and the enhancement layers contain refinement values (based on the complete training set or, more generally, another training set). The sublayers may be stored/transmitted separately.

In an embodiment, a layer to be compressed LR, for example a layer of neural network parameters, e.g. neural network weights, such as weights that may be represented by matrix 15a in FIGS. 2 and 3, is decomposed into a base layer LB and one or more enhancement layers L_{E,1}, L_{E,2}, . . . , L_{E,N}. Then, in a first step the base layer is compressed/transmitted and in following steps the enhancement layers L_{E,1}, L_{E,2}, . . . , L_{E,N} are compressed/transmitted (separately).

In another embodiment, the reconstructed layer LR can be obtained by adding (element-wise) all sublayers L_{S,N}, according to:

$${L}_{R} = {\sum }_{i = 0}^{N} {L}_{S , N}$$

In a further embodiment, the reconstructed layer LR can be obtained by multiplying (element-wise) all sublayers L_{S,N}, according to:

$${L}_{R} = {\prod }_{i = 0}^{N} {L}_{S , N}$$

In other words, embodiments according to the invention comprise apparatuses, configured to reconstruct the neural network parameters 13, in the form of the reconstructed layer LR or for example using the reconstructed layer LR, by a parameter wise sum or parameter wise product of, per neural network parameter, the first-reconstruction-layer neural network parameter value and the second-reconstruction-layer neural network parameter value.

Respectively, for apparatuses for encoding neural network parameters 13 according to embodiments the neural network parameters 13 are reconstructible by a parameter wise sum or parameter wise product of, per neural network parameter, the first-reconstruction-layer neural network parameter value and the second-reconstruction-layer neural network parameter value.

In a further embodiment, the methods of 2.1 and/or 2.2 are applied to a subset or all sublayers.

In an embodiment an entropy coding scheme, using a context modelling (e.g. analogous or similar to 2.2.3), is applied but adding one or more sets of context models according to one or more of the following rules:

a) Each sublayer applies an own context set. In other words, embodiments according to the invention comprise apparatuses, configured to encode/decode the first neural network parameters 13a for the first reconstruction layer into/from the data stream or a separate data stream, and encode/decode the second neural network parameters 13b for the second reconstruction layer into/from the data stream by context-adaptive entropy encoding using separate probability contexts for the first and second reconstruction layers.

b) The chosen context set for a parameter of an enhancement layer to be encoded depends on the value of a co-located parameter in the a preceding layer in coding order (e.g. the base layer). A first set of context models is chosen whenever a co-located parameter is equal to zero and a second set otherwise. In other words, embodiments according to the invention comprise apparatuses, configured to encode the second-reconstruction-layer neural network parameter value, e.g. the parameter of an enhancement layer, into the data stream by context-adaptive entropy encoding using a probability model which depends on the first-reconstruction-layer neural network parameter value, e.g. the value of a co-located parameter in the a preceding layer in coding order (e.g. the base layer). Further embodiments comprise apparatuses configured to encode the second-reconstruction-layer neural network parameter value into the data stream by context-adaptive entropy encoding, by selecting a probability context set out of a collection of probability context sets depending on the first-reconstruction-layer neural network parameter value, and by selecting a probability context to be used out of the selected probability context set depending on the first-reconstruction-layer neural network parameter value. Respectively, for apparatuses for decoding neural network parameters 13 according to embodiments, said apparatuses may be configured to decode the second-reconstruction-layer neural network parameter value from the data stream by context-adaptive entropy decoding using a probability model which depends on the first-reconstruction-layer neural network parameter value. Respectively, further embodiments comprise apparatuses, configured to decode the second-reconstruction-layer neural network parameter value from the data stream by context-adaptive entropy decoding, by selecting a probability context set out of a collection of probability context sets depending on the first-reconstruction-layer neural network parameter value, and by selecting a probability context to be used out of the selected probability context set depending on the first-reconstruction-layer neural network parameter value.

c) The chosen context set for a parameter of an enhancement layer to be encoded depends on the value of a co-located parameter in the a preceding layer in coding order (e.g. the base layer). A first set of context models is chosen whenever a co-located parameter is smaller than zero (negative), a second set is chosen if a co-located parameter is greater than zero (positive) and a third set otherwise. In other words, embodiments according to the invention comprise apparatuses, e.g. for encoding, wherein the collection of probability context sets comprises three probability context sets, and the apparatus is configured to select a first probability context set out of the collection of probability context sets as the selected probability context set if the first-reconstruction-layer neural network parameter value is negative, to select a second probability context set out of the collection of probability context sets as the selected probability context set if the first-reconstruction-layer neural network parameter value is positive, and to select a third probability context set out of the collection of probability context sets as the selected probability context set if the first-reconstruction-layer neural network parameter value is zero. Respectively, for apparatuses for decoding neural network parameters 13 according to embodiments, the collection of probability context sets may comprise three probability context sets, and the apparatuses may be configured to select a first probability context set out of the collection of probability context sets as the selected probability context set if the first-reconstruction-layer neural network parameter value is negative, to select a second probability context set out of the collection of probability context sets as the selected probability context set if the first-reconstruction-layer neural network parameter value is positive, and to select a third probability context set out of the collection of probability context sets as the selected probability context set if the first-reconstruction-layer neural network parameter value is zero.

d) The chosen context set for a parameter of an enhancement layer to be encoded depends on the value of a co-located parameter in the a preceding layer in coding order (e.g. the base layer). A first set of context models is chosen whenever the (absolute) value of a co-located parameter is greater than X (where X is a parameter), and a second set otherwise. In other words, embodiments according to the invention comprise apparatuses, wherein the collection of probability context sets comprises two probability context sets, and the apparatus is configured to select a first probability context set out of the collection of probability context sets as the selected probability context set if the first-reconstruction-layer neural network parameter value, e.g. the value of a co-located parameter in the a preceding layer in coding order (e.g. the base layer), is greater than a predetermined value, e.g. x, and select a second probability context set out of the collection of probability context sets as the selected probability context set if the first-reconstruction-layer neural network parameter value is not greater than the predetermined value, or to select the first probability context set out of the collection of probability context sets as the selected probability context set if an absolute value of the first-reconstruction-layer neural network parameter value is greater than the predetermined value, and select the second probability context set out of the collection of probability context sets as the selected probability context set if the absolute value of the first-reconstruction-layer neural network parameter value is not greater than the predetermined value. Respectively, for apparatuses for decoding neural network parameters 13 according to embodiments, the collection of probability context may comprise two probability context sets, and the apparatuses may be configured to select a first probability context set out of the collection of probability context sets as the selected probability context set if the first-reconstruction-layer neural network parameter value is greater than a predetermined value, e.g. X, and select a second probability context set out of the collection of probability context sets as the selected probability context set if the first-reconstruction-layer neural network parameter value is not greater than the predetermined value, or to select the first probability context set out of the collection of probability context sets as the selected probability context set if an absolute value of the first-reconstruction-layer neural network parameter value is greater than the predetermined value, and select the second probability context set out of the collection of probability context sets as the selected probability context set if the absolute value of the first-reconstruction-layer neural network parameter value is not greater than the predetermined value.

4 Neural Network Parameter Coding with Dependent Scalar Quantization

In this section further optional aspects and features for concepts and embodiments according to the invention, as explained in the context of FIGS. 2-4, are disclosed.

The following describes a modified concept for neural network parameter coding. The main change relative to the neural network parameter coding described previously is that the neural network parameters 13 are not independently quantized and reconstructed. Instead, the admissible reconstruction levels for a neural network parameter 13 depend on the selected quantization indexes 56 for the preceding neural network parameters in reconstruction order. The concept of dependent scalar quantization is combined with a modified entropy coding, in which the probability model selection (or, alternatively, the codeword table selection) for a neural network parameter depends on the set of admissible reconstruction levels. Yet, it is to be noted, that embodiments described previously may be used and/or incorporated and/or extended by any of the features explained in the following, separately or in combination.

### 4.1 Advantage Compared to Related Neural Network Parameter Coding

The advantage of the dependent quantization of neural network parameters is that the admissible reconstruction vectors are denser packed in the N-dimensional signal space (where N denotes the number of samples or neural network parameters 13 in a set of samples to be processed, e.g. a layer 10a, 10b). The reconstruction vectors for a set of neural network parameters refer to the ordered reconstructed neural network parameters (or, alternatively, the ordered reconstructed samples) of a set of neural network parameters. The effect of dependent scalar quantization is illustrated in FIG. 8 for the simplest case of two neural network parameters. FIG. 8 shows an example of locations of admissible reconstruction vectors for the simple case of two weight parameters: FIG. 8(a) shows an example for Independent scalar quantization; FIG. 8(b) shows an example for Dependent scalar quantization. FIG. 8a shows the admissible reconstruction vectors 201 (which represent points in the 2d plane) for independent scalar quantization. As it can be seen, the set of admissible values for the second neural network parameter

$${t}_{1}^{′} 13$$

does not depend on the chosen value for the first reconstructed neural network parameter

$${t}_{0}^{′} 13.$$

FIG. 8(b) shows an example for dependent scalar quantization. Note that, in contrast to independent scalar quantization, the selectable reconstruction values for the second neural network parameter

$${t}_{1}^{′} 13$$

depend on the chosen reconstruction level for the first neural network parameter

$${t}_{0}^{′} 13.$$

In the example of FIG. 8b, there are two different sets 52 of available reconstruction levels for the second neural network parameter

$${t}_{1}^{′} 13$$

(illustrated by different colors). If the quantization index 56 for the first neural network parameter

$${t}_{0}^{′} 13$$

is even ( . . . , −2,0,2, . . . ), construction level 201a of the first set (blue points) can be selected for the second neural network parameter

$${t}_{1}^{′} 13.$$

And if the quantization index 56 for the first neural network parameter

$${t}_{0}^{′}$$

is odd ( . . . , −3, −1, 1, 3, . . . ), any reconstruction level 201b of the second set (red points) can be selected for the second neural network parameter

$${t}_{1}^{′} 13.$$

In the example, the reconstruction levels for the first and second set are shifted by half the quantization step size (any reconstruction level of the second set is located between two reconstruction levels of the first set).

The dependent scalar quantization of neural network parameter 13 has the effect that, for a given average number of reconstruction vectors 201 per N-dimensional unit volume, the expectation value of the distance between a given input vector of neural network parameters 13 and the nearest available reconstruction vector is reduced. As a consequence, the average distortion between the input vector of neural network parameters and the vector reconstructed neural network parameters can be reduced for a given average number of bits. In vector quantization, this effect is referred to as space-filling gain. Using dependent scalar quantization for sets of neural network parameters 13, a major part of the potential space-filling gain for high-dimensional vector quantization can be exploited. And, in contrast to vector quantization, the implementation complexity of the reconstruction process (or decoding process) is comparable to that of the related neural network parameter coding with independent scalar quantizers.

### 4.2 Overview

The main change is, as mentioned before, the dependent quantization. A reconstructed neural network parameter

$${t}_{k}^{′} 13.$$

with reconstruction order index k>0, does not only depend on the associated quantization index qₖ 56, but also on the quantization indexes q₀, q₁, . . . , qₖ₋₁ for preceding neural network parameters in reconstruction order. Note that in dependent quantization, the reconstruction order of neural network parameters 13 has to be uniquely defined. The performance of the overall neural network codec can typically be improved if the knowledge about the set of reconstruction levels associated with a quantization index qₖ 56 is also exploited in the entropy coding. That means, it is typically advantageous to switch contexts (probability models) or codeword tables based on the set of reconstruction levels that applies to a neural network parameter.

The entropy coding is usually uniquely specified given the entropy decoding process. But, similar as in related neural network parameter coding, there is a lot of freedom for selecting the quantization indexes given the original neural network parameters.

The embodiments set forth herein are not restricted to layer-wise neural network coding. It is also applicable to neural network parameter coding of any finite collection of neural network parameters 13.

Particularly, the method can also be applied to sublayers as described in sec. 3.1

### 4.3 Dependent Quantization of Neural Network Parameters

Dependent quantization of neural network parameters 13 refers to a concept in which the set of available reconstruction levels for a neural network parameter 13 depends on the chosen quantization indexes for preceding neural network parameters in reconstruction order (inside the same set of neural network parameters, e.g. a layer or a sublayer).

In an embodiment, multiple sets of reconstruction levels are pre-defined and, based on the quantization indexes for preceding neural network parameters in coding order, one of the predefined sets is selected for reconstructing the current neural network parameter. In other words, an apparatus according to embodiments may be configured to select 54, for a current neural network parameter 13), a set 48 of reconstruction levels out of a plurality 50 of reconstruction level sets 52 depending on quantization indices (58) for previous, e.g. preceding, neural network parameters.

Embodiments for defining sets of reconstruction levels are described in sec. 4.3.1. The identification and signaling of a chosen reconstruction level is described in see 4.3.2. Sec. 4.3.3 describes embodiments for selecting one of the pre-defined sets of reconstruction levels for a current neural network parameter (based on chosen quantization indexes for preceding neural network parameters in reconstruction order).

### 4.3.1 Sets of Reconstruction Levels

In an embodiment, the set of admissible reconstruction levels for a current neural network Parameter is selected (based on the quantization indexes for preceding neural network parameters in coding order) among a collection (two or more sets, e.g. set 0 and set 1 from FIGS. 2 and 3) of pre-defined sets 52 of reconstruction levels.

In an embodiment, a parameter determines a quantization step size Δ(QP) and all reconstruction levels (in all sets of reconstruction levels) represent integer multiples of the quantization step size Δ. But note that each set of reconstruction levels includes only a subset of the integer multiples of the quantization step size Δ(QP). Such a configuration for dependent quantization, in which all possible reconstruction levels for all sets of reconstruction levels represent integer multiples of the quantization step size (QP), can be considered of an extension of uniform reconstruction quantizers (URQs). Its basic advantage is that the reconstructed neural network parameters 13 can be calculated by algorithms with a very low computational complexity (as will be described below in more detail).

The sets of the reconstruction levels can be completely disjoint; but it is also possible that one or more reconstruction levels are contained in multiple sets (while the sets still differ in other reconstruction levels).

In an embodiment, the dependent scalar quantization for neural network parameters uses exactly two different sets of reconstruction levels, e.g. set 0 and set 1. And in an embodiment, all reconstruction levels of the two sets for a neural network parameter tₖ 13 represent integer multiples of the quantization step size Δₖ (QP) for this neural network parameter 13. Note that the quantization step size Δₖ (QP) just represents a scaling factor for the admissible reconstruction values in both sets. The same two sets of reconstruction levels are used for all neural network parameters 13.

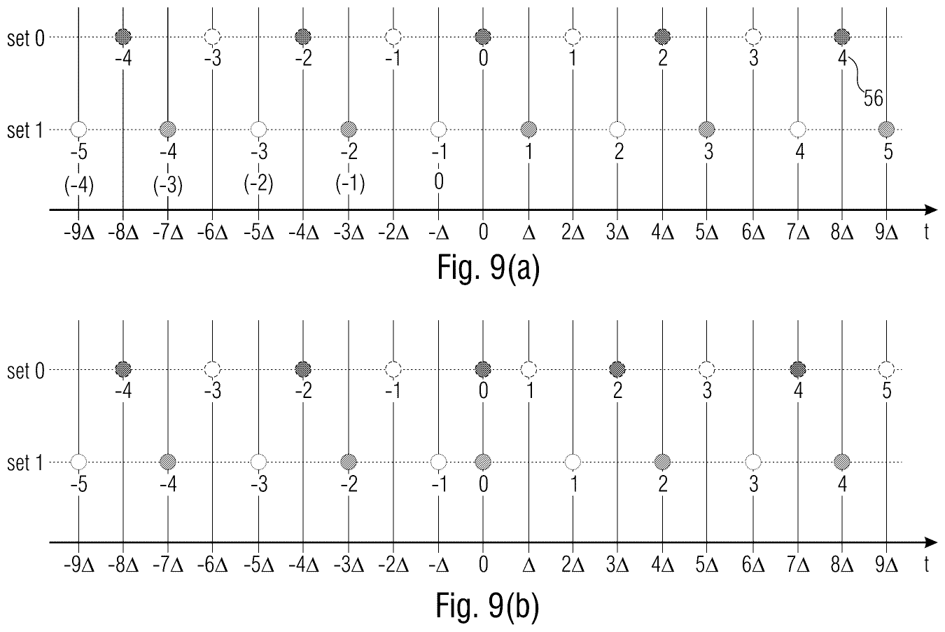

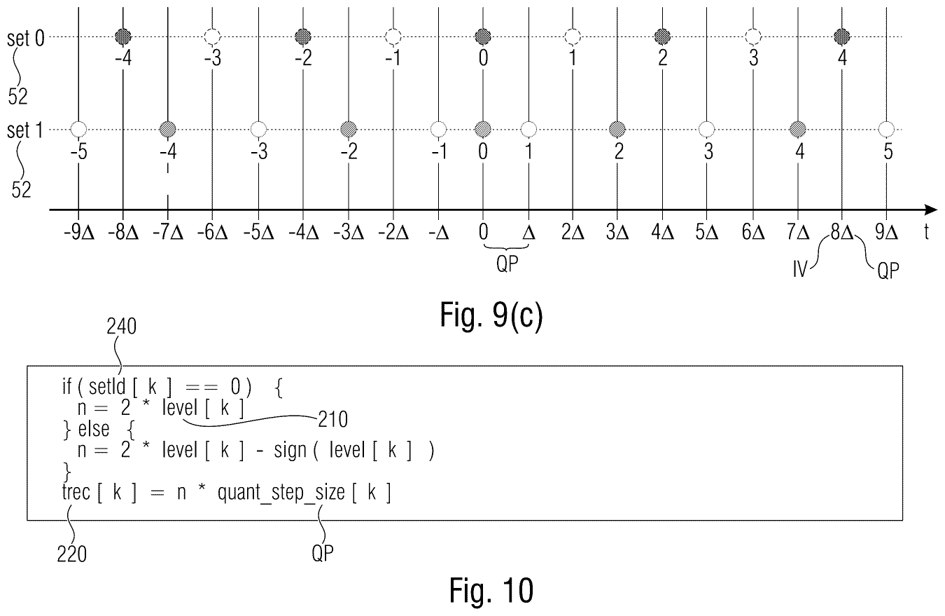

In FIG. 9, three configurations ((a)-(c)) for the two sets of reconstruction levels (set 0 and set 1) are illustrated. FIG. 9 shows examples for dependent quantization with two sets of reconstruction levels that are completely determined by a single quantization steps size Δ(QP). The two available sets of reconstruction levels are highlighted with different colors (blue for set 0 and red for set 1). Examples for quantization indexes that indicate a reconstruction level inside a set are given by the numbers below the circles. The hollow and filled circles indicate two different subsets inside the sets of reconstruction levels; the subsets can be used for determining the set of reconstruction levels for the next neural network parameter in reconstruction order. The figures show three configurations with two sets of reconstruction levels: (a) The two sets are disjoint and symmetric with respect to zero; (b) Both sets include the reconstruction level equal to zero, but are otherwise disjoint; the sets are non-symmetric around zero; (c) Both sets include the reconstruction level equal to zero, but are otherwise disjoint; both sets are symmetric around zero. Note that all reconstruction levels lie on a grid given by the integer multiples (IV) of the quantization step size Δ. It should further be noted that certain reconstruction levels can be contained in both sets.

The two sets depicted in FIG. 9 (a) are disjoint. Each integer multiple of the quantization step size Δ(QP) is only contained in one of the sets. While the first set (set 0) contains all even integer multiples (IV) of the quantization step size, the second set (set 1) contain all odd integer multiples of the quantization step size. In both sets, the distance between any two neighboring reconstruction levels is two times the quantization step size. These two sets are usually suitable for high-rate quantization, i.e., for settings in which the variance of the neural network parameters is significantly larger than the quantization step size (QP). In neural network parameter coding, however, the quantizers are typically operated in a low-rate range. Typically, the absolute value of many original neural network parameters 13 is closer to zero than to any non-zero multiple of the quantization step size (QP). In that case, it is typically advantageous if the zero is included in both quantization sets (sets of reconstruction levels).

The two quantization sets illustrated in FIG. 9 (b) both contain the zero. In set 0, the distance between the reconstruction level equal to zero and the first reconstruction level greater than zero is equal to the quantization step size (QP), while all other distances between two neighboring reconstruction levels are equal to two times the quantization step size. Similarly, in set 1, the distance between the reconstruction level equal to zero and the first reconstruction level smaller than zero is equal to the quantization step size, while all other distances between two neighboring reconstruction levels are equal to two times the quantization step size. Note that both reconstruction sets are non-symmetric around zero. This may lead to inefficiencies, since it makes it difficult to accurately estimate the probability of the sign.

A configuration for the two sets of reconstruction levels is shown in FIG. 9 (c). The reconstruction levels that are contained in the first quantization set (labeled as set 0 in the figure) represent the even integer multiples of the quantization step size (note that this set is actually the same as the set 0 in FIG. 9 (a)). The second quantization set (labeled as set 1 in the figure) contains all odd integer multiples of the quantization step size and additionally the reconstruction level equal to zero. Note that both reconstruction sets are symmetric about zero. The reconstruction level equal to zero is contained in both reconstruction sets, otherwise the reconstruction sets are disjoint. The union of both reconstruction sets contains all integer multiples of the quantization step size.

In other words according to embodiments, for example comprising apparatuses for encoding/decoding neural network parameters 13, the number of reconstruction level sets 52 of the plurality 50 of reconstruction level sets 52 is two (e.g. set 0, set 1) and the plurality of reconstruction level sets comprises a first reconstruction level set (set 0) that comprises zero and even multiples of a predetermined quantization step size, and a second reconstruction level set (set 1) that comprises zero and odd multiples of the predetermined quantization step size.

Furthermore, all reconstruction levels of all reconstruction level sets may represent integer multiples (IV) of a predetermined quantization step size (QP), and an apparatus, e.g. for decoding neural network parameters 13, according to embodiments, may be configured to dequantize the neural network parameters 13 by deriving, for each neural network parameter, an intermediate integer value, e.g. the integer multiple (IV) depending on the selected reconstruction level set for the respective neural network parameter and the entropy decoded quantization index 58 for the respective neural network parameter 13′, and by multiplying, for each neural network parameter 13, the intermediate value for the respective neural network parameter with the predetermined quantization step size for the respective neural network parameter 13.

Respectively, all reconstruction levels of all reconstruction level sets may represent integer multiples (IV) of a predetermined quantization step size (QP), and an apparatus, e.g. for encoding neural network parameters 13, according to embodiments, may be configured to quantize the neural network parameters in a manner so that same are dequantizable by deriving, for each neural network parameter, an intermediate integer value depending on the selected reconstruction level set for the respective neural network parameter and the entropy encoded quantization index for the respective neural network parameter, and by multiplying, for each neural network parameter, the intermediate value for the respective neural network parameter with the predetermined quantization step size for the respective neural network parameter.

The embodiments set forth herein are not restricted to the configurations shown in FIG. 9. Any other two different sets of reconstruction levels can be used. Multiple reconstruction levels may be included in both sets. Or the union of both quantization sets may not contain all possible integer multiples of the quantization step size. Furthermore, it is possible to use more than two sets of reconstruction levels for the dependent scalar quantization of neural network parameters.

### 4.3.2 Signaling of Chosen Reconstruction Levels

The reconstruction level that the encoder selects among the admissible reconstruction levels has to be indicated inside the bitstream 14. As in conventional independent scalar quantization, this can be achieved using so-called quantization indexes 56, which are also referred to as weight levels. Quantization indexes 56 (or weight levels) are integer numbers that uniquely identify the available reconstruction levels inside a quantization set 52 (i.e., inside a set of reconstruction levels). The quantization indexes 56 are sent to the decoder as part of the bitstream 14 (using any entropy coding technique). At the decoder side, the reconstructed neural network parameters 13 can be uniquely calculated based on a current set 48 of reconstruction levels (which is determined by the preceding quantization indexes in coding/reconstruction order) and the transmitted quantization index 56 for the current neural network parameter 13′.

In an embodiment, the assignment of quantization indexes 56 to reconstruction levels inside a set of reconstruction levels (or quantization set) follows the following rules. For illustration, the reconstruction levels in FIG. 9 are labeled with an associated quantization index 56 (the quantization indexes are given by the numbers below the circles that represent the reconstruction levels). If a set of reconstruction levels includes the reconstruction level equal to 0, the quantization index equal to 0 is assigned to the reconstruction level equal to 0. The quantization index equal to 1 is assigned to the smallest reconstruction level greater than 0, the quantization index equal to 2 is assigned to the next reconstruction level greater than 0 (i.e., the second smallest reconstruction level greater than 0), etc. Or, in other words, the reconstruction levels greater than 0 are labeled with integer numbers greater than 0 (i.e., with 1, 2, 3, etc.) in increasing order of their values. Similarly, the quantization index−1 is assigned to the largest reconstruction level smaller than 0, the quantization index −2 is assigned to the next (i.e., the second largest) reconstruction level smaller than 0, etc. Or, in other words, the reconstruction levels smaller than 0 are labeled with integer numbers less than 0 (i.e.,−1,−2, −3, etc.) in decreasing order of their values. For the examples in FIG. 9, the described assignment of quantization indexes is illustrated for all quantization sets, except set 1 in FIG. 9 (a) (which does not include a reconstruction level equal to 0).

For quantization sets that don't include the reconstruction level equal to 0, one way of assigning quantization indexes 56 to reconstruction levels is the following. All reconstruction levels greater than 0 are labeled with quantization indexes greater than 0 (in increasing order of their values) and all reconstruction levels smaller than 0 are labeled with quantization indexes smaller than 0 (in decreasing order of the values). Hence, the assignment of quantization indexes 56 basically follows the same concept as for quantization sets that include the reconstruction level equal to 0, with the difference that there is no quantization index equal to 0 (see labels for quantization set 1 in FIG. 9 (a)). That aspect should be considered in the entropy coding of quantization indexes 56. For example, the quantization index 56 is often transmitted by coding its absolute value (ranging from 0 to the maximum supported value) and, for absolute values unequal to 0, additionally coding the sign of the quantization index 56. If no quantization index 56 equal to 0 is available, the entropy coding could be modified in a way that the absolute level minus 1 is transmitted (the values for the corresponding syntax element range from 0 to a maximum supported value) and the sign is transmitted. As an alternative, the assignment rule for assigning quantization indexes 56 to reconstruction levels could be modified. For example, one of the reconstruction levels close to zero could be labeled with the quantization index equal to 0. And then, the remaining reconstruction levels are labeled by the following rule: Quantization indexes greater than 0 are assigned to the reconstruction levels that are greater than the reconstruction level with quantization index equal to 0 (the quantization indexes increase with the value of the reconstruction level). And quantization indexes less than 0 are assigned to the reconstruction levels that are smaller than the reconstruction level with the quantization index equal to 0 (the quantization indexes decrease with the value of the reconstruction level). One possibility for such an assignment is illustrated by the numbers in parentheses in FIG. 9 (a) (if no number in parentheses is given, the other numbers apply).

As mentioned above, in an embodiment, two different sets of reconstruction levels (which we also call quantization sets) are used, and the reconstruction levels inside both sets represent integer multiples of the quantization step size (QP). That includes cases, in which the quantization step size is modified on a layer basis (e.g., by transmitting a layer quantization parameter inside the bitstream 14) or another finite set (e.g. a block) of neural network parameters 13 (e.g. by transmitting a block quantization parameter inside the bitstream 14).

The usage of reconstruction levels that represent integer multiples of a quantization step sizes (QP) allow computationally low complex algorithms for the reconstruction of neural network parameters 13 at the decoder side. This is illustrated based on the example of FIG. 9 (c) in the following (similar simple algorithms also exist for other configurations, in particular, the settings shown in FIG. 9 (a) and FIG. 9 (b)). In the configuration shown in FIG. 9 (c), the first quantization set includes all even integer multiples of the quantization step size (QP) and the second quantization set includes all odd integer multiples of the quantization step size plus the reconstruction level equal to 0 (which is contained in both quantization sets). The reconstruction process for a neural network parameter could be implemented similar to the algorithm specified in the pseudo-code of FIG. 10. FIG. 10 shows an example for a pseudo-code illustrating an example for the reconstruction process for neural network parameters 13. k represents an index that specifies the reconstruction order of the current neural network parameter 13′, the quantization index 56 for the current neural network parameter is denoted by level [k] 210, the quantization step size Δₖ (QP) that applies to the current neural network parameter 13′ is denoted by quant_step_size [k], and trec [k] 220 represents the value of the reconstructed neural network parameter

$${t}_{k}^{′} .$$

The variable setld[k]240 specifies the set of reconstruction levels that applies to the current neural network parameter 13′. It is determined based on the preceding neural network parameters in reconstruction order; the possible values of setld[k] are 0 and 1. The variable n specifies the integer factor, e.g. the intermediate value IV, of the quantization step size (QP); it is given by the chosen set of reconstruction levels (i.e., the value of setld [k]) and the transmitted quantization index level [k].

In the pseudo-code of FIG. 10, level [k] denotes the quantization index 56 that is transmitted for a neural network parameter tₖ 13 and setld [k] (being equal to 0 or 1) specifies the identifier of the current set of reconstruction levels (it is determined based on preceding quantization indexes 56 in reconstruction order as will be described in more detail below). The variable n represents the integer multiple of the quantization step size (QP) given by the quantization index level [k] and the set identifier setld [k]. If the neural network parameter 13 is coded using the first set of reconstruction levels (setld [k]==0), which contains the even integer multiples of the quantization step size Δₖ (QP), the variable n is two times the transmitted quantization index 56. This case may be represented by the reconstruction levels of the first quantization set Set 0 in FIG. 9 (c), wherein Set 0 includes all even integer multiples of the quantization step size (QP). If the neural network parameter 13 is coded using the second set of reconstruction levels (setld [k]==1), we have the following three cases: (a) if level [k] is equal to 0, n is also equal to 0; (b) if level [k] is greater than 0, n is equal to two times the quantization index level [k] minus 1; and (c) if level [k] is less than 0, n is equal to two times the quantization index level [k] plus 1. This can be specified using the sign function

$$sign ( x ) = \{ \begin{matrix}1 : & x > 0 \\ 0 : & x = 0 \\ - 1 : & x < 0\end{matrix} .$$

Then, if the second quantization set is used, the variable n is equal to two times the quantization index level [k] minus the sign function sign (level [k]) of the quantization index. This case may be represented by the reconstruction levels of the second quantization set Set 1 in FIG. 9 (c), wherein Set 1 includes all odd integer multiples of the quantization step size (QP).

Once the variable n (specifying the integer factor of the quantization step size) is determined, the reconstructed neural network parameter tₖ is obtained by multiplying n with the quantization step size Δₖ·

In other words, the number of reconstruction level sets 52 of the plurality 50 of reconstruction level sets 52 may be two and an apparatus, e.g. for decoding and/or encoding neural network parameters 13, according to embodiments of the invention may be configured to derive the intermediate value for each neural network parameter by,
if the selected reconstruction level set for the respective neural network parameter is a first set, multiply the quantization index for the respective neural network parameter by two to obtain the intermediate value for the respective neural network parameter; and
if the selected reconstruction level set for a respective neural network parameter is a second set and the quantization index for the respective neural network parameter is equal to zero, set the intermediate value for the respective sample equal to zero; and
if the selected reconstruction level set for a respective neural network parameter is a second set and the quantization index for the respective neural network parameter is greater than zero, multiply the quantization index for the respective neural network parameter by two and subtract one from the result of the multiplication to obtain the intermediate value for the respective neural network parameter; and
   if the selected reconstruction level set for a current neural network parameter is a second set and the quantization index for the respective neural network parameter is less than zero, multiply the quantization index for the respective neural network parameter by two and add one to the result of the multiplication to obtain the intermediate value for the respective neural network parameter.

### 4.3.3 Dependent Reconstruction of Neural Network Parameters

Besides the selection of the sets of reconstruction levels discussed above in see 4.3.1 and 4.3.2 another important design aspect of dependent scalar quantization in neural network parameter coding is the algorithm used for switching between the defined quantization sets (sets of reconstruction levels). The used algorithm determines the “packing density” that can be achieved in the N-dimensional space of neural network parameters 13 (and, thus, also in the N-dimensional space of reconstructed samples). A higher packing density eventually results in an increased coding efficiency.

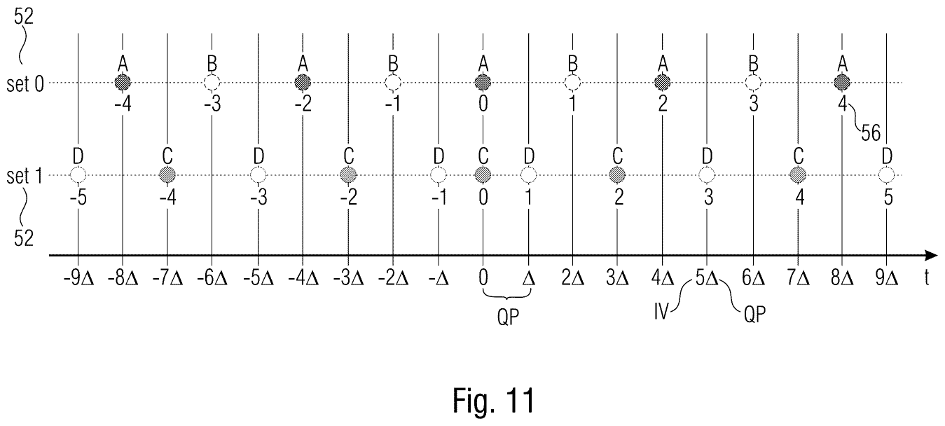

An advantageous way of determining the set of reconstruction levels for the next neural network parameters is based on a partitioning of the quantization sets, as it is illustrated in FIG. 11. FIG. 11 shows an example for a splitting of the sets of reconstruction levels into two subsets according to embodiments of the invention. The two shown quantization sets are the quantization sets of the example of FIG. 9 (c). The two subsets of the quantization set 0 are labeled using “A” and “B”, and the two subsets of quantization set 1 are labeled using “C” and “D”. Note that the quantization sets shown in FIG. 11 are the same quantization sets as the ones in FIG. 9 (c). Each of the two (or more) quantization sets is partitioned into two subsets. For the example in FIG. 11, the first quantization set (labeled as set 0) is partitioned into two subsets (which are labeled as A and B) and the second quantization set (labeled as set 1) is also partitioned into two subsets (which are labeled as C and D). Even though it is not the only possibility, the partitioning for each quantization set is advantageously done in a way that directly neighboring reconstruction levels (and, thus, neighboring quantization indexes) are associated with different subsets. In an embodiment, each quantization set is partitioned into two subsets. In FIG. 9, the partitioning of the quantization sets into subsets is indicated by hollow and filled circles.

For the embodiment illustrated in FIG. 11 and FIG. 9 (c), the following partitioning rules apply:
Subset A consists of all even quantization indexes of the quantization set 0;
Subset B consists of all odd quantization indexes of the quantization set 0;
Subset C consists of all even quantization indexes of the quantization set 1;
Subset D consists of all odd quantization indexes of the quantization set 1.

It should be noted that the used subset is typically not explicitly indicated inside the bitstream 14. Instead, it can be derived based on the used quantization set (e.g., set 0 or set 1) and the actually transmitted quantization index 56. For the partitioning shown in FIG. 11, the subset can be derived by a bit-wise “and” operation of the transmitted quantization index level and 1. Subset A consists of all quantization indexes of set 0 for which (level&1) is equal to 0, subset B consists of all quantization indexes of set 0 for which (level&1) is equal to 1, subset C consists of all quantization indexes of set 1 for which (level&1) is equal to 0, and subset D consists of all quantization indexes of set 1 for which (level&1) is equal to 1.

In an embodiment, the quantization set (set of admissible reconstruction levels) that is used for reconstructing a current neural network parameter 13′ is determined based on the subsets that are associated with the last two or more quantization indexes 56. An example, in which the two last subsets (which are given by the last two quantization indexes) are used is shown in Table 1. The determination of the quantization set specified by this table represents an embodiment. In other embodiments, the quantization set for a current neural network parameter 13′ is determined by the subsets that are associated with the last three or more quantization indexes 56. For the first neural network parameter of a layer (or a subset of neural network parameters), we don't have any data about the subsets of preceding neural network parameters (since there are no preceding neural network parameters). In an embodiment, pre-defined values are used in these cases. In an embodiment, we infer the subset A for all non-available neural network parameters. That means, if we reconstruct the first neural network parameter, the two preceding subsets are inferred as “AA” (or “AAA” for the case where 3 preceding neural network parameters are considered) and, thus, according to Table 1, the quantization set 0 is used. For the second neural network parameter, the subset of the directly preceding quantization index is determined by its value (since set 0 is used for the first neural network parameter, the subset is either A or B), but the subset for the second last quantization index (which does not exist) is inferred to be equal to A. Of course, any other rules can be used for inferring default values for non-existing quantization indexes. It is also possible to use other syntax elements for deriving default subsets for the non-existing quantization indexes. As a further alternative, it is also possible to use the last quantization indexes 56 of the preceding set of neural network parameters 13 for initialization.

TABLE 1
Example for the determination of the quantization set (set of available
reconstruction levels) that is used for the next neural network
parameter based on the subsets that are associated with the two
last quantization indexes according to embodiments of the invention.
The subsets are shown in the left table column; they are uniquely
determined by the used quantization set (for the two last quantization
indexes) and the so-called path (which may be determined by the
parity of the quantization index). The quantization set and, in
parenthesis, the path for the subsets are listed in the second
column form the left. The third column specifies the associated
quantization set. In the last column, the value of a so-called
state variable is shown, which can be used for simplifying the
process for determining the quantization sets.

| | quantization set | | |
|---|---|---|---|
| | and path (given in | | |
| subsets of the | parentheses) for the | quantization set | |
| two last | two last quantization | for current neural | state |
| quantization indexes | indexes | network parameter | variable |
| A A | 0(0), 0(0) | 0 | 0 |
| A B | 0(0), 0(1) | 0 | 0 |
| A C | 0(0), 1(0) | 1 | 1 |
| A D | 0(0), 1(1) | 1 | 1 |
| B A | 0(1), 0(0) | 1 | 1 |
| B B | 0(1), 0(1) | 1 | 1 |
| B C | 0(1), 1(0) | 0 | 0 |
| B D | 0(1), 1(1) | 0 | 0 |
| C A | 1(0), 0(0) | 0 | 2 |
| C B | 1(0), 0(1) | 0 | 2 |
| C C | 1(0), 1(0) | 1 | 3 |
| C D | 1(0), 1(1) | 1 | 3 |
| D A | 1(1), 0(0) | 1 | 3 |
| D B | 1(1), 0(1) | 1 | 3 |
| D C | 1(1), 1(0) | 0 | 2 |
| D D | 1(1), 1(1) | 0 | 2 |

It should be noted that the subset (A, B, C, or D) of a quantization index 56 is determined by the used quantization set (set 0 or set 1) and the used subset inside the quantization set (for example, A or B for set 0, and C or D for set 1). The chosen subset inside a quantization set is also referred to as path (since it specifies a path if we represent the dependent quantization process as trellis structure as will be described below). In our convention, the path is either equal to 0 or 1. Then subset A corresponds to path 0 in set 0, subset B corresponds to path 1 in set 0, subset C corresponds to path 0 in set 1, and subset D corresponds to path 1 in set 1. Hence, the quantization set for the next neural network parameter is also uniquely determined by the quantization sets (set 0 or set 1) and the paths (path 0 or path 1) that are associated with the two (or more) last quantization indexes. In Table 1, the associated quantization sets and paths are specified in the second column.

It should be noted that the path can often be determined by simple arithmetic operations, for example by binary functions. For example, for the configuration shown in FIG. 11, the path is given by

$$path = ( level [ k ] \& 1 ) ,$$

where level [k] represent the quantization index (weight level) 56 and the operator & specifies a bit-wise “and” (in two-complement integer arithmetic).

In other words, the number of reconstruction level sets 52 of the plurality 50 of reconstruction level sets 52 may be two, e.g. with set 0 and set 1, and apparatuses, e.g. for decoding neural network parameters 13, according to embodiments of the invention may be configured to derive a subset index, for each neural network parameter based on the selected set of reconstruction levels for the respective neural network parameter and a binary function of the quantization index for the respective neural network parameter, resulting in four possible values, e.g. A, B, C, or D, for the subset index; and to select 54, for the current neural network parameter 13′, the set 48 of reconstruction levels out of the plurality 50 of reconstruction level sets 52 depending on the subset indices for previously decoded neural network parameters.

Further embodiments according to the invention comprise apparatuses configured to select 54, for the current neural network parameter 13′, the set 48 of reconstruction levels out of the plurality 50 of reconstruction level sets 5) using a selection rule which depends on the subset indices for a number of immediately previously decoded neural network parameters, e.g. as shown in the first column of Table 1, and to use the selection rule for all, or a portion, of the neural network parameters.

According to further embodiments, the number of immediately previously decoded neural network parameters on which the selection rule depends is two, e.g. as shown in Table 1, the subsets of the two last quantization indexes.

According to additional embodiments, the subset index for each neural network parameter is derived based on the selected set of reconstruction levels for the respective neural network parameter and a parity, e.g. using path=(level [k] & 1), of the quantization index for the respective neural network parameter.

Respectively, for apparatuses for encoding neural network parameters 13 according to embodiments, the number of reconstruction level sets 52 of the plurality 50 of reconstruction level sets 52 may be two, e.g. with set 0 and set 1, and the apparatuses may be configured to derive a subset index for each neural network parameter based on the selected set of reconstruction levels for the respective neural network parameter and a binary function of the quantization index for the respective neural network parameter, resulting in four possible values for the subset index, e.g. A, B, C and D, and to select 54, for the current neural network parameter 13′, the set 48 of reconstruction levels out of the plurality 50 of reconstruction level sets 52 depending on the subset indices for previously encoded neural network parameters.

Further embodiments according to the invention comprise apparatuses configured to select 54, for the current neural network parameter 13′, the set 48 of reconstruction levels out of the plurality 50 of reconstruction level sets 52 using a selection rule which depends on the subset indices for a number of immediately previously encoded neural network parameters, e.g. as shown in the first column of Table 1, and to use the selection rule for all, or a portion, of the neural network parameters.

According to further embodiments, the number of immediately previously encoded neural network parameters on which the selection rule depends is two, e.g. as shown in Table 1, the subsets of the two last quantization indexes.

According to additional embodiments, the subset index for each neural network parameter is derived based on the selected set of reconstruction levels for the respective neural network parameter and a parity, e.g. using path=(level [k] & 1), of the quantization index for the respective neural network parameter.

The transition between the quantization sets 52 (set 0 and set 1) can also be elegantly represented by a state variable. An example for such a state variable is shown in the last column of Table 1. For this example, the state variable has four possible values (0, 1, 2, 3). On the one hand, the state variable specifies the quantization set that is used for the current neural network parameter 13′. In the example of Table 1, the quantization set 0 is used if and only if the state variable is equal to 0 or 2, and the quantization set 1 is used if and only if the state variable is equal to 1 or 3. On the other hand, the state variable also specifies the possible transitions between the quantization sets. By using a state variable, the rules of Table 1 can be described by a smaller state transition table. As an example, Table 2 specifies a state transition table for the rules given in Table 1. It represents an embodiment. Given a current state, it specified the quantization set for the current neural network parameter (second column). It further specifies the state transition based on the path that is associated with the chosen quantization index 56 (the path specifies the used subset A, B, C, or D if the quantization set is given). Note that by using the concept of state variables, it is not required to keep track of the actually chosen subset. In reconstructing the neural network parameters for a layer, it is sufficient to update a state variable and determine the path of the used quantization index.

TABLE 2
Example of a state transition table for a configuration
with 4 states, according to embodiments of the invention.

| | quantization set | | |
|---|---|---|---|
| current | for current | next state | |
| state | coefficient | path 0 | path 1 |
| 0 | 0 | 0 | 1 |
| 1 | 1 | 2 | 3 |
| 2 | 0 | 1 | 0 |
| 3 | 1 | 3 | 2 |

In other words, an apparatus, e.g. for decoding neural network parameters, according to embodiments may be configured to select 54, for the current neural network parameter 13′, the set 48 of quantization levels out of the plurality 50 of reconstruction level sets 52 by means of a state transition process by determining, for the current neural network parameter 13′, the set 48 of quantization levels out of the plurality 50 of reconstruction level sets 52 depending on a state associated with the current neural network parameter 13′, and by updating the state for a subsequent neural network parameter depending on the quantization index 58 decoded from the data stream for the immediately preceding neural network parameter.

Respectively, for apparatuses for encoding neural network parameters 13 according to embodiments, said apparatuses may be configured to select 54, for the current neural network parameter 13′, the set 48 of reconstruction levels out of the plurality 50 of reconstruction level sets 52 by means of a state transition process by determining, for the current neural network parameter 13′, the set 48 of reconstruction levels out of the plurality 50 of reconstruction level sets 52 depending on a state associated with the current neural network parameter 13′, and by updating the state for a subsequent neural network parameter depending on the quantization index 58 encoded into the data stream for the immediately preceding neural network parameter.

In an embodiment of the invention, the path is given by the parity of the quantization index. With level [k] being the current quantization index, it can be determined according to

$$path = ( level [ k ] \& 1 ) ,$$

where the operator & represents a bit-wise “and” in two-complement integer arithmetic.

In other words, an apparatus, e.g. for decoding neural network parameters, according to embodiments may be configured to update the state, for example according to Table 2, for the subsequent neural network parameter using a binary function of the quantization index 58 decoded from the data stream for the immediately preceding neural network parameter.

Furthermore, an apparatus according to embodiments may be configured to update the state for the subsequent neural network parameter using a parity of the quantization index 58, e.g. using path=(level [k] & 1), decoded from the data stream 14 for the immediately preceding neural network parameter.

Respectively, for apparatuses for encoding neural network parameters 13 according to embodiments, said apparatuses may be configured to update the state for the subsequent neural network parameter using a binary function of the quantization index 58 encoded into the data stream for the immediately preceding neural network parameter.

Furthermore, an apparatus, e.g. for encoding neural network parameters 13, according to embodiments may be configured to update the state, for example according to Table 2, for the subsequent neural network parameter using a parity of the quantization index 58 encoded into the data stream for the immediately preceding neural network parameter.

In an embodiment, a state variable with four possible values is used. In other embodiments, a state variable with a different number of possible values is used. Of particular interest are state variables for which the number of possible values for the state variable represents an integer power of two, i.e., 4, 8, 16, 32, 64, etc. It should be noted that, in a configuration (as given in Table 1 and Table 2), a state variable with 4 possible values is equivalent to an approach where the current quantization set is determined by the subsets of the two last quantization indexes. A state variable with 8 possible values would correspond to a similar approach where the current quantization set is determined by the subsets of the three last quantization indexes. A state variable with 16 possible values would correspond to an approach, in which the current quantization set is determined by the subsets of the last four quantization indexes, etc. Even though it is generally advantageous to use state variables with a number of possible values that is equal to an integer power of two, the embodiments are not limited to this setting.

In an embodiment, a state variable with eight possible values (0, 1, 2, 3, 4, 5, 6, 7) is used. In the example Table 3, the quantization set 0 is used if and only if the state variable is equal to 0, 2, 4 or 6, and the quantization set 1 is used if and only if the state variable is equal to 1, 3, 5 or 7.

TABLE 3
Example of a state transition table for a configuration
with 8 states, according to embodiments.

| | quantization set | | |
|---|---|---|---|
| current | for current | next state | |
| state | coefficient | path 0 | path 1 |
| 0 | 0 | 0 | 2 |
| 1 | 1 | 7 | 5 |
| 2 | 0 | 1 | 3 |
| 3 | 1 | 6 | 4 |
| 4 | 0 | 2 | 0 |
| 5 | 1 | 5 | 7 |
| 6 | 0 | 3 | 1 |
| 7 | 1 | 4 | 6 |

In other words, according to embodiments of the invention, the state transition process is configured to transition between four or eight possible states.

Moreover, an apparatus for decoding/encoding neural network parameters 13, according to embodiments may be configured to transition, in the state transition process, between an even number of possible states and the number of reconstruction level sets 52 of the plurality 50 of reconstruction level sets 52 is two, wherein the determining, for the current neural network parameter 13′, the set 48 of quantization levels out of the quantization sets 52 depending on the state associated with the current neural network parameter 13′ determines a first reconstruction level set out of the plurality 50 of reconstruction level sets 52 if the state belongs to a first half of the even number of possible states, and a second reconstruction level set out of the plurality 50 of reconstruction level sets 52 if the state belongs to a second half of the even number of possible states.

An apparatus, e.g. for decoding neural network parameters 13, according to further embodiments may be configured to perform the update of the state by means of a transition table which maps a combination of the state and a parity of the quantization index 58 decoded from the data stream for the immediately preceding neural network parameter onto a further state associated with the subsequent neural network parameter.

Respectively, an apparatus for encoding neural network parameters 13 according to embodiments may be configured to perform the update of the state by means of a transition table which maps a combination of the state and a parity of the quantization index 58 encoded into the data stream for the immediately preceding neural network parameter onto a further state associated with the subsequent neural network parameter.

Using the concept of state transition, the current state and, thus, the current quantization set is uniquely determined by the previous state (in reconstruction order) and the previous quantization index 56. However, for the first neural network parameter 13 in a finite set (e.g. a layer), there are no previous state and previous quantization index. Hence, it is required that the state for the first neural network parameter of a layer is uniquely defined. There are different possibilities. Advantageous choices are:
The first state for a layer is set equal to a fixed pre-defined value. In an embodiment, the first state is set equal to 0.
The value of the first state is explicitly transmitted as part of the bitstream 14. This includes approaches, where only a subset of the possible state values can be indicated by a corresponding syntax element.
The value of the first state is derived based on other syntax elements for the layer. That mean even though the corresponding syntax elements (or syntax element) are used for signaling other aspects to the decoder, they are additionally used for deriving the first state for dependent scalar quantization.

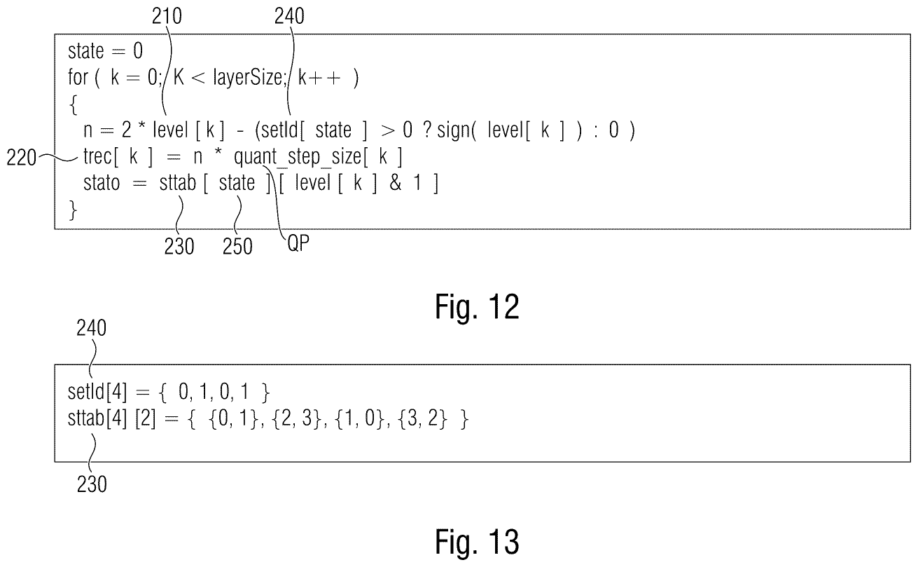

The concept of state transition for the dependent scalar quantization allows low-complexity implementations for the reconstruction of neural network parameters 13 in a decoder. An example for the reconstruction process of neural network parameters of a single layer is shown in FIG. 12 using C-style pseudo-code. FIG. 12 shows an example of pseudo-code illustrating an example for the reconstruction process of neural network parameters 13 for a layer according to embodiments of the invention. Note that, alternatively, the derivation of the quantization indices and the derivation of reconstructed values using the quantization step size, for instance, or, alternatively, using a codebook, may be done in separate loops one after the other. That is, in other words, the derivation of “n” and the state update may be done in a first loop and the derivation of “trec” in another separate, second loop. The array level 210 represents the transmitted neural network parameter levels (quantization indexes 56) for the layer and the array trec 220 represent the corresponding reconstructed neural network parameters 13. The quantization step size Δₖ (QP) that applies to the current neural network parameter 13′ is denoted by quant_step_size [k]. The 2d table sttab 230 specifies the state transition table, e.g. according to any of the Tables 1, 2 and/or 3, and the table setld 240 specifies the quantization set that is associated with the states 250.

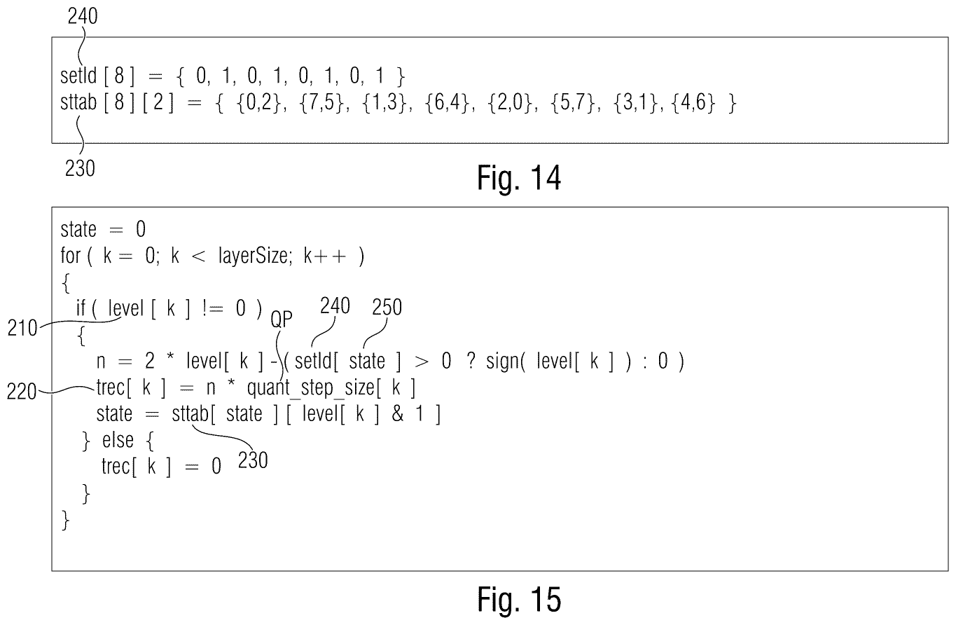

In the pseudo-code of FIG. 12, the index k specifies the reconstruction order of neural network parameters. The last index layerSize specifies the reconstruction index of the last reconstructed neural network parameter. The variable layerSize may be set equal to the number of neural network parameters in the layer. The reconstruction process for each single neural network parameter is the same as in the example of FIG. 10. As for the example in FIG. 10, the quantization indexes are represented by level [k] 210 and the associated reconstructed neural network parameters are represented by trec [k] 220. The state variable is represented by state 210. Note that in the example of FIG. 12, the state is set equal to 0 at the beginning of a layer. But as discussed above, other initializations (for example, based on the values of some syntax elements) are possible. The 1d table setld [ ] 240 specifies the quantization sets that are associated with the different values of the state variable and the 2d table sttab [ ] [ ] 230 specifies the state transition given the current state (first argument) and the path (second argument). In the example, the path is given by the parity of the quantization index (using the bit-wise and operator &), but other concepts are possible. Examples, in C-style syntax, for the tables are given in FIG. 13 and FIG. 14 (these tables are identical to Table 2 and Table 3, in other words they may provide a representation of Table 2 and Table 3).

FIG. 13 shows examples for the state transition table sttab 230 and the table setld 240, which specifies the quantization set associated with the states 250 according to embodiments of the invention. The table given in C-style syntax represents the tables specified in Table 2.

FIG. 14 shows examples for the state transition table sttab 230 and the table setld 240, which specifies the quantization set associated with the states 250, according to embodiments of the invention. The table given in C-style syntax represents the tables specified in Table 3.

In another embodiment, all quantization indexes 56 equal to 0 are excluded from the state transition and dependent reconstruction process. The information whether a quantization index 56 is equal or not equal to 0 is merely used for partitioning the neural network parameters 13 into zero and non-zero neural network parameters. The reconstruction process for dependent scalar quantization is only applied to the ordered set of non-zero quantization indexes 56. All neural network parameters associated with quantization indexes equal to 0 are simply set equal to 0. A corresponding pseudo-code is shown in FIG. 15. FIG. 15 shows a pseudo-code illustrating an alternative reconstruction process for neural network parameter levels, in which quantization index equal to 0 are excluded from the state transition and dependent scalar quantization, according to embodiments of the invention.

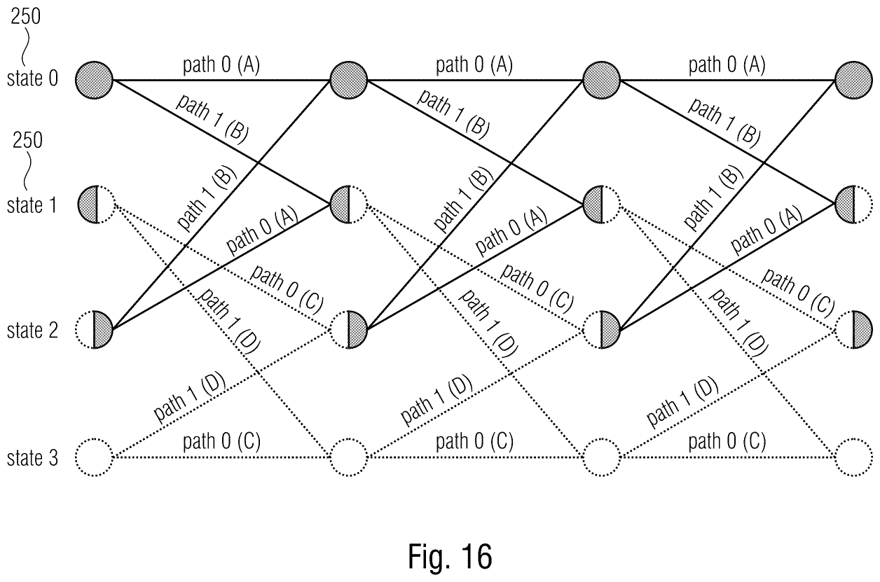

The state transition in dependent quantization can also be represented using a trellis structure, as is illustrated in FIG. 16. FIG. 16 shows examples of state transitions in dependent scalar quantization as trellis structure according to embodiments of the invention. The horizontal axis represents different neural network parameters 13 in reconstruction order. The vertical axis represents the different possible states 250 in the dependent quantization and reconstruction process. The shown connections specify the available paths between the states for different neural network parameters. The trellis shown in this figures corresponds to the state transitions specified in Table 2. For each state 250, there are two paths that connect the state for a current neural network parameter 13′ with two possible states for the next neural network parameter 13 in reconstruction order. The paths are labeled with path 0 and path 1, this number corresponds to the path variable that was introduced above (for an embodiment, that path variable is equal to the parity of the quantization index). Note that each path uniquely specifies a subset (A, B, C, or D) for the quantization indexes. In FIG. 16, the subsets are specified in parentheses. Given an initial state (for example state 0), the path through the trellis is uniquely specified by the transmitted quantization indexes 56.

For the example in FIG. 16, the states (0, 1, 2, and 3) have the following properties:
State 0: The previous quantization index level [k−1] specifies a reconstruction level of set 0 and the current quantitation index level [k] specifies a reconstruction level of set 0.
State 1: The previous quantization index level [k−1] specifies a reconstruction level of set 0 and the current quantitation index level [k] specifies a reconstruction level of set 1.
State 2: The previous quantization index level [k−1] specifies a reconstruction level of set 1 and the current quantitation index level [k] specifies a reconstruction level of set 0.
State 3: The previous quantization index level [k−1] specifies a reconstruction level of set 1 and the current quantitation index level [k] specifies a reconstruction level of set 1.

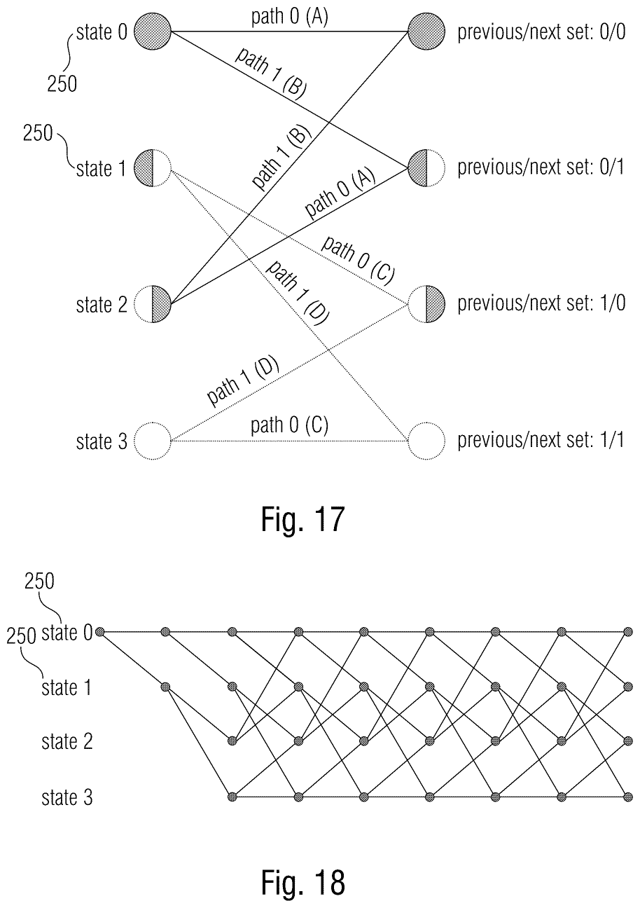

The trellis consists of a concatenation of so-called basic trellis cells. An example for such a basic trellis cell is shown in FIG. 17. FIG. 17 shows an example of a basic trellis cell according to embodiments of the invention. It should be noted that the invention is not restricted to trellises with 4 states 250. In other embodiments, the trellis can have more states 250. In particular, any number of states that represents an integer power of 2 is suitable. In an embodiment the number of states 250 is equal to eight, e.g. analogously to Table 3. Even if the trellis has more than 2 states 250, each node for a current neural network parameter 13′ is typically connected with two states for the previous neural network parameter 13 and two states of the next neural network parameters 13. It is, however, also possible that a node is connected with more than two states of the previous neural network parameters or more than two states of the next neural network parameters. Note that a fully connected trellis (each state 250 is connected with all states 250 of the previous and all states 250 of the next neural network parameters 13) would correspond to independent scalar quantization.

In an embodiment, the initial state cannot be freely selected (since it would require some side information rate to transmit this decision to the decoder). Instead, the initial state is either set to a pre-defined value or its value is derived based on other syntax elements. In this case, not all paths and states 250 are available for the first neural network parameters. As an example for a 4-state trellis, FIG. 18 shows a trellis structure for the case that the initial state is equal to 0. FIG. 18 shows a Trellis example for dependent scalar quantization of 8 neural network parameters according to embodiments of the invention. The first state (left side) represents an initial state, which is set equal to 0 in this example.

### 4.4 Entropy Coding

The quantization indexes obtained by dependent quantization are encoded using an entropy coding method. For this any entropy coding method is applicable. In an embodiment of the invention, the entropy coding method according to section 2.2 (see section 2.2.1 for encoder method and section 2.2.2 for decoder method) using Context-Adaptive Binary Arithmetic Coding (CABAC), is applied. For this, the non-binary are first mapped onto a series of binary decisions (so-called bins) in order to transmit the quantization indexes as absolute values, e.g. as shown in FIG. 5 (binarization).

It should be noted that any of the concepts described here, can be combined with the method and related concepts (especially concerning context modelling) in sec. 3.

### 4.4.1 Context Modelling for Dependent Scalar Quantization

The main aspect of dependent scalar quantization is that there are different sets of admissible reconstruction levels (also called quantization sets) for the neural network parameters 13. The quantization set for a current neural network parameter 13′ is determined based on the values of the quantization index 56 for preceding neural network parameters. If we consider the example in FIG. 11 and compare the two quantization sets, it is obvious that the distance between the reconstruction level equal to zero and the neighboring reconstruction levels is larger in set 0 than in set 1. Hence, the probability that a quantization index 56 is equal to 0 is larger if set 0 is used and it is smaller if set 1 is used. In an embodiment, this effect is exploited in the entropy coding by switching codeword tables or probability models based on the quantization sets (or states) that are used for a current quantization index.

Note that for a suitable switching of codeword tables or probability models, the path (association with a subset of the used quantization set) of all preceding quantization indexes has to be known when entropy decoding a current quantization index (or a corresponding binary decision of a current quantization index). Therefore, the neural network parameters 13 have to be coded in reconstruction order. Hence, in an embodiment, the coding order of neural network parameters 13 is equal to their reconstruction order. Beside that aspect, any coding/reconstruction order of quantization indexes 56 is possible, such as the one specified in section 2.2.1, are any other uniquely defined order.

In other words, embodiments according to the invention comprise apparatuses, e.g. for encoding neural network parameters, using probability models that additionally depend on the quantization index of previously encoded neural network parameters.

Respectively, embodiments according to the invention comprise apparatuses, e.g. for decoding neural network parameters, using probability models that additionally depend on the quantization index of previously decoded neural network parameters.

At least a part of bins for the absolute levels is typically coded using adaptive probability models (also referred to as contexts). In an embodiment of the invention, the probability models of one or more bins are selected based on the quantization set (or, more generally, the corresponding state variable, e.g. with a relationship according to any of Tables 1-3) for the corresponding neural network parameter. The chosen probability model can depend on multiple parameters or properties of already transmitted quantization indexes 56, but one of the parameters is the quantization set or state that applies to the quantization index being coded.

In other words, apparatuses, for example for encoding neural network parameters 13, according to embodiments may be configured to preselect, depending on the state or the set 48 of reconstruction levels selected for the current neural network parameter 13′, a subset of probability models out of a plurality of probability models and select the probability model for the current neural network parameter out of the subset of probability models depending on 121 the quantization index of previously encoded neural network parameters.

Respectively apparatuses, for example for decoding neural network parameters 13, according to embodiments may be configured to preselect, depending on the state or the set 48 of reconstruction levels selected for the current neural network parameter 13′, a subset of probability models out of a plurality of probability models and select the probability model for the current neural network parameter out of the subset of probability models depending on 121 the quantization index of previously decoded neural network parameters.

For example in combination with inventive concepts as explained in the context of FIG. 9, embodiments, for example for encoding and/or decoding of neural network parameters 13, according to the invention comprise apparatuses configured to preselect, depending on the state or the set 48 of reconstruction levels selected for the current neural network parameter 13′, the subset of probability models out of the plurality of probability models in a manner so that a subset preselected for a first state or reconstruction levels set is disjoint to a subset preselected for any other state or reconstruction levels set.

In an embodiment, the syntax for transmitting the quantization indexes of a layer includes a bin that specifies whether the quantization index is equal to zero or whether it is not equal to 0, e.g. the beforementioned sig_flag. The probability model that is used for coding this bin is selected among a set of two or more probability models. The selection of the probability model used depends on the quantization set (i.e., the set of reconstruction levels) that applies to the corresponding quantization index 56. In another embodiment of the invention, the probability model used depends on the current state variable (the state variables implies the used quantization set).

In a further embodiment, the syntax for transmitting the quantization indexes of a layer includes a bin that specifies whether the quantization index is greater than zero or lower than zero, e.g. the beforementioned sign_flag. In other words, the bin indicates the sign of the quantization index. The selection of the probability model used depends on the quantization set (i.e., the set of reconstruction levels) that applies to the corresponding quantization index. In another embodiment, the probability model used depends on the current state variable (the state variables implies the used quantization set).

In a further embodiment, the syntax for transmitting the quantization indexes includes a bin that specifies whether the absolute value of a quantization index (neural network parameter level) is greater than X, e.g. the beforementioned abs_level_greater_X (for details refer to section 0). The probability model that is used for coding this bin is selected among a set of two or more probability models. The selection of the probability model used depends on the quantization set (i.e., the set of reconstruction levels) that applies to the corresponding quantization index 56. In another embodiment, the probability model used depends on the current state variable (the state variables implies the used quantization set).

One advantageous aspect of embodiments discussed herein is that the dependent quantization of neural network parameters 13 is combined with an entropy coding, in which the selection of a probability model for one or more bins of the binary representation of the quantization indexes (which are also referred to as quantization levels) depends on the quantization set (set of admissible reconstruction levels) or a corresponding state variable for the current quantization index. The quantization set 52 (or state variable) is given by the quantization indexes 56 (or a subset of the bins representing the quantization indexes) for the preceding neural network parameters in coding and reconstruction order.

In embodiments, the described selection of probability models is combined with one or more of the following entropy coding aspects:
The absolute values of the quantization indexes are transmitted using a binarization scheme that consists of a number of bins that are coded using adaptive probability models and, if the adaptive coded bins do not already completely specify the absolute value, a suffix part that is coded in the bypass mode of the arithmetic coding engine (non-adaptive probability model with a pmf (e.g. probability mass function) (0.5, 0.5) for all bins). In an embodiment, the binarization used for the suffix part depends on the values of the already transmitted quantization indexes.
The binarization for the absolute values of the quantization indexes includes an adaptively coded bin that specifies whether the quantization index is unequal to 0. The probability model (as referred to a context) used for coding this bin is selected among a set of candidate probability models. The selected candidate probability model is not only determined by the quantization set (set of admissible reconstruction levels) or state variable for the current quantization index 56, but, in addition, it is also determined by already transmitted quantization indexes for the layer. In an embodiment, the quantization set (or state variable) determines a subset (also called context set) of the available probability models and the values of already coded quantization indexes determine the used probability model inside this subset (context set).

In an embodiment, the used probability model inside a context set is determined based on the values of the already coded quantization indexes in a local neighborhood of the current neural network parameter, e.g. a template as explained in 2.2.3. In the following, some example measures are listed that can be derived based on the values of the quantization indexes in the local neighborhood and can, then, be used for selecting a probability model of the pre-determined context set:
The signs of the quantization indexes not equal to 0 inside the local neighborhood.
The number of quantization indexes not equal to 0 inside the local neighborhood. This number can possibly be clipped to a maximum value.
The sum of the absolute values of the quantization indexes in the local neighborhood. This number can be clipped to a maximum value.
The difference of the sum of the absolute values of the quantization indexes in the local neighborhood and number of quantization indexes not equal to 0 inside the local neighborhood. This number can be clipped to a maximum value.

In other words, embodiments according to the invention comprise apparatuses, e.g. for encoding neural network parameters configured to select the probability model for the current neural network parameter out of the subset of probability models depending on a characteristic of the quantization index of previously encoded neural network parameters which relate to a portion of the neural network neighboring a portion which the current neural network parameter relates to, the characteristic comprising on or more of
the signs of non-zero quantization indices of previously encoded neural network parameters which relate to a portion of the neural network neighboring a portion which the current neural network parameter relates to,
the number of quantization indices of previously encoded neural network parameters which relate to a portion of the neural network neighboring a portion which the current neural network parameter relates to, and which are non-zero
a sum of the absolute values of quantization indices of previously encoded neural network parameters which relate to a portion of the neural network neighboring a portion which the current neural network parameter relates to
a difference between
a sum of the absolute values of quantization indices of previously encoded neural network parameters which relate to a portion of the neural network neighboring a portion which the current neural network parameter relates to,
and the number of quantization indices of the previously encoded neural network parameters which relate to a portion of the neural network neighboring a portion which the current neural network parameter relates to, and which are non-zero.

Respectively, embodiments according to the invention comprise apparatuses, e.g. for decoding neural network parameters, configured to select the probability model for the current neural network parameter out of the subset of probability models depending on a characteristic of the quantization index of previously decoded neural network parameters which relate to a portion of the neural network neighboring a portion which the current neural network parameter relates to, the characteristic comprising on or more of
the signs of non-zero quantization indices of previously decoded neural network parameters which relate to a portion of the neural network neighboring a portion which the current neural network parameter relates to,
the number of quantization indices of previously decoded neural network parameters which relate to a portion of the neural network neighboring a portion which the current neural network parameter relates to, and which are non-zero
a sum of the absolute values of quantization indices of previously decoded neural network parameters which relate to a portion of the neural network neighboring a portion which the current neural network parameter relates to
a difference between
   a sum of the absolute values of quantization indices of previously decoded neural network parameters which relate to a portion of the neural network neighboring a portion which the current neural network parameter relates to, and
   the number of quantization indices of the previously decoded neural network parameters which relate to a portion of the neural network neighboring a portion which the current neural network parameter relates to, and which are non-zero.
The binarization for the absolute values of the quantization indexes includes adaptively coded bin that specifies whether the absolute value of the quantization index is greater than X, e.g. abs_level_greater_X. The probability models (as referred to a context) used for coding these bins are selected among a set of candidate probability models. The selected probability models are not only determined by the quantization set (set of admissible reconstruction levels) or state variable for the current quantization index, but, in addition, it is also determined by already transmitted quantization indexes for the layer, e.g. using a template as beforementioned. In an embodiment, the quantization set (or state variable) determines a subset (also called context set) of the available probability models and the data of already coded quantization indexes determines, for example in other words can be used to determine, the used probability model inside this subset (context set). For selecting the probability model, any of the methods described above (for the bin specifying whether a quantization index is unequal to 0) can be used.

Furthermore, apparatuses according to the invention may be configured to locate the previously encoded neural network parameters 13 so that the previously encoded neural network parameters 13 relate to the same neural network layer as the current neural network parameter 13′.

Moreover, apparatuses, e.g. for encoding neural network parameters according to the invention may be configured to locate one or more of the previously encoded neural network parameters in a manner so that the one or more previously encoded neural network parameters relate to neuron interconnections which emerge from, or lead towards, a neuron 10c to which a neuron interconnection 11 relates which the current neural network parameter refers to, or a further neuron neighboring said neuron.

Apparatuses according to further embodiments may be configured to encode the quantization index 56 for the current neural network parameter 13′ into the data stream 14 using binary arithmetic coding by using the probability model which depends on previously encoded neural network parameters for one or more leading bins of a binarization of the quantization index and by using an equi-probable bypass mode suffix bins of the binarization of the quantization index which follow the one or more leading bins.

The suffix bins of the binarization of the quantization index may represent bins of a binarization code of a suffix binarization for binarizing values of the quantization index an absolute value of which exceeds a maximum absolute value representable by the one or more leading bins. Therefore, an apparatus according to embodiments of the invention may be configured to select the suffix binarization depending on the quantization index 56 of previously encoded neural network parameters 13.

Respectively, apparatuses according, e.g. for decoding neural network parameters to the invention may be configured to locate the previously decoded neural network parameters 13 so that the previously decoded neural network parameters relate to the same neural network layer as the current neural network parameter 13′.

According to further embodiments, apparatuses, e.g. for decoding neural network parameters according to the invention may be configured to locate one or more of the previously decoded neural network parameters 13 in a manner so that the one or more previously decoded neural network parameters relate to neuron interconnections 11 which emerge from, or lead towards, a neuron 10c to which a neuron interconnection relates which the current neural network parameter refers to, or a further neuron neighboring said neuron.

Apparatuses according to further embodiments may be configured to decode the quantization index 56 for the current neural network parameter 13′ from the data stream 14 using binary arithmetic coding by using the probability model which depends on previously decoded neural network parameters for one or more leading bins of a binarization of the quantization index and by using an equi-probable bypass mode suffix bins of the binarization of the quantization index which follow the one or more leading bins.

The suffix bins of the binarization of the quantization index may represent bins of a binarization code of a suffix binarization for binarizing values of the quantization index an absolute value of which exceeds a maximum absolute value representable by the one or more leading bins.

Therefore an apparatus according ot embodiments may be configured to selected the suffix binarization depending on the quantization index of previously decoded neural network parameters.

### 4.5 Example Method for Encoding

For obtaining bitstreams that provide a very good trade-off between distortion (reconstruction quality) and bit rate, the quantization indexes should be selected in a way that a Lagrangian cost measure

$$D + λ \cdot R = {\sum }_{k} {D}_{k} + λ \cdot {R}_{k} = {\sum }_{k} {α}_{k} \cdot {( {t}_{k} - {t}_{k}^{′} )}^{2} + λ \cdot R ( {q}_{k} \vert {q}_{k - 1} , {q}_{k - 2} , ⋯ )$$

is minimized. For independent scalar quantization, such a quantization algorithm (referred to as rate-distortion optimized quantization or RDOQ) was discussed in sec. 2.1.1 But in comparison to independent scalar quantization, we have an additional difficulty. The reconstructed neural network parameters

$${t}_{k}^{′}$$

and, thus, their distortion

$${D}_{k} = \vert {t}_{k} - {t}_{k}^{′} \vert$$

$$( or {D}_{k , MSE} = {( {t}_{k} - {t}_{k}^{′} )}^{2} ) ,$$

do not only depend on the associated quantization index qₖ 56, but also on the values of the preceding quantization indexes in coding order.

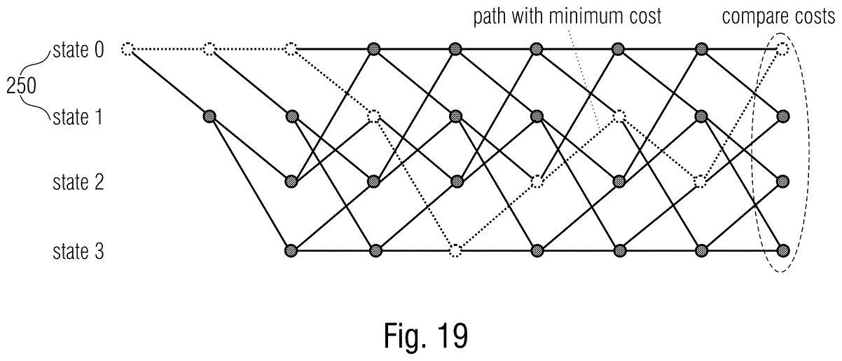

However, as we have discussed in sec. 4.3.3, the dependencies between the neural network parameters 13 can be represented using a trellis structure. For the further description, we use the embodiment given in FIG. 11 as an example. The trellis structure for the example of a set of 8 neural network parameters is shown in FIG. 19. FIG. 19 shows example trellis structures that can be exploited for determining sequences (or blocks) of quantization indexes that minimize a cost measures (such as an Lagrangian cost measure D+λ·R), according to embodiments of the invention. The trellis structure represents the example of dependent quantization with 4 states (see FIG. 18). The trellis is shown for 8 neural network parameters (or quantization indexes). The first state (at the very left) represents an initial state, which is assumed to be equal to 0. The paths through the trellis (from the left to the right) represent the possible state transitions for the quantization indexes 56. Note that each connection between two nodes represents a quantization index of a particular subset (A, B, C, D). If we chose a quantization index qₖ 56 from each of the subsets (A, B, C, D) and assign the corresponding rate-distortion cost

$${J}_{k} = {D}_{k} ( {q}_{k} \vert {q}_{k - 1} , {q}_{k - 2} , ⋯ ) + λ \cdot {R}_{k} ( {q}_{k} \vert {q}_{k - 1} , {q}_{k - 2} , ⋯ )$$

to the associated connection between two trellis nodes, the problem of determining the vector/block of quantization indexes that minimizes the overall rate-distortion cost D+λ·R is equivalent to finding the path with minimum cost path through the trellis (from the left to the right in FIG. 19). If we neglect some dependencies in the entropy coding, this minimization problem can be solved using the well-known Viterbi algorithm.

In other words, embodiments according to the invention comprise apparatuses configured to use a Viterbi algorithm and a rate-distortion cost measure to perform the selection and/or the quantizing.

An example encoding algorithm for selecting suitable quantization indexes for a layer could consist of the following main steps:
1. Set the rate-distortion cost for initial state equal to 0.
2. For all neural network parameters 13 in coding order, do the following:
   a. For each subset A, B, C, D, determine the quantization index 56 that minimizes the distortion for the given original neural network parameter 13.
   b. For all trellis nodes (0, 1, 2, 3) for the current neural network parameter 13′, do the following:
      i. Calculate the rate-distortion costs for the two paths that connect a state for the preceding neural network parameter 13 with the current state. The costs are given as the sum of the cost for the preceding state and the Dₖ+λ·Rₖ, where Dₖ and Rₖ represent the distortion and rate for choosing the quantization index of the subset (A, B, C, D) that is associated with the considered connection.
      ii. Assign the minimum of the calculated costs to the current node and prune the connection to the state of the previous neural network parameter 13 that does not represent the minimum cost path.
   Note: After this step all nodes for the current neural network parameter 13′ have a single connection to any node for the preceding neural network parameter 13
3. Compare the costs of the 4 final nodes (for the last parameter in coding order) and chose the node with minimum cost. Note that this node is associated with a unique path through the trellis (all other connection were pruned in the previous steps).
4. Follow the chosen path (specified by the final node) is reverse order and collect the quantization indexes 56 that are associated with the connections between the trellis nodes.

It should be noted that the determination of quantization indexes 56 based on the Viterbi algorithm is not substantially more complex than rate-distortion optimized quantization (RDOQ) for independent scalar quantization. Nonetheless, there are also simpler encoding algorithms for dependent quantization. For example, starting with a pre-defined initial state (or quantization set), the quantization indexes 56 could be determined in coding/reconstruction order by minimizing any cost measure that only considers the impact of a current quantization index. Given the determined quantization index for a current parameter (and all preceding quantization indexes), the quantization set for the next neural network parameter 13 is known. And, thus, the algorithm can be applied to all neural network parameters in coding order.

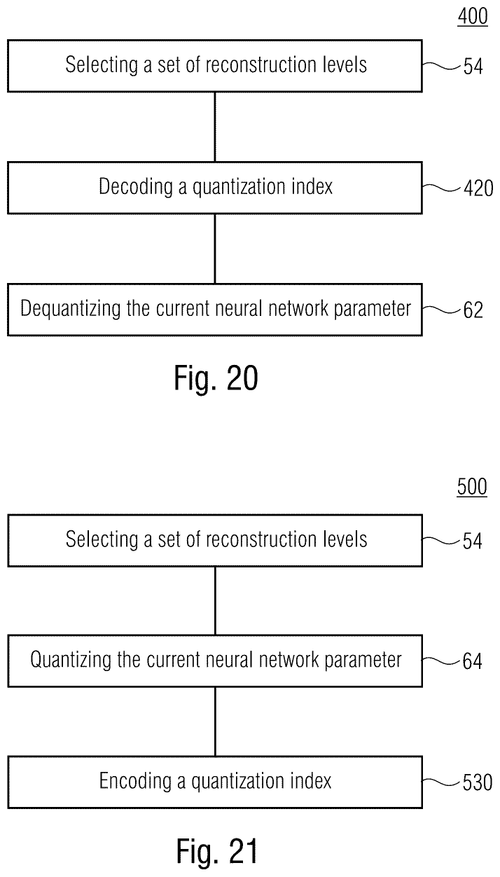

In the following methods according to embodiments are shown in FIGS. 20, 21, 22 and 23.

FIG. 20 shows a block diagram of a method 400 for decoding neural network parameters, which define a neural network, from a data stream, the method 400 comprising sequentially decoding the neural network parameters by selecting 54, for a current neural network parameter, a set of reconstruction levels out of a plurality of reconstruction level sets depending on quantization indices decoded from the data stream for previous neural network parameters, by decoding 420 a quantization index for the current neural network parameter from the data stream, wherein the quantization index indicates one reconstruction level out of the selected set of reconstruction levels for the current neural network parameter, and by dequantizing 62 the current neural network parameter onto the one reconstruction level of the selected set of reconstruction levels that is indicated by the quantization index for the current neural network parameter.

FIG. 21 shows a block diagram of a method 500 for encoding neural network parameters, which define a neural network, from a data stream, the method 500 comprising sequentially encoding the neural network parameters by selecting 54, for a current neural network parameter, a set of reconstruction levels out of a plurality of reconstruction level sets depending on quantization indices encoded into the data stream for previously encoded neural network parameters, by quantizing 64 the current neural network parameter onto the one reconstruction level of the selected set of reconstruction levels, and by encoding 530 a quantization index for the current neural network parameter that indicates the one reconstruction level onto which the quantization index for the current neural network parameter is quantized into the data stream.

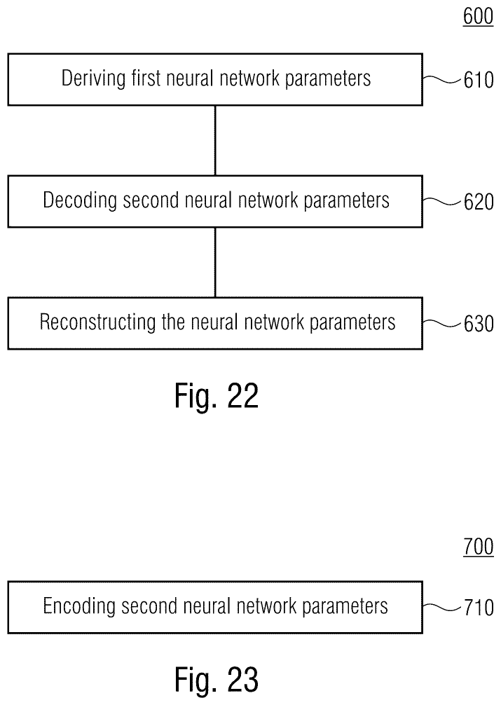

FIG. 22 shows a block diagram of a method for reconstructing neural network parameters, which define a neural network, according to embodiments of the invention. The Method 600 comprises deriving 610 first neural network parameters for a first reconstruction layer to yield, per neural network parameter, a first-reconstruction-layer neural network parameter value, The method 600 further comprises decoding 620 (e.g. as shown with arrow 312 in FIG. 6) second neural network parameters for a second reconstruction layer from a data stream to yield, per neural network parameter, a second-reconstruction-layer neural network parameter value, and reconstructing 630 (e.g. as shown with arrow 314 in FIG. 6) the neural network parameters by, for each neural network parameter, combining the first-reconstruction-layer neural network parameter value and the second-reconstruction-layer neural network parameter value.

FIG. 23 shows a block diagram of a method for encoding neural network parameters, which define a neural network, according to embodiments of the invention. The Method 700 uses first neural network parameters for a first reconstruction layer which comprise, per neural network parameter, a first-reconstruction-layer neural network parameter value, and comprises encoding 710 (e.g. as shown with arrow 322 in FIG. 6) second neural network parameters for a second reconstruction layer into a data stream, which comprise, per neural network parameter, a second-reconstruction-layer neural network parameter value, wherein the neural network parameters are reconstructible by, for each neural network parameter, combining the first-reconstruction-layer neural network parameter value and the second-reconstruction-layer neural network parameter value.

In the following, additional embodiments according to the invention will be presented.

| | |
|---|---|
| quant_tensor( dimensions, maxNumNoRem, entryPointOffset ) { | |
| stateId = 0 | 997 |
| bitPointer = get_bit_pointer( ) | 998 |
| lastOffset = 0 | 999 |
| for( i = 0; i < Prod( dimensions ); i++ ) { | 1000 |
| idx = TensorIndex( dimensions, i, scan_order ) | 1001 |
| if( entryPointOffset != −1 && | 1002 |
| GetEntryPointIdx( dimensions, i, scan_order) != −1 ) { | |
| lvlCurrRange = 256 | 1003 |
| j = entryPointOffset + GetEntryPointIdx | 1004 |
| ( dimensions, i, scan_order ) | |
| lvlOffset = cabac_offset_list[j] | 1005 |
| if(dq_flag) | 1006 |
| stateId = dq_state_list[j] | 1007 |
| set_bit_pointer( bitPointer + lastOffset + BitOffsetList[j] ) | 1008 |
| lastOffset = BitOffsetList[j] | 1009 |
| Invoke initialisation process for probability | 1010 |
| estimation parameters | |
| } | 1011 |
| int_param( idx, maxNumNoRem, stateId ) | 1012 |
| if(dq_flag) { | 1013 |
| nextSt = StateTransTab[stateId][QuantParam[idx] & 1] | 1014 |
| if( QuantParam[idx] != 0 ) { | 1015 |
| QuantParam[idx] = QuantParam[idx] << 1 | 1016 |
| if( QuantParam[idx] < 0 ) | 1017 |
| QuantParam[idx] += stateId & 1 | 1018 |
| else | 1019 |
| QuantParam[idx] += − (stateId & 1 ) | 1020 |
| } | 1021 |
| stateId = nextSt | 1022 |
| } | |
| } | |
| } | |

The 2D integer array State TransTab [ ] [ ], for example shown in line 1014 specifies the state transition table for dependent scalar quantization and is as follows:

$$StateTransTab [ ] [ ] = \{ \{ 0 , 2 \} , \{ 7 , 5 \} , \{ 1 , 3 \} , \{ 6 , 4 \} , \{ 2 , 0 \} , \{ 5 , 7 \} , \{ 3 , 1 \} , \{ 4 , 6 \} \}$$

| | |
|---|---|
| int_param( i, maxNumNoRem, stateId ) { | |
| QuantParam[i] = 0 | 5997 |
| sig_flag | 5998 |
| if( sig_flag ) { | 5999 |
| QuantParam[i]++ | 6000 |
| sign_flag | 6001 |
| j = −1 | 6002 |
| do { | 6003 |
| j++ | 6004 |
| abs_level_greater_x[j] | 6005 |
| QuantParam[i] += abs_level_greater_x[j] | 6006 |
| } while( abs_level_greater_x[j] == | 6007 |
| 1 && j < maxNumNoRem ) | |
| if( j == maxNumNoRem ) { | 6008 |
| RemBits = 0 | 6009 |
| j = −1 | 6010 |
| do { | 6011 |
| j++ | 6012 |
| abs_level_greater_x2[j] | 6013 |
| if( abs_level_greater_x2[j] ) { | 6014 |
| RemBits++ | 6015 |
| QuantParam[i] += 1 << RemBits | 6016 |
| } | 6017 |
| } while( abs_level_greater_x2[j] && j < 30 ) | 6018 |
| abs_remainder | 6019 |
| QuantParam[i] += abs_remainder | 6020 |
| } | 6021 |
| QuantParam[i] = sign_flag ? −QuantParam[i] : | 6022 |
| QuantParam[i] | |
| } | |
| } | |

Inputs to this process are:
A variable tensorDims specifying the dimensions of the tensor to be decoded.
A variable entryPointOffset indicating whether entry points are present for decoding and, if entry points are present, an entry point offset.
A variable codebookld indicating whether a codebook is applied and, if a codebook is applied, which codebook shall be used.

Output of this process is a variable recParam of type TENSOR_FLOAT with dimensions equal to tensorDims.

A variable stepSize is derived as follows:

$$mul = ( 1 << QpDensity ) + ( ( qp\_value + QuantizationParameter ) \& ( ( 1 << QpDensity ) - 1 ) ) \qquad 3001$$

$$shift = ( qp\_value + QuantizationParameter ) >> QpDensity \qquad 3002$$

$$stepSize = mul * {2}^{shift - QpDensity} \qquad 3003$$

Variable recParam is updated as follows:

$$recP aram = recParam * stepSize \qquad 4001$$

NOTE-Following from the above calculations, recParam can be represented as binary fraction.

As to the derivation process of ctxInc indicating the context or probability estimation to b used
for the syntax element sig_flag:

Inputs to this process are the sig_flag decoded before the current sig_flag, the state value stateld and the associated sign_flag, if present. If no sig_flag was decoded before the current sig_flag, it is assumed to be 0. If no sign_flag associated with the previously decoded sig_flag was decoded, it is assumed to be 0.

Output of this process is the variable ctxInc.

The variable ctxInc is derived as follows:
If sig_flag is equal to 0, ctxInc is set to stateld*3.
Otherwise, if sign_flag is equal to 0, ctxInc is set to stateld*3+1.
Otherwise, ctxInc is set to stateld*3+2.

The example above shows a concept for coding/decoding neural network parameters 13 into/from a data stream 14, wherein the neural network parameters 13 may relate to weights of neuron interconnections 11 of the neural network 10, e.g. weights of a weight tensor. The decoding/coding the neural network parameters 13 is done sequentially. See the for-next loop 1000 which cycles through the weights of the tensor with as many weights as the product of number of weights per dimension of the tensor. The weights are scanned at some predetermined order TensorIndex (dimensions, i, scan_order). For a current neural network parameter idx 13′, a set of reconstruction levels out of two reconstruction level sets 52 is selected at 1018 and 1020 depending on a quantization state stateld which is continuously updated based on the quantization indices 58 decoded from the data stream for previous neural network parameters. In particular, a quantization index for the current neural network parameter idx is decoded from the data stream at 1012, wherein the quantization index indicates one reconstruction level out of the selected set of reconstruction levels for the current neural network parameter 13′. The two s′recontruction level sets are defined by the duplication at 1016 followed by the addition of one or minus one depending on the quantization state index at 1018 and 1020. Here, at 1018 and 1020, the current neural network parameter 13′ is actually dequantized onto the one reconstruction level of the selected set of reconstruction levels that is indicated by the quantization index QuantParam [idx] for the current neural network parameter 13′. A step size stepSize is used to parametrize the reconstruction level sets at 3001-3003. Information on this predetermined quantization step size stepSize is derived from the data stream via a syntax element qp_value. The latter might be coded in the data stream for the whole tensor or the whole NN layer, respectively, or even for the whole NN. That is, the neural network 10 may comprises a one or more NN layers 10a, 10b and, for each NN layer, the information on the predetermined quantization step size (QP) may be derived for the respective NN layer from the data stream 14, and, for each NN layer, the plurality of reconstruction level sets may then be parametrized using the predetermined quantization step size derived for the respective NN layer so as to be used for dequantizing the neural network parameters 13 belonging to the respective NN layer.

The first reconstruction level set for stateld=0 comprises here zero and even multiples of a predetermined quantization step size, and the second reconstruction level set for stateld=1 that comprises zero and odd multiples of the predetermined quantization step size (QP) as can be seen at 1018 and 1020. For each neural network parameter 13, an intermediate integer value QuantParam [idx] (IV) is derived depending on the selected reconstruction level set for the respective neural network parameter13 and the entropy decoded quantization index QuantParam [idx] for the respective neural network parameter at 1015 to 1021, and then, for each neural network parameter, the intermediate value for the respective neural network parameter is multiplied with the predetermined quantization step size for the respective neural network parameter at 4001.

The selection, for the current neural network parameter 13′, of the set of reconstruction levels out of the two of reconstruction level sets (e.g. set 0, set 1) is done depending on a LSB portion of the quantization indices decoded from the data stream for previously decoded neural network parameters as shown at 1014 where a transition table transitions from stateld to the next quantization state nextSt depending on the LSB of QuantParam [idx] so that the statld depends on the past sequence of already decoded quantization indices 56. The stat transitioning depends, thus, on the result of a binary function of the quantization indices 56 decoded from the data stream for previously decoded neural network parameters, namely the parity thereof. In other words, the selection, for the current neural network parameter, of the set of reconstruction levels out of the plurality of reconstruction level sets is done by means of a state transition process by determining, for the current neural network parameter, the set of reconstruction levels out of the plurality of reconstruction level sets depending on a state statld associated with the current neural network parameter at 1018 and 1020 and updating the state statld at 1014 for a subsequent neural network parameter, not necessarily the NN parameter to be coded/decoded next, but the one for whom the stateld is to be determined next, depending on the quantization index decoded from the data stream for the immediately preceding neural network parameter, i.e the one for whom the stateld had been determined so far. For example, here the current neural network parameter is used for the update to yield stateld for the NN par ammeter to be coded/decoded next. The update at 1014 is done using a binary function of the quantization index decoded from the data stream for the immediately preceding (current) neural network parameter, namely using a parity thereof. The state transition process is configured to transition between eight possible states. The transitioning is done via table StateTransTab [ ] [ ]. In the state transition process, transitioning is done between these eight possible states, wherein the determining in 1018 and 1020, for the current neural network parameter, of the set of reconstruction levels out of the quantization sets depending on the state stateld associated with the current neural network parameter determines a first reconstruction level set out of the two reconstruction level sets if the state belongs to a first half of the even number of possible states, namely the odd states, and a second reconstruction level set out of the two reconstruction level sets if the state belongs to a second half of the even number of possible states, i.e. the ven states. The update of the state statld is done by means of a transition table State TransTab [ ] [ ] which maps a combination of the state statID and a parity of the quantization index (58), QuantParam [idx] & 1, decoded from the data stream for the immediately preceding (current) neural network parameter onto a further state associated with the subsequent neural network parameter.

The quantization index for the current neural network parameter is coded into, and decoded from, the data stream using arithmetic coding using a probability model which depends on the set of reconstruction levels selected for the current neural network parameter or, to be more precise, the quantization state stateld, i.e. the state for the current neural network parameter 13′. See the third parameter when calling function int_param in 1012. In particular, the quantization index for the current neural network parameter may be coded into, and decoded from, the data stream using binary arithmetic coding/decoding by using a probability model which depends on the state for the current neural network parameter for at least one bin of a binarization of the quantization index, here the bin sig_flag out of the binarization sig_flag, sign_flag (optional), abs_level_greater_x [j], abs_level_greater_x2 [j], and abs_remainder.

sig_flag is a significance bin indicative of the quantization index (56) of the current neural network parameter being equal to zero or not. The dependency of the probability model involves a selection of a context out of a set of contexts for the neural network parameters using the dependency, each context having a predetermined probability model associated therewith. Here, the context for sig_flag is selected by using ctxInc as an incrementer for an index for indexes the context out of a list of contetxs each of which being associated with a binary probability model. The model may be updated using the bins associated with the context. That is, the predetermined probability model associated with each of the contexts may be updated based on the quantization index arithmetically coded using the respective context. Note that the probability model for sig_flag additionally depends on the quantization index of previously decoded neural network parameters, namely the sig_flag of previously decoded neural network parameters, and sign_flag thereof-indicating the sign thereof. To be more precise, depending on the state stateld, a subset of probability models out of a plurality of probability models, namely out of context incrementer states 0 . . . 23, is preselected, namely an eight thereof including three consecutive contexts out of {0 . . . 23}, and the probability model for the current neural network parameter out of the subset of probability models for sig_flag is selected depending on (121) the quantization index of previously decoded neural network parameters, namely based on sig_flag and sign_flag of a previous NN parameter. Any subset preselected for a first value if stateID is disjoint to a subset preselected for any other value of statelD. The previous NN parameter whose sig_flag and sgin_flag is use, relates to a portion of the neural network neighboring a portion which the current neural network parameter relates to.

A plurality of embodiments has been described above. It is to be noted that aspects and features of embodiments may be used individually or in combination. Furthermore, aspects and features of embodiments according to first and second aspecst of the invention may be used in combination.

Further embodiments comprise apparatuses, wherein the neural network parameters relate to one reconstruction layer, e.g. enhancement layer, of reconstruction layers using which the neural network 10 is represented. The apparatuses may be configured so that the neural network is reconstructible by combining the neural network parameters, neural network parameter wise, with corresponding, e.g. those which relate to a common neuron interconnection or, frankly speaking, those which are co-located in the matrix representations of the NN layers in the different representations layers, neural network parameters of one or more further reconstruction layers.

For example as described with this embodiment, features and aspects of the first and second aspect of the invention may be combined. The facultative features of the dependent claims according to the second aspect shall be transferable hereto to yield further embodiments.

Furthermore, apparatuses according to aspects of the invention may be configured to encode the quantization index 56 for the current neural network parameter 13′ into the data stream 14 using arithmetic encoding using a probability model which depends on corresponding neural network parameter corresponding to the current neural network parameter.

Respectively, further embodiments comprise apparatuses, wherein the neural network parameters relate to one reconstruction layer, e.g. enhancement layer, of reconstruction layers using which the neural network 10 is represented. The apparatuses may be configured to reconstruct the neural network by combining the neural network parameters, neural network parameter wise, with corresponding, e.g. those which relate to a common neuron interconnection, or, frankly speaking, those which are co-located in the matrix representations of the NN layers in the different representations layers, neural network parameters of one or more further reconstruction layers.

For example as described with this embodiment, features and aspects of the first and second aspect of the invention may be combined. The facultative features of the dependent claims according to the second aspect shall be transferable hereto to yield further embodiments.

Furthermore, apparatuses according to aspects of the invention may be configured decode the quantization index 56 for the current neural network parameter 13′ from the data stream 14 using arithmetic coding using a probability model which depends on corresponding neural network parameter corresponding to the current neural network parameter.

In other words, neural network parameters of reconstruction layer, for example second neural network parameters as described, above may be encoded/decoded and/or quantized/dequantized according to the concepts explained with respect ot FIGS. 3 and 5 and FIGS. 2 and 4 respectively.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The inventive data stream can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

Some example solutions are listed below.

1. Apparatus for decoding neural network parameters (13), which define a neural network (10), from a data stream (14), configured to sequentially decode the neural network parameters (13) by selecting (54), for a current neural network parameter (13′), a set (48) of reconstruction levels out of a plurality (50) of reconstruction level sets (52) depending on quantization indices (58) decoded from the data stream (14) for previous neural network parameters, decoding a quantization index (56) for the current neural network parameter (13′) from the data stream (14), wherein the quantization index (56) indicates one reconstruction level out of the selected set (48) of reconstruction levels for the current neural network parameter, dequantizing (62) the current neural network parameter (13′) onto the one reconstruction level of the selected set (48) of reconstruction levels that is indicated by the quantization index (56) for the current neural network parameter.

2. Apparatus of solution 1, wherein the neural network parameters (13) relate to weights of neuron interconnections (11) of the neural network (10).

3. Apparatus of solution 1 or 2, wherein the number of reconstruction level sets (52) of the plurality (50) of reconstruction level sets (52) is two.

4. Apparatus of any of solutions 1 to 3, configured to parametrize (60) the plurality (50) of reconstruction level sets (52) by way of a predetermined quantization step size (QP) and derive information on the predetermined quantization step size from the data stream (14).

5. Apparatus of any of the previous solutions, wherein the neural network comprises a one or more NN layers and the apparatus is configured to derive, for each NN layer (p; p−1), information on a predetermined quantization step size for the respective NN layer from the data stream (14), and parametrize, for each NN layer, the plurality (50) of reconstruction level sets (52) using the predetermined quantization step size derived for the respective NN layer so as to be used for dequantizing the neural network parameters belonging to the respective NN layer.

6. Apparatus of any of solutions 1 to 5, wherein the number of reconstruction level sets (52) of the plurality (50) of reconstruction level sets (52) is two and the plurality of reconstruction level sets comprises a first reconstruction level set (set 0) that comprises zero and even multiples of a predetermined quantization step size, and a second reconstruction level set (set 1) that comprises zero and odd multiples of the predetermined quantization step size.

7. Apparatus of solutions 1 to 6, wherein all reconstruction levels of all reconstruction level sets represent integer multiples of a predetermined quantization step size, and the apparatus is configured to dequantize the neural network parameters by deriving, for each neural network parameter, an intermediate integer value depending on the selected reconstruction level set for the respective neural network parameter and the entropy decoded quantization index for the respective neural network parameter, and multiplying, for each neural network parameter, the intermediate value for the respective neural network parameter with the predetermined quantization step size for the respective neural network parameter.

8. Apparatus of solution 7, wherein the number of reconstruction level sets (52) of the plurality (50) of reconstruction level sets (52) is two and the apparatus is configured to derive the intermediate value for each neural network parameter by, if the selected reconstruction level set for the respective neural network parameter is a first set, multiply the quantization index for the respective neural network parameter by two to obtain the intermediate value for the respective neural network parameter; and if the selected reconstruction level set for a respective neural network parameter is a second set and the quantization index for the respective neural network parameter is equal to zero, set the intermediate value for the respective sample equal to zero; and if the selected reconstruction level set for a respective neural network parameter is a second set and the quantization index for the respective neural network parameter is greater than zero, multiply the quantization index for the respective neural network parameter by two and subtract one from the result of the multiplication to obtain the intermediate value for the respective neural network parameter; and if the selected reconstruction level set for a current neural network parameter is a second set and the quantization index for the respective neural network parameter is less than zero, multiply the quantization index for the respective neural network parameter by two and add one to the result of the multiplication to obtain the intermediate value for the respective neural network parameter.

9. Apparatus of any of solutions 1 to 8, configured to select (54), for the current neural network parameter (13′), the set (48) of reconstruction levels out of the plurality (50) of reconstruction level sets (52) depending on a LSB portion or previously decoded bins of a binarization of the quantization indices (58) decoded from the data stream (14) for previously decoded neural network parameters.

10. Apparatus of any of solutions 1 to 8, configured to select (54), for the current neural network parameter (13′), the set (48) of reconstruction levels out of the plurality (50) of reconstruction level sets (52) depending on the results of a binary function of the quantization indices (58) decoded from the data stream (14) for previously decoded neural network parameters.

11. Apparatus of any of solutions 1 to 10, wherein the apparatus is configured to select (54), for the current neural network parameter (13′), the set (48) of quantization levels out of the plurality (50) of reconstruction level sets (52) depending on a parity of the quantization indices (58) decoded from the data stream (14) for previously decoded neural network parameters.

12. Apparatus of any of solutions 1 to 11, wherein the number of reconstruction level sets (52) of the plurality (50) of reconstruction level sets (52) is two, and the apparatus is configured to derive a subset index for each neural network parameter based on the selected set of reconstruction levels for the respective neural network parameter and a binary function of the quantization index for the respective neural network parameter, resulting in four possible values for the subset index; and select (54), for the current neural network parameter (13′), the set (48) of reconstruction levels out of the plurality (50) of reconstruction level sets (52) depending on the subset indices for previously decoded neural network parameters.

13. Apparatus of solutions 12, wherein the apparatus is configured to select (54), for the current neural network parameter (13′), the set (48) of reconstruction levels out of the plurality (50) of reconstruction level sets (52) using a selection rule which depends on the subset indices for a number of immediately previously decoded neural network parameters and to use the selection rule for all, or a portion, of the neural network parameters.

14. Apparatus of solution 13, wherein the number of immediately previously decoded neural network parameters on which the selection rule depends is two.

15. Apparatus of any of solutions 12 to 14, wherein the subset index for each neural network parameter is derived based on the selected set of reconstruction levels for the respective neural network parameter and a parity of the quantization index for the respective neural network parameter.

16. Apparatus of any of solutions 1 to 15, wherein the apparatus is configured to select (54), for the current neural network parameter (13′), the set (48) of quantization levels out of the plurality (50) of reconstruction level sets (52) by means of a state transition process by determining, for the current neural network parameter (13′), the set (48) of quantization levels out of the plurality (50) of reconstruction level sets (52) depending on a state associated with the current neural network parameter (13′), and updating the state for a subsequent neural network parameter depending on the quantization index (58) decoded from the data stream for the immediately preceding neural network parameter.

17. Apparatus of solution 16, configured to update the state for the subsequent neural network parameter using a binary function of the quantization index (58) decoded from the data stream for the immediately preceding neural network parameter.

18. Apparatus of solution 16, configured to update the state for the subsequent neural network parameter using a parity of the quantization index (58) decoded from the data stream for the immediately preceding neural network parameter.

19. Apparatus of any of solutions 16 to 18, wherein the state transition process is configured to transition between four or eight possible states.

20. Apparatus of any of solutions 16 to 19, configured to transition, in the state transition process, between an even number of possible states and the number of reconstruction level sets (52) of the plurality (50) of reconstruction level sets (52) is two, wherein the determining, for the current neural network parameter (13′), the set (48) of quantization levels out of the quantization sets (52) depending on the state associated with the current neural network parameter (13′) determines a first reconstruction level set out of the plurality (50) of reconstruction level sets (52) if the state belongs to a first half of the even number of possible states, and a second reconstruction level set out of the plurality (50) of reconstruction level sets (52) if the state belongs to a second half of the even number of possible states.

21. Apparatus of any of solutions 16 to 20, configured to perform the update of the state by means of a transition table which maps a combination of the state and a parity of the quantization index (58) decoded from the data stream for the immediately preceding neural network parameter onto a further state associated with the subsequent neural network parameter.

22. Apparatus of any of solutions 1 to 21, configured to decode the quantization index (56) for the current neural network parameter (13′) from the data stream (14) using arithmetic coding using a probability model which depends on (123) the set (48) of reconstruction levels selected for the current neural network parameter (13′).

23. Apparatus of any of solutions 1 to 21, configured to select (54), for the current neural network parameter (13′), the set (48) of quantization levels out of the plurality (50) of reconstruction level sets (52) by means of a state transition process by determining, for the current neural network parameter (13′), the set (48) of quantization levels out of the plurality (50) of reconstruction level sets (52) depending on a state associated with the current neural network parameter (13′), and updating the state for a subsequent neural network parameter depending on the quantization index (58) decoded from the data stream for the immediately preceding neural network parameter, and decode the quantization index (56) for the current neural network parameter (13′) from the data stream (14) using arithmetic coding using a probability model which depends on (122) the state for the current neural network parameter (13′).

24. Apparatus of solution 23, configured to decode the quantization index (56) for the current neural network parameter (13′) from the data stream (14) using binary arithmetic coding by using the probability model which depends on (122) the state for the current neural network parameter (13′) for at least one bin (84) of a binarization (82) of the quantization index (56).

25. Apparatus of solution 23, wherein the at least one bin comprises a significance bin indicative of the quantization index (56) of the current neural network parameter being equal to zero or not.

26. Apparatus of any of solutions 23 to 25, wherein the at least one bin comprises a sign bin (86) indicative of the quantization index (56) of the current neural network parameter being greater than zero or lower than zero.

27. Apparatus of any of solutions 23 to 26, wherein the at least one bin comprises a greater-than-X bin indicative of an absolute value of the quantization index (56) of the current neural network parameter being greater than X or not, wherein X is an integer greater than zero.

28. Apparatus of solution 22 or any of 23, 25-27, configured so that the dependency of the probability model involves a selection (103) of a context (87) out of a set of contexts for the neural network parameters using the dependency, each context having a predetermined probability model associated therewith.

29. Apparatus of solution 28, configured to update the predetermined probability model associated with each of the contexts based on the quantization index arithmetically coded using the respective context.

30. Apparatus of any of solutions 1 to 29, configured to decode the quantization index (56) for the current neural network parameter (13′) from the data stream (14) using binary arithmetic coding by using a probability model which depends on the set (48) of reconstruction levels selected for the current neural network parameter (13′) for at least one bin of a binarization of the quantization index.

31. Apparatus of solution 30, wherein the at least one bin comprises a significance bin indicative of the quantization index (56) of the current neural network parameter being equal to zero or not.

32. Apparatus of any of solutions 30 to 31, wherein the at least one bin comprises a sign bin indicative of the quantization index (56) of the current neural network parameter being greater than zero or lower than zero.

33. Apparatus of any of solutions 30 to 32, wherein the at least one bin comprises a greater-than-X bin indicative of an absolute value of the quantization index (56) of the current neural network parameter being greater than X or not, wherein X is an integer greater than zero.

34. Apparatus of any of solutions 22 to 33 model, wherein the probability model additionally depends on the quantization index of previously decoded neural network parameters.

35. Apparatus of solution 34, configured to preselect, depending on the state or the set (48) of reconstruction levels selected for the current neural network parameter (13′), a subset of probability models out of a plurality of probability models and select the probability model for the current neural network parameter out of the subset of probability models depending on (121) the quantization index of previously decoded neural network parameters.

36. Apparatus of solution 35, configured to preselect, depending on the state or the set (48) of reconstruction levels selected for the current neural network parameter (13′), the subset of probability models out of the plurality of probability models in a manner so that a subset preselected for a first state or reconstruction levels set is disjoint to a subset preselected for any other state or reconstruction levels set.

37. Apparatus of solution 35 or 36, configured to select the probability model for the current neural network parameter out of the subset of probability models depending on the quantization index of previously decoded neural network parameters which relate to a portion of the neural network neighboring a portion which the current neural network parameter relates to.

38. Apparatus of solution 35 or 36, configured to select the probability model for the current neural network parameter out of the subset of probability models depending on a characteristic of the quantization index of previously decoded neural network parameters which relate to a portion of the neural network neighboring a portion which the current neural network parameter relates to, the characteristic comprising on or more of the signs of non-zero quantization indices of previously decoded neural network parameters which relate to a portion of the neural network neighboring a portion which the current neural network parameter relates to, the number of quantization indices of previously decoded neural network parameters which relate to a portion of the neural network neighboring a portion which the current neural network parameter relates to, and which are non-zero a sum of the absolute values of quantization indices of previously decoded neural network parameters which relate to a portion of the neural network neighboring a portion which the current neural network parameter relates to a difference between a sum of the absolute values of quantization indices of previously decoded neural network parameters which relate to a portion of the neural network neighboring a portion which the current neural network parameter relates to, and the number of quantization indices of the previously decoded neural network parameters which relate to a portion of the neural network neighboring a portion which the current neural network parameter relates to, and which are non-zero.

39. Apparatus of any of solutions 37 and 38, configured to locate the previously decoded neural network parameters so that the previously decoded neural network parameters relate to the same neural network layer as the current neural network parameter.

40. Apparatus of any of solutions 37 and 39, configured to locate one or more of the previously decoded neural network parameters in a manner so that the one or more previously decoded neural network parameters relate to neuron interconnections which emerge from, or lead towards, a neuron to which a neuron interconnection relates which the current neural network parameter refers to, or a further neuron neighboring said neuron.

41. Apparatus of any of solutions 1 to 40, configured to decode the quantization indices (56) for the neural network parameters (13) and perform the dequantization of the neural network parameters (13) along a common sequential order (14′) among the neural network parameters (13).

42. Apparatus of any of solutions 1 to 41, configured to decode the quantization index (56) for the current neural network parameter (13′) from the data stream (14) using binary arithmetic coding by using the probability model which depends on previously decoded neural network parameters for one or more leading bins of a binarization of the quantization index and by using an equi-probable bypass mode suffix bins of the binarization of the quantization index which follow the one or more leading bins.

43. Apparatus of solution 42, wherein the suffix bins of the binarization of the quantization index represent bins of a binarization code of a suffix binarization for binarizing values of the quantization index an absolute value of which exceeds a maximum absolute value representable by the one or more leading bins, wherein the apparatus is configured to selected the suffix binarization depending on the quantization index of previously decoded neural network parameters.

44. Apparatus of any of solutions 1 to 43, wherein the neural network parameters relate to one reconstruction layer of reconstruction layers using which the neural network (10) is represented, and the apparatus is in configured to reconstruct the neural network by combining the neural network parameters, neural network parameter wise, with corresponding neural network parameters of one or mor further reconstruction layers.

45. Apparatus of solution 44, configured to decode the quantization index (56) for the current neural network parameter (13′) from the data stream (14) using arithmetic coding using a probability model which depends on corresponding neural network parameter corresponding to the current neural network parameter.

46. Apparatus for encoding neural network parameters, which define a neural network, into a data stream, configured to sequentially encode the neural network parameters (13) by selecting (54), for a current neural network parameter (13′), a set (48) of reconstruction levels out of a plurality (50) of reconstruction level sets (52) depending on quantization indices (58) encoded into the data stream (14) for previously encoded neural network parameters, quantizing (64) the current neural network parameter (13′) onto the one reconstruction level of the selected set (48) of reconstruction levels, and encoding a quantization index (56) for the current neural network parameter (13′) that indicates the one reconstruction level onto which the quantization index (56) for the current neural network parameter is quantized into the data stream (14).

47. Apparatus of solution 46, wherein the neural network parameters (13) relate to weights of neuron interconnections (11) of the neural network (10).

48. Apparatus of solution 46 or 47, wherein the number of reconstruction level sets (52) of the plurality (50) of reconstruction level sets (52) is two.

49. Apparatus of any of solutions 46 to 48, configured to parametrize (60) the plurality (50) of reconstruction level sets (52) by way of a predetermined quantization step size (QP) and insert information on the predetermined quantization step size into the data stream (14).

50. Apparatus of any of the previous solutions, wherein the neural network comprises a one or more NN layers and the apparatus is configured to insert, for each NN layer (p; p−1), information on a predetermined quantization step size for the respective NN layer into the data stream (14), and parametrize, for each NN layer, the plurality (50) of reconstruction level sets (52) using the predetermined quantization step size derived for the respective NN layer so as to be used for quantizing the neural network parameters belonging to the respective NN layer.

51. Apparatus of any of solutions 46 to 50, wherein the number of reconstruction level sets (52) of the plurality (50) of reconstruction level sets (52) is two and the plurality of reconstruction level sets comprises a first reconstruction level set (set 0) that comprises zero and even multiples of a predetermined quantization step size, and a second reconstruction level set (set 1) that comprises zero and odd multiples of the predetermined quantization step size.

52. Apparatus of solutions 46 to 51, wherein all reconstruction levels of all reconstruction level sets represent integer multiples of a predetermined quantization step size, and the apparatus is configured to quantize the neural network parameters in a manner so that same are dequantizable by deriving, for each neural network parameter, an intermediate integer value depending on the selected reconstruction level set for the respective neural network parameter and the entropy encoded quantization index for the respective neural network parameter, and multiplying, for each neural network parameter, the intermediate value for the respective neural network parameter with the predetermined quantization step size for the respective neural network parameter.

53. Apparatus of solution 52, wherein the number of reconstruction level sets (52) of the plurality (50) of reconstruction level sets (52) is two and the apparatus is configured to derive the intermediate value for each neural network parameter by, if the selected reconstruction level set for the respective neural network parameter is a first set, multiply the quantization index for the respective neural network parameter by two to obtain the intermediate value for the respective neural network parameter; and if the selected reconstruction level set for a respective neural network parameter is a second set and the quantization index for the respective neural network parameter is equal to zero, set the intermediate value for the respective sample equal to zero; and if the selected reconstruction level set for a respective neural network parameter is a second set and the quantization index for the respective neural network parameter is greater than zero, multiply the quantization index for the respective neural network parameter by two and subtract one from the result of the multiplication to obtain the intermediate value for the respective neural network parameter; and if the selected reconstruction level set for a current neural network parameter is a second set and the quantization index for the respective neural network parameter is less than zero, multiply the quantization index for the respective neural network parameter by two and add one to the result of the multiplication to obtain the intermediate value for the respective neural network parameter.

54. Apparatus of any of solutions 46 to 53, configured to select (54), for the current neural network parameter (13′), the set (48) of reconstruction levels out of the plurality (50) of reconstruction level sets (52) depending on a LSB portion or previously encoded bins of a binarization of the quantization indices (58) encoded into the data stream (14) for previously encoded neural network parameters.

55. Apparatus of any of solutions 46 to 53, configured to select (54), for the current neural network parameter (13′), the set (48) of reconstruction levels out of the plurality (50) of reconstruction level sets (52) depending on the results of a binary function of the quantization indices (58) encoded into the data stream (14) for previously encoded neural network parameters.

56. Apparatus of any of solutions 46 to 55, wherein the apparatus is configured to select (54), for the current neural network parameter (13′), the set (48) of quantization levels out of the plurality (50) of reconstruction level sets (52) depending on a parity of the quantization indices (56) encoded into the data stream (14) for previously encoded neural network parameters.

57. Apparatus of any of solutions 46 to 56, wherein the number of reconstruction level sets (52) of the plurality (50) of reconstruction level sets (52) is two, and the apparatus is configured to derive a subset index for each neural network parameter based on the selected set of reconstruction levels for the respective neural network parameter and a binary function of the quantization index for the respective neural network parameter, resulting in four possible values for the subset index; and select (54), for the current neural network parameter (13′), the set (48) of reconstruction levels out of the plurality (50) of reconstruction level sets (52) depending on the subset indices for previously encoded neural network parameters.

58. Apparatus of solution 57, wherein the apparatus is configured to select (54), for the current neural network parameter (13′), the set (48) of reconstruction levels out of the plurality (50) of reconstruction level sets (52) using a selection rule which depends on the subset indices for a number of immediately previously encoded neural network parameters and to use the selection rule for all, or a portion, of the neural network parameters.

59. Apparatus of solution 58, wherein the number of immediately previously encoded neural network parameters on which the selection rule depends is two.

60. Apparatus of any of solutions 57 to 59, wherein the subset index for each neural network parameter is derived based on the selected set of reconstruction levels for the respective neural network parameter and a parity of the quantization index for the respective neural network parameter.

61. Apparatus of any of solutions 46 to 60, wherein the apparatus is configured to select (54), for the current neural network parameter (13′), the set (48) of quantization levels out of the plurality (50) of reconstruction level sets (52) by means of a state transition process by determining, for the current neural network parameter (13′), the set (48) of quantization levels out of the plurality (50) of reconstruction level sets (52) depending on a state associated with the current neural network parameter (13′), and updating the state for a subsequent neural network parameter depending on the quantization index (58) encoded into the data stream for the immediately preceding neural network parameter.

62. Apparatus of solution 61, configured to update the state for the subsequent neural network parameter using a binary function of the quantization index (58) encoded into the data stream for the immediately preceding neural network parameter.

63. Apparatus of solution 61, configured to update the state for the subsequent neural network parameter using a parity of the quantization index (58) encoded into the data stream for the immediately preceding neural network parameter.

64. Apparatus of any of solutions 61 to 63, wherein the state transition process is configured to transition between four or eight possible states.

65. Apparatus of any of solutions 61 to 64, configured to transition, in the state transition process, between an even number of possible states and the number of reconstruction level sets (52) of the plurality (50) of reconstruction level sets (52) is two, wherein the determining, for the current neural network parameter (13′), the set (48) of quantization levels out of the quantization sets (52) depending on the state associated with the current neural network parameter (13′) determines a first reconstruction level set out of the plurality (50) of reconstruction level sets (52) if the state belongs to a first half of the even number of possible states, and a second reconstruction level set out of the plurality (50) of reconstruction level sets (52) if the state belongs to a second half of the even number of possible states.

66. Apparatus of any of solutions 61 to 65, configured to perform the update of the state by means of a transition table which maps a combination of the state and a parity of the quantization index (58) encoded into the data stream for the immediately preceding neural network parameter onto a further state associated with the subsequent neural network parameter.

67. Apparatus of any of solutions 46 to 66, configured to encode the quantization index (56) for the current neural network parameter (13′) into the data stream (14) using arithmetic coding using a probability model which depends on (123) the set (48) of reconstruction levels selected for the current neural network parameter (13′).

68. Apparatus of any of solutions 46 to 66, configured to select (54), for the current neural network parameter (13′), the set (48) of quantization levels out of the plurality (50) of reconstruction level sets (52) by means of a state transition process by determining, for the current neural network parameter (13′), the set (48) of quantization levels out of the plurality (50) of reconstruction level sets (52) depending on a state associated with the current neural network parameter (13′), and updating the state for a subsequent neural network parameter depending on the quantization index (58) encoded into the data stream for the immediately preceding neural network parameter, and encode the quantization index (56) for the current neural network parameter (13′) into the data stream (14) using arithmetic coding using a probability model which depends on (122) the state for the current neural network parameter (13′).

69. Apparatus of solution 68, configured to encode the quantization index (56) for the current neural network parameter (13′) into the data stream (14) using binary arithmetic coding by using the probability model which depends on (122) the state for the current neural network parameter (13′) for at least one bin (84) of a binarization (82) of the quantization index (56).

70. Apparatus of solution 68, wherein the at least one bin comprises a significance bin indicative of the quantization index (56) of the current neural network parameter being equal to zero or not.

71. Apparatus of any of solutions 68 to 70, wherein the at least one bin comprises a sign bin (86) indicative of the quantization index (56) of the current neural network parameter being greater than zero or lower than zero.

72. Apparatus of any of solutions 68 to 71, wherein the at least one bin comprises a greater-than-X bin indicative of an absolute value of the quantization index (56) of the current neural network parameter being greater than X or not, wherein X is an integer greater than zero.

73. Apparatus of solution 67 or any of 68, 70-72, configured so that the dependency of the probability model involves a selection (103) of a context (87) out of a set of contexts for the neural network parameters using the dependency, each context having a predetermined probability model associated therewith.

74. Apparatus of solution 73, configured to update the predetermined probability model associated with each of the contexts based on the quantization index arithmetically coded using the respective context.

75. Apparatus of any of solutions 46 to 74, configured to encode the quantization index (56) for the current neural network parameter (13′) into the data stream (14) using binary arithmetic coding by using a probability model which depends on the set (48) of reconstruction levels selected for the current neural network parameter (13′) for at least one bin of a binarization of the quantization index.

76. Apparatus of solution 75, wherein the at least one bin comprises a significance bin indicative of the quantization index (56) of the current neural network parameter being equal to zero or not.

77. Apparatus of any of solutions 75 to 76, wherein the at least one bin comprises a sign bin indicative of the quantization index (56) of the current neural network parameter being greater than zero or lower than zero.

78. Apparatus of any of solutions 75 to 77, wherein the at least one bin comprises a greater-than-X bin indicative of an absolute value of the quantization index (56) of the current neural network parameter being greater than X or not, wherein X is an integer greater than zero.

79. Apparatus of any of solutions 67 to 78, wherein the probability model additionally depends on the quantization index of previously encoded neural network parameters.

80. Apparatus of solution 79, configured to preselect, depending on the state or the set (48) of reconstruction levels selected for the current neural network parameter (13′), a subset of probability models out of a plurality of probability models and select the probability model for the current neural network parameter out of the subset of probability models depending on (121) the quantization index of previously encoded neural network parameters.

81. Apparatus of solution 80, configured to preselect, depending on the state or the set (48) of reconstruction levels selected for the current neural network parameter (13′), the subset of probability models out of the plurality of probability models in a manner so that a subset preselected for a first state or reconstruction levels set is disjoint to a subset preselected for any other state or reconstruction levels set.

82. Apparatus of solution 80 or 81, configured to select the probability model for the current neural network parameter out of the subset of probability models depending on the quantization index of previously encoded neural network parameters which relate to a portion of the neural network neighboring a portion which the current neural network parameter relates to.

83. Apparatus of solution 80 or 81, configured to select the probability model for the current neural network parameter out of the subset of probability models depending on a characteristic of the quantization index of previously encoded neural network parameters which relate to a portion of the neural network neighboring a portion which the current neural network parameter relates to, the characteristic comprising on or more of the signs of non-zero quantization indices of previously encoded neural network parameters which relate to a portion of the neural network neighboring a portion which the current neural network parameter relates to, the number of quantization indices of previously encoded neural network parameters which relate to a portion of the neural network neighboring a portion which the current neural network parameter relates to, and which are non-zero a sum of the absolute values of quantization indices of previously encoded neural network parameters which relate to a portion of the neural network neighboring a portion which the current neural network parameter relates to a difference between a sum of the absolute values of quantization indices of previously encoded neural network parameters which relate to a portion of the neural network neighboring a portion which the current neural network parameter relates to, and the number of quantization indices of the previously encoded neural network parameters which relate to a portion of the neural network neighboring a portion which the current neural network parameter relates to, and which are non-zero.

84. Apparatus of any of solutions 82 and 83, configured to locate the previously encoded neural network parameters so that the previously encoded neural network parameters relate to the same neural network layer as the current neural network parameter.

85. Apparatus of any of solutions 82 and 84, configured to locate one or more of the previously encoded neural network parameters in a manner so that the one or more previously encoded neural network parameters relate to neuron interconnections which emerge from, or lead towards, a neuron to which a neuron interconnection relates which the current neural network parameter refers to, or a further neuron neighboring said neuron.

86. Apparatus of any of solutions 46 to 75, configured to encode the quantization indices (56) for the neural network parameters (13) and perform the quantization of the neural network parameters (13) along a common sequential order (14′) among the neural network parameters (13).

87. Apparatus of any of solutions 46 to 86, configured to encode the quantization index (56) for the current neural network parameter (13′) into the data stream (14) using binary arithmetic coding by using the probability model which depends on previously encoded neural network parameters for one or more leading bins of a binarization of the quantization index and by using an equi-probable bypass mode suffix bins of the binarization of the quantization index which follow the one or more leading bins.

88. Apparatus of solution 87, wherein the suffix bins of the binarization of the quantization index represent bins of a binarization code of a suffix binarization for binarizing values of the quantization index an absolute value of which exceeds a maximum absolute value representable by the one or more leading bins, wherein the apparatus is configured to select the suffix binarization depending on the quantization index of previously encoded neural network parameters.

89. Apparatus of any of previous solutions 46 to 88, wherein the neural network parameters relate to one reconstruction layer of reconstruction layers using which the neural network (10) is represented, and the apparatus is in configured so that the neural network is reconstructible by combining the neural network parameters, neural network parameter wise, with corresponding neural network parameters of one or mor further reconstruction layers.

90. Apparatus of solution 89, configured to encode the quantization index (56) for the current neural network parameter (13′) into the data stream (14) using arithmetic encoding using a probability model which depends on corresponding neural network parameter corresponding to the current neural network parameter.

91. Apparatus of any of solutions 46 to 90, configured to use a Viterbi algorithm and a rate-distortion cost measure to perform the selection and/or the quantizing.

92. Apparatus (310) for reconstructing neural network parameters (13), which define a neural network (10), configured to derive first neural network parameters for a first reconstruction layer to yield, per neural network parameter (13), a first-reconstruction-layer neural network parameter value, decode (312) second neural network parameters (13) for a second reconstruction layer from a data stream (14) to yield, per neural network parameter (13), a second-reconstruction-layer neural network parameter value, and reconstruct (314) the neural network parameters (13) by, for each neural network parameter, combining the first-reconstruction-layer neural network parameter value and the second-reconstruction-layer neural network parameter value.

93. Apparatus (310) of solution 92, configured to Decode (316) the first neural network parameters (13) for the first reconstruction layer from the data stream or from a separate data stream, and decode the second neural network parameters (13) for the second reconstruction layer from the data stream by context-adaptive entropy decoding using separate probability contexts for the first and second reconstruction layers.

94. Apparatus (310) of any of solutions 92 to 93, configured to reconstruct the neural network parameters (13) by a parameter wise sum or parameter wise product of, per neural network parameter, the first-reconstruction-layer neural network parameter value and the second-reconstruction-layer neural network parameter value.

95. Apparatus (310) of any of solutions 92 to 94 configured to Decode the second-reconstruction-layer neural network parameter value from the data stream by context-adaptive entropy decoding using a probability model which depends on the first-reconstruction-layer neural network parameter value.

96. Apparatus (310) of any of solutions 92 to 95, configured to decode the second-reconstruction-layer neural network parameter value from the data stream by context-adaptive entropy decoding, selecting a probability context set out of a collection of probability context sets depending on the first-reconstruction-layer neural network parameter value, selecting a probability context to be used out of the selected probability context set depending on the first-reconstruction-layer neural network parameter value.

97. Apparatus (310) of previous solution 96, wherein the collection of probability context sets comprises three probability context sets, and the apparatus is configured to select a first probability context set out of the collection of probability context sets as the selected probability context set if the first-reconstruction-layer neural network parameter value is negative, select a second probability context set out of the collection of probability context sets as the selected probability context set if the first-reconstruction-layer neural network parameter value is positive, select a third probability context set out of the collection of probability context sets as the selected probability context set if the first-reconstruction-layer neural network parameter value is zero.

98. Apparatus (310) of previous solution 96, wherein the collection of probability context sets comprises two probability context sets, and the apparatus is configured to select a first probability context set out of the collection of probability context sets as the selected probability context set if the first-reconstruction-layer neural network parameter value is greater than a predetermined value, and select a second probability context set out of the collection of probability context sets as the selected probability context set if the first-reconstruction-layer neural network parameter value is not greater than the predetermined value, or select the first probability context set out of the collection of probability context sets as the selected probability context set if an absolute value of the first-reconstruction-layer neural network parameter value is greater than the predetermined value, and select the second probability context set out of the collection of probability context sets as the selected probability context set if the absolute value of the first-reconstruction-layer neural network parameter value is not greater than the predetermined value.

99. Apparatus (320) for encoding neural network parameters (13), which define a neural network (10), by using first neural network parameters (13) for a first reconstruction layer which comprise, per neural network parameter (13), a first-reconstruction-layer neural network parameter value, and the apparatus being configured to encode (322) second neural network parameters (13) for a second reconstruction layer into a data stream (14), which comprise, per neural network parameter (13), a second-reconstruction-layer neural network parameter value, wherein the neural network parameters (13) are reconstructible by, for each neural network parameter, combining the first-reconstruction-layer neural network parameter value and the second-reconstruction-layer neural network parameter value.

100. Apparatus (320) of solution 99, configured to encode the first neural network parameters (13) for the first reconstruction layer into the data stream or a separate data stream, and encode the second neural network parameters (13) for the second reconstruction layer into the data stream by context-adaptive entropy encoding using separate probability contexts for the first and second reconstruction layers.

101. Apparatus (320) of any of solutions 99 to 100, wherein the neural network parameters (13) are reconstructible by a parameter wise sum or parameter wise product of, per neural network parameter, the first-reconstruction-layer neural network parameter value and the second-reconstruction-layer neural network parameter value.

102. Apparatus (320) of any of solutions 99 to 101, configured to encode the second-reconstruction-layer neural network parameter value into the data stream by context-adaptive entropy encoding using a probability model which depends on the first-reconstruction-layer neural network parameter value.

103. Apparatus (320) of any of solutions 99 to 102, configured to encode the second-reconstruction-layer neural network parameter value into the data stream by context-adaptive entropy encoding, selecting a probability context set out of a collection of probability context sets depending on the first-reconstruction-layer neural network parameter value, selecting a probability context to be used out of the selected probability context set depending on the first-reconstruction-layer neural network parameter value.

104. Apparatus (320) of solution 103, wherein the collection of probability context sets comprises three probability context sets, and the apparatus is configured to select a first probability context set out of the collection of probability context sets as the selected probability context set if the first-reconstruction-layer neural network parameter value is negative, select a second probability context set out of the collection of probability context sets as the selected probability context set if the first-reconstruction-layer neural network parameter value is positive, select a third probability context set out of the collection of probability context sets as the selected probability context set if the first-reconstruction-layer neural network parameter value is zero.

105. Apparatus (320) of solution 103, wherein the collection of probability context sets comprises two probability context sets, and the apparatus is configured to select a first probability context set out of the collection of probability context sets as the selected probability context set if the first-reconstruction-layer neural network parameter value is greater than a predetermined value, and select a second probability context set out of the collection of probability context sets as the selected probability context set if the first-reconstruction-layer neural network parameter value is not greater than the predetermined value, or select the first probability context set out of the collection of probability context sets as the selected probability context set if an absolute value of the first-reconstruction-layer neural network parameter value is greater than the predetermined value, and select the second probability context set out of the collection of probability context sets as the selected probability context set if the absolute value of the first-reconstruction-layer neural network parameter value is not greater than the predetermined value.

106. Method (400) for decoding neural network parameters (13), which define a neural network (10), from a data stream (14), the method comprising: sequentially decoding the neural network parameters (13) by selecting (54), for a current neural network parameter (13′), a set (48) of reconstruction levels out of a plurality (50) of reconstruction level sets (52) depending on quantization indices (58) decoded from the data stream (14) for previous neural network parameters, decoding (420) a quantization index (56) for the current neural network parameter (13′) from the data stream (14), wherein the quantization index (56) indicates one reconstruction level out of the selected set (48) of reconstruction levels for the current neural network parameter, dequantizing (62) the current neural network parameter (13′) onto the one reconstruction level of the selected set (48) of reconstruction levels that is indicated by the quantization index (56) for the current neural network parameter.

107. Method (500) for encoding neural network parameters, which define a neural network, into a data stream, the method comprising: sequentially encoding the neural network parameters (13) by selecting (54), for a current neural network parameter (13′), a set (48) of reconstruction levels out of a plurality (50) of reconstruction level sets (52) depending on quantization indices (58) encoded into the data stream (14) for previously encoded neural network parameters, quantizing (64) the current neural network parameter (13′) onto the one reconstruction level of the selected set (48) of reconstruction levels, and encoding (530) a quantization index (56) for the current neural network parameter (13′) that indicates the one reconstruction level onto which the quantization index (56) for the current neural network parameter is quantized into the data stream (14) 108. Method (600) for reconstructing neural network parameters (13), which define a neural network (10), comprising deriving (610) first neural network parameters for a first reconstruction layer to yield, per neural network parameter (13), a first-reconstruction-layer neural network parameter value, decoding (620) second neural network parameters (13) for a second reconstruction layer from a data stream to yield, per neural network parameter (13), a second-reconstruction-layer neural network parameter value, and reconstructing (630) the neural network parameters (13) by, for each neural network parameter, combining the first-reconstruction-layer neural network parameter value and the second-reconstruction-layer neural network parameter value.

109. Method (700) for encoding neural network parameters (13), which define a neural network (10), by using first neural network parameters (13) for a first reconstruction layer which comprise, per neural network parameter (13), a first-reconstruction-layer neural network parameter value, and the method comprises encoding (710) second neural network parameters (13) for a second reconstruction layer into a data stream, which comprise, per neural network parameter (13), a second-reconstruction-layer neural network parameter value, wherein the neural network parameters (13) are reconstructible by, for each neural network parameter, combining the first-reconstruction-layer neural network parameter value and the second-reconstruction-layer neural network parameter value.

110. Data stream encoded by a method according to solution 107 and 109.

111. Computer program having a program code for executing a method according to solution 106, 107, 108 or 109 when the program runs on one or several computers.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] C. W. P. V. J. C. J. T. B. C. E. S. Sharan Chetlur, “cuDNN: Efficient Primitives for Deep Learning,” arXiv: 1410.0759, 2014
[2] MPEG, “Working Draft 2 of Compression of neural networks for multimedia content description and analysis”, Document of ISO/IEC JTC1/SC29/WG11, w18784, Geneva, October 2019
[3] D. Marpe, H. Schwarz und T. Wiegand, Context-Based Adaptive Binary Arithmetic Coding in the H.264/AVC Video Compression Standard,” IEEE transactions on circuits and systems for video technology, Vol. 13, No. 7, pp. 620-636, July 2003.
[4] H. Kirchhoffer, J. Stegemann, D. Marpe, H. Schwarz und T. Wiegand, JVET-K0430-v3-CE5-related: State-based probalility estimator,” in JVET, Ljubljana, 2018.
[5] ITU-International Telecommunication Union, ITU-T H.265 High efficiency video coding,” Series H: Audiovisual and multimedia systems-Infrastructure of audiovisual services-Coding of moving video, April 2015.
[6] B. Bross, J. Chen und S. Liu, JVET-M1001-v6-Versatile Video Coding (Draft 4),” in JVET, Marrakech, 2019.

1. Apparatus for decoding neural network parameters, which define a neural network, from a data stream, comprising a processor configured to
sequentially decode the neural network parameters by
selecting, for a current neural network parameter, a set of reconstruction levels out of a plurality of reconstruction level sets depending on quantization indices decoded from the data stream for previous neural network parameters,
decoding a quantization index for the current neural network parameter from the data stream, wherein the quantization index indicates one reconstruction level out of the selected set of reconstruction levels for the current neural network parameter,
dequantizing the current neural network parameter onto the one reconstruction level of the selected set of reconstruction levels that is indicated by the quantization index for the current neural network parameter.

2. Apparatus of claim 1, wherein the number of reconstruction level sets of the plurality of reconstruction level sets is two.

3. Apparatus of claim 1, configured to parametrize the plurality of reconstruction level sets by way of a predetermined quantization step size and derive information on the predetermined quantization step size from the data stream.

4. Apparatus of claim 1, wherein the neural network comprises a one or more NN layers and the apparatus is configured to
derive, for each NN layer, information on a predetermined quantization step size for the respective NN layer from the data stream, and
parametrize, for each NN layer, the plurality of reconstruction level sets using the predetermined quantization step size derived for the respective NN layer so as to be used for dequantizing the neural network parameters belonging to the respective NN layer.

5. Apparatus of claim 1, wherein the number of reconstruction level sets of the plurality of reconstruction level sets is two and the plurality of reconstruction level sets comprises
a first reconstruction level set that comprises zero and even multiples of a predetermined quantization step size, and
a second reconstruction level set that comprises zero and odd multiples of the predetermined quantization step size.

6. Apparatus of claim 1, wherein all reconstruction levels of all reconstruction level sets represent integer multiples of a predetermined quantization step size, and the apparatus is configured to dequantize the neural network parameters by
deriving, for each neural network parameter, an intermediate integer value depending on the selected reconstruction level set for the respective neural network parameter and the entropy decoded quantization index for the respective neural network parameter, and
multiplying, for each neural network parameter, the intermediate value for the respective neural network parameter with the predetermined quantization step size for the respective neural network parameter.

7. Apparatus of claim 6, wherein the number of reconstruction level sets of the plurality of reconstruction level sets is two and the apparatus is configured to derive the intermediate value for each neural network parameter by,
if the selected reconstruction level set for the respective neural network parameter is a first set, multiply the quantization index for the respective neural network parameter by two to acquire the intermediate value for the respective neural network parameter; and
if the selected reconstruction level set for a respective neural network parameter is a second set and the quantization index for the respective neural network parameter is equal to zero, set the intermediate value for the respective sample equal to zero; and
if the selected reconstruction level set for a respective neural network parameter is a second set and the quantization index for the respective neural network parameter is greater than zero, multiply the quantization index for the respective neural network parameter by two and subtract one from the result of the multiplication to acquire the intermediate value for the respective neural network parameter; and
if the selected reconstruction level set for a current neural network parameter is a second set and the quantization index for the respective neural network parameter is less than zero, multiply the quantization index for the respective neural network parameter by two and add one to the result of the multiplication to acquire the intermediate value for the respective neural network parameter.

8. Apparatus of claim 1, wherein the apparatus is configured to
select, for the current neural network parameter, the set of quantization levels out of the plurality of reconstruction level sets by means of a state transition process by
determining, for the current neural network parameter, the set of quantization levels out of the plurality of reconstruction level sets depending on a state associated with the current neural network parameter, and
updating the state for a subsequent neural network parameter depending on the quantization index decoded from the data stream for the immediately preceding neural network parameter.

9. Apparatus of claim 8, configured to update the state for the subsequent neural network parameter using a binary function of the quantization index decoded from the data stream for the immediately preceding neural network parameter.

10. Apparatus of claim 8, configured to update the state for the subsequent neural network parameter using a parity of the quantization index decoded from the data stream for the immediately preceding neural network parameter.

11. Apparatus of claim 8, wherein the state transition process is configured to transition between four or eight possible states.

12. Apparatus of claim 8, configured to transition, in the state transition process, between an even number of possible states and the number of reconstruction level sets of the plurality of reconstruction level sets is two, wherein the determining, for the current neural network parameter, the set of quantization levels out of the quantization sets depending on the state associated with the current neural network parameter determines a first reconstruction level set out of the plurality of reconstruction level sets if the state belongs to a first half of the even number of possible states, and a second reconstruction level set out of the plurality of reconstruction level sets if the state belongs to a second half of the even number of possible states.

13. Apparatus of claim 8, configured to perform the update of the state by means of a transition table which maps a combination of the state and a parity of the quantization index decoded from the data stream for the immediately preceding neural network parameter onto a further state associated with the subsequent neural network parameter.

14. Apparatus of claim 1, configured to
select, for the current neural network parameter, the set of quantization levels out of the plurality of reconstruction level sets by means of a state transition process by
determining, for the current neural network parameter, the set of quantization levels out of the plurality of reconstruction level sets depending on a state associated with the current neural network parameter, and
updating the state for a subsequent neural network parameter depending on the quantization index decoded from the data stream for the immediately preceding neural network parameter, and
decode the quantization index for the current neural network parameter from the data stream using arithmetic coding using a probability model which depends on the state for the current neural network parameter.

15. Apparatus of claim 14, configured to decode the quantization index for the current neural network parameter from the data stream using binary arithmetic coding by using the probability model which depends on the state for the current neural network parameter for at least one bin of a binarization of the quantization index.

16. Apparatus of claim 14, wherein the at least one bin comprises a significance bin indicative of the quantization index of the current neural network parameter being equal to zero or not.

17. Apparatus of claim 14, wherein the probability model additionally depends on the quantization index of previously decoded neural network parameters.

18. Apparatus of claim 17, configured to preselect, depending on the state or the set of reconstruction levels selected for the current neural network parameter, a subset of probability models out of a plurality of probability models and select the probability model for the current neural network parameter out of the subset of probability models depending on the quantization index of previously decoded neural network parameters.

19. Apparatus of claim 18, configured to preselect, depending on the state or the set of reconstruction levels selected for the current neural network parameter, the subset of probability models out of the plurality of probability models in a manner so that a subset preselected for a first state or reconstruction levels set is disjoint to a subset preselected for any other state or reconstruction levels set.

20. Apparatus of claim 18, configured to select the probability model for the current neural network parameter out of the subset of probability models depending on the quantization index of previously decoded neural network parameters which relate to a portion of the neural network neighboring a portion which the current neural network parameter relates to.

21. Apparatus of claim 18, configured to select the probability model for the current neural network parameter out of the subset of probability models depending on a characteristic of the quantization index of previously decoded neural network parameters which relate to a portion of the neural network neighboring a portion which the current neural network parameter relates to, the characteristic comprising on or more of
the signs of non-zero quantization indices of previously decoded neural network parameters which relate to a portion of the neural network neighboring a portion which the current neural network parameter relates to,
the number of quantization indices of previously decoded neural network parameters which relate to a portion of the neural network neighboring a portion which the current neural network parameter relates to, and which are non-zero a sum of the absolute values of quantization indices of previously decoded neural network parameters which relate to a portion of the neural network neighboring a portion which the current neural network parameter relates to
a difference between
a sum of the absolute values of quantization indices of previously decoded neural network parameters which relate to a portion of the neural network neighboring a portion which the current neural network parameter relates to, and
the number of quantization indices of the previously decoded neural network parameters which relate to a portion of the neural network neighboring a portion which the current neural network parameter relates to, and which are non-zero.

22. Apparatus for encoding neural network parameters, which define a neural network, into a data stream, comprising a processor configured to
sequentially encode the neural network parameters by
selecting, for a current neural network parameter, a set of reconstruction levels out of a plurality of reconstruction level sets depending on quantization indices encoded into the data stream for previously encoded neural network parameters,
quantizing the current neural network parameter onto the one reconstruction level of the selected set of reconstruction levels, and
encoding a quantization index for the current neural network parameter that indicates the one reconstruction level onto which the quantization index for the current neural network parameter is quantized into the data stream.

23. Apparatus for reconstructing neural network parameters, which define a neural network, comprising a processor configured to
derive first neural network parameters for a first reconstruction layer to yield, per neural network parameter, a first-reconstruction-layer neural network parameter value,
decode second neural network parameters for a second reconstruction layer from a data stream to yield, per neural network parameter, a second-reconstruction-layer neural network parameter value, and
reconstruct the neural network parameters by, for each neural network parameter, combining the first-reconstruction-layer neural network parameter value and the second-reconstruction-layer neural network parameter value.

24. Apparatus of claim 23, configured to
Decode the first neural network parameters for the first reconstruction layer from the data stream or from a separate data stream, and
decode the second neural network parameters for the second reconstruction layer from the data stream by context-adaptive entropy decoding using separate probability contexts for the first and second reconstruction layers.

25. Apparatus of claim 23, configured to
reconstruct the neural network parameters by a parameter wise sum or parameter wise product of, per neural network parameter, the first-reconstruction-layer neural network parameter value and the second-reconstruction-layer neural network parameter value.

26. Apparatus of claim 23, configured to
Decode the second-reconstruction-layer neural network parameter value from the data stream by context-adaptive entropy decoding using a probability model which depends on the first-reconstruction-layer neural network parameter value.

27. Apparatus of claim 23, configured to
decode the second-reconstruction-layer neural network parameter value from the data stream by
context-adaptive entropy decoding,
selecting a probability context set out of a collection of probability context sets depending on the first-reconstruction-layer neural network parameter value, selecting a probability context to be used out of the selected probability context set depending on the first-reconstruction-layer neural network parameter value.

28. Apparatus of claim 27, wherein the collection of probability context sets comprises three probability context sets, and the apparatus is configured to
select a first probability context set out of the collection of probability context sets as the selected probability context set if the first-reconstruction-layer neural network parameter value is negative,
select a second probability context set out of the collection of probability context sets as the selected probability context set if the first-reconstruction-layer neural network parameter value is positive,
select a third probability context set out of the collection of probability context sets as the selected probability context set if the first-reconstruction-layer neural network parameter value is zero.

29. Apparatus of claim 27, wherein the collection of probability context sets comprises two probability context sets, and the apparatus is configured to
select a first probability context set out of the collection of probability context sets as the selected probability context set if the first-reconstruction-layer neural network parameter value is greater than a predetermined value, and select a second probability context set out of the collection of probability context sets as the selected probability context set if the first-reconstruction-layer neural network parameter value is not greater than the predetermined value, or
select the first probability context set out of the collection of probability context sets as the selected probability context set if an absolute value of the first-reconstruction-layer neural network parameter value is greater than the predetermined value, and select the second probability context set out of the collection of probability context sets as the selected probability context set if the absolute value of the first-reconstruction-layer neural network parameter value is not greater than the predetermined value.

30. Apparatus for encoding neural network parameters, which define a neural network, by using first neural network parameters for a first reconstruction layer which comprise, per neural network parameter, a first-reconstruction-layer neural network parameter value, and the apparatus comprising a processor being configured to
encode second neural network parameters for a second reconstruction layer into a data stream, which comprise, per neural network parameter, a second-reconstruction-layer neural network parameter value,
wherein the neural network parameters are reconstructible by, for each neural network parameter, combining the first-reconstruction-layer neural network parameter value and the second-reconstruction-layer neural network parameter value.
